(19) United States
(12) Patent Application Publication
(10) Pub. No.: US 2003/0228142 A1
(43) Pub. Date: Dec. 11, 2003

(54) Ceiling mounted heating and cooling device and method therefor

(76) Inventor: Kenneth H. Reiker, Shalimar, FL (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/422,256

(22) Filed: Apr. 24, 2003

Related U.S. Application Data
(63) Continuation-in-part of application No. 10/087,694, filed on Mar. 1, 2002.
(63) Continuation-in-part of application No. 10/021,131, filed on Oct. 22, 2001, now Pat. No. 6,631,243.
(63) Continuation-in-part of application No. 09/805,478, filed on Mar. 13, 2001, now Pat. No. 6,477,321.
Application No. 09/805,478 is a continuation of application No. 09/443,617, filed on Nov. 19, 1999, now Pat. No. 6,240,247.
Application No. 09/443,617 is a continuation-in-part of application No. 09/439,763, filed on Nov. 15, 1999, now Pat. No. 6,438,322.
(63) Continuation-in-part of application No. 09/598,855, filed on Jun. 21, 2000, now Pat. No. 6,366,733.
(60) Provisional application No. 60/262,491, filed on Jan. 17, 2001.
(60) Provisional application No. 60/108,686, filed on Nov. 16, 1998.
(60) Provisional application No. 60/141,499, filed on Jun. 28, 1999.

(51) Int. Cl. F03D 11/00

(52) U.S. Cl. 392/364; 416/5

(57) ABSTRACT

A ceiling mounted heating and cooling device capable of creating and uniformly distributing a first heated airflow for heating a room and/or a first cooled airflow for cooling a room, wherein the device incorporates a heating device and an air conditioning system.

### CROSS-REFERENCE AND PRIORITY CLAIM TO RELATED APPLICATIONS

To the full extent permitted by law, the present application claims priority to and the benefit of the following applications: (1) as continuation-in-part application of non-provisional application entitled “Ceiling Mounted Heating Device and Method Therefor”, filed Mar. 1, 2002 having assigned Ser. No. 10/087,694; (2) as continuation-in-part application of non-provisional application entitled “Air Recirculating and Heating Device”, filed Oct. 22, 2001 having assigned Ser. No. 10/021,131 which claims benefit of provisional patent application entitled “Room Conditioner With Coaxial Fan And Heater Modules”, filed on Jan. 17, 2001, having assigned Serial No. 60/262,491; (3) as a continuation-in-part application of non-provisional application entitled “Ceiling Fan Room Conditioner With Ceiling Fan And Heater”, filed Mar. 13, 2001, having assigned Ser. No. 09/805,478 and having now issued as U.S. Pat. No. 6,477,321, which is a continuation of and claims priority to and benefit of non-provisional application entitled “Room Conditioner With Ceiling Mounted Heater”, filed Nov. 19, 1999, having assigned Ser. No. 09/443,617 and having now issued as U.S. Pat. No. 6,240,247, which is a continuation-in-part of and claims priority to and benefit of non-provisional application entitled “Ceiling Fan With Attached Heater and Secondary Fan” filed on Nov. 15, 1999, having assigned Ser. No. 09/439,763 and having now issued as U.S. Pat. No. 6,438,322 which claims priority to provisional application entitled “Stabilized Air Temperature Distribution Apparatus”, filed on Nov. 16, 1998, having assigned Serial No. 60/108,686; (4) as a continuation-in-part application of non-provisional application entitled “Ceiling Fan With Attached Heater and Secondary Fan” filed on Nov. 15, 1999, having assigned Ser. No. 09/439,763 and having now issued as U.S. Pat. No. 6,438,322 which claims priority to and the benefit of provisional application entitled “Stabilized Air Temperature Distribution Apparatus”, filed on Nov. 16, 1998, having assigned Serial No. 60/108,686; and (5) as a continuation-in-part application of non-provisional application entitled “Ceiling Fan Having One Or More Fan Heaters” filed on Jun. 21, 2000, having assigned Ser. No. 09/598,855 and having now issued as U.S. Pat. No. 6,366,733 which claims priority to and the benefit of provisional application entitled “Ceiling Fan Having Dual Fan Heaters”, filed on Jun. 28, 1999, having assigned Serial No. 60/141,499, wherein all above applications are incorporated herein by reference.

### TECHNICAL FIELD

The present invention relates generally to room heating and cooling devices, and more specifically to a ceiling mounted heating and cooling device and method therefor. The present invention is particularly suitable for creating and uniformly distributing a primary heated airflow for heating a room and/or a primary cooled airflow for cooling a room.

### BACKGROUND OF THE INVENTION

Prior-art heating and cooling systems utilized in dwellings and/or offices typically employ large, thermostatically controlled, central forced air systems that convey heated/cooled air to various rooms of the dwelling or office via a complex system of ductwork. However, in view of inherent energy losses through such ductwork, and the size of the heating and cooling unit necessary to heat and cool the entire dwelling/office, such forced air systems generally fail to evenly distribute heated/cooled air. Furthermore, as central thermostats are incapable of providing uniform temperatures throughout a home or office, operational costs can be exceedingly high. Additionally, associated duct outlets, whether wall, floor or ceiling mounted, often produce hot and/or cold spots within a room, and thus tend to constrict furniture arrangement.

Ceiling fans are generally utilized to create air circulation and to produce a cooling affect through wind chill, but do so without raising and/or lowering the temperature of a room. Ceiling fans do, however, remove the stratification layers from a room and equalize the temperature therein.

Although ceiling fans having heaters suspended therefrom may be found by reference to U.S. Pat. No. 4,508,958 to Kan et al., U.S. Pat. No. 5,668,920 to Pelonis, U.S. Pat. No. 5,887,785 to Yilmaz and U.S. Pat. No. 4,694,142 to Glucksman, such fans, in light of the present invention, are deficient in that they either fail to evenly distribute heated air throughout a room, and thus create hot and/or cold spots, or fail to protect the incorporated fan motor from adverse heat generated from improperly isolated heating elements and/or deficient airflow design.

Ceiling fans that effectively assist in thermostatically regulating room temperature are known however, and may be found in U.S. Pat. No. 6,240,247 to Reiker and U.S. Pat. No. 6,366,733 to Reiker, wherein the present application claims priority thereto via a chain of priority.

Ceiling fans and air movement devices designed to work in conjunction with an air conditioning device are also known and may be found by reference to U.S. Pat. No. 5,097,674 to Imaiida et al., U.S. Pat. No. 5,524,450 to Chen, U.S. Pat. No. 4,598,632 to Johnson, and Patent No. 5,497,632 to Robinson. However, in light of the present invention, the aforementioned designs are deficient in that they fail to provide both a cooling and heating mode of operation, fail to remove condensed water vapor, and/or are dependent upon a wholly separate apparatus outside the realm of the invention to supply cooled or heated airflow.

Therefore, it is readily apparent that there is a need for a new and improved ceiling mounted heating and cooling device, wherein the device is capable of creating and uniformly distributing a primary heated airflow for heating a room and/or a primary cooled airflow for cooling a room. It is, therefore, to the provision of such an improvement that the present invention is directed.

### BRIEF SUMMARY OF THE INVENTION

Briefly described, in a preferred embodiment, the present invention overcomes the above-mentioned disadvantages and meets the recognized need for such a device by providing a highly efficient, preferably ceiling mounted heating and cooling device designed to achieve desired energy objectives by utilizing minimal amounts of energy to create a powerful, heated or cooled airflow to heat and/or cool a room.

According to its major aspects and broadly stated, the present invention in its preferred form is a ceiling mounted heating and cooling device having a heating device and an air conditioning apparatus.

More specifically, the present invention is a ceiling mounted heating and cooling device having a heating device preferably possessing an impeller, heating elements and heat sink material or heat shield, wherein the heat sink material or heat shield protects proximate components from unacceptable heat transfer from the heating elements. Located preferably above the heating device, preferably in an attic or between floors, is an air conditioning apparatus that preferably provides cooled airflow that preferably exits the ceiling above the blades of a distribution fan, wherein the distribution fan is disposed preferably below the heating device and the air conditioning apparatus, and preferably functions to uniformly distribute heated and cooled airflow throughout the room, breaking up stratification layers common to conventional heating and cooling systems.

In the heating mode, the present invention is designed to move air from an upward location, preferably adjacent the ceiling, by preferably energizing the impeller of the heating device and drawing air therein. As air is moved through the heating device, it is urged through the heating elements and then subsequently expelled through outlets as a primary heated airflow. The present invention is able to achieve its greatest efficiency through the constant recycling of heated air molecules, thus reducing the rising and subsequent dissipation of heated air molecules along the ceiling of a room. The present invention is designed to continuously recycle and thus reheat air molecules, recirculating them throughout the room in a preferably upward direction via assistance from the blades of the distribution fan.

During the heating mode of the device, as the temperature of a room reaches its desired comfort level, a preferred remote transmitter/receiver preferably reduces the amount of energy required to maintain the temperature of the room via reducing the number of heating elements activated and/or the energy consumed by the heating elements. The device is preferably designed to first achieve a desired temperature setting and then maintain the desired temperature utilizing the least amount of energy necessary.

In the cooling mode, the present invention is designed to produce a primary cooled airflow preferably via drawing air from the room to be cooled and preferably directing the air into a heat exchanger for subsequent discharge above the blades of the distribution fan. The distribution fan preferably distributes this cooled airflow in a downward direction to lower the temperature of both the room and the cool breezes that are directed at the room's occupants. In an alternate embodiment the distribution fan could operate in an upward direction and distribute the cooled air to also achieve a uniformly cooled temperature throughout the room.

During the cooling mode of the device, as the temperature of a room reaches its desired comfort level, a preferred remote transmitter/receiver preferably deactivates the air conditioning system and permits the distribution fan to continue to circulate the air in the room. As the temperature in the room rises, the remote transmitter/receiver preferably reactivates the air conditioning system to enable the primary cooled airflow produced thereby to mix with the airflow supplied by the distribution fan, thereby lowering the temperature of the room and reducing the temperature of the airflow directed at the room's occupants. In an alternate embodiment the temperature in the room could be stabilized by lowering the speed of the evaporator fan, thereby reducing the amount of cooled airflow added to the room.

A feature and advantage of the present invention is its ability to provide a more efficient method of heating and cooling a single room as compared to conventional heating and cooling systems.

A feature and advantage of the present invention is its ability to function with minimal ductwork, wherein prior-art dependency upon and the utilization of large amounts of lengthy ductwork has proven to contribute to a 30% to 40% energy loss due to pressure and heat losses associated therewith and common placement thereof in cold and/or hot attics.

A feature and advantage of the present invention is its ability to provide a method of heating and cooling specific rooms and/or areas within any type of building, wherein utilization of such a method enables the occupant of the building to regulate the temperature of each room, rather than attempting to regulate an entire home or an entire floor with a conventional centrally-mounted thermostat.

A feature and advantage of the present invention is its ability to efficiently and rapidly heat or cool only those rooms in use, while rooms not in use, can be closed off, heated and/or cooled just prior to their intended use and/or occupancy.

A feature and advantage of the present invention is the inherent safety provided by mounting the device on the ceiling rather than in the vicinity of children, pets or home furnishings.

A feature and advantage of the present invention is its ability to establish different temperatures in different or separate rooms on the same floor of a building structure.

A feature and advantage of the present invention is its ability to permit an individual having a generally warmer body temperature to utilize the air conditioning feature of the present invention in one room, while an individual having a generally colder body temperature may utilize the heating feature of the present invention in another room.

A feature and advantage of the present invention is the proximity of all components for ease of maintenance.

A feature and advantage of the present invention is its ability to continually stimulate heated or cooled air molecules for distribution throughout a room, wherein such stimulation results in large eddies of air colliding and transferring their heated or cooled energy to achieve near uniform room temperatures.

A feature and advantage of the preferred embodiment of the present invention is its ability to be mounted in a location that will not encumber or interfere with furniture and/or furniture arrangements.

A feature and advantage of the present invention is its ability to break up stratification layers, remove hot and/or cold spots, and effect a more comfortable conditioned environment.

A feature and advantage of the present invention is its ability to warm cold window glass to further enhance the comfort level in a room possessing windows.

A feature and advantage of the present invention is its ability to cool hot window glass to further enhance the comfort level in a room possessing windows.

A feature and advantage of the present invention is its ability to prevent condensed water vapor from leaking into a room, behind a ceiling and/or in the attic of a home.

A feature and advantage of the present invention is its ability to provide a less obtrusive heating and cooling system when installed.

A feature and advantage of the present invention is its ability to be installed at an overall lesser cost than conventional H/VAC systems.

A feature and advantage of the present invention is its ability to provide a heating and air conditioning apparatus that reduces the level of noise generally associated with conventional heating and/or cooling systems.

These and other objects, features and advantages of the present invention will become apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structures and refer to like elements throughout, and in which:

FIG. 1 is a partial cross-sectional side view of a ceiling mounted heating and cooling device according to a preferred embodiment of the present invention, showing alternate ceiling mounted heating devices that may be utilized therewith.

FIG. 2 is a partial perspective view of a ceiling mounted heating and cooling device according to a preferred embodiment of the present invention.

FIG. 3 is a top partial cutaway view of the air conditioning system of a ceiling mounted heating and cooling device according to a preferred embodiment of the present invention.

FIG. 4 is a top partial cutaway view of the air conditioning system of a ceiling mounted heating and cooling device according to a preferred embodiment of the present invention.

FIG. 4A is sectional view along lines 4A-4A of FIG. 4.

FIG. 5 is a partial cross-sectional side view of a ceiling mounted heating and cooling device according to a preferred embodiment of the present invention.

FIG. 5A is a partial cross-sectional side view of a ceiling mounted heating and cooling device according to a preferred embodiment of the present invention.

FIG. 6 is a partial cross-sectional side view of a ceiling mounted heating and cooling device according to a preferred embodiment of the present invention.

FIG. 6A is a partial cross-sectional side view of a ceiling mounted heating and cooling device according to a preferred embodiment of the present invention.

FIG. 7 is a schematic diagram of the preferred control circuitry for the air conditioning system of a ceiling mounted heating and cooling device according to a preferred embodiment of the present invention.

FIG. 8 is a side view of the ceiling mounted heating device of a ceiling mounted heating and cooling device according to a preferred embodiment of the present invention, showing the heating device housed within one of several optional decorative housings.

FIG. 9 illustrates the airflow within a room resulting from operation of a ceiling mounted heating and cooling device according to a preferred embodiment of the present invention.

FIGS. 10A and 10B are exploded views of the ceiling mounted heating device of a ceiling mounted heating and cooling device according to a preferred embodiment of the present invention.

FIG. 10C is a partial cross-sectional view of an impeller and motor of the ceiling mounted heating device of a ceiling mounted heating and cooling device according to a preferred embodiment of the present invention.

FIG. 11 is a perspective view of the impeller, motor and heat shields of the ceiling mounted heating device of a ceiling mounted heating and cooling device according to a preferred embodiment of the present invention.

FIG. 12 is a schematic diagram of the preferred control circuitry for the ceiling mounted heating device of a ceiling mounted heating and cooling device according to a preferred embodiment of the present invention.

FIG. 13 is a partial cross-sectional view of the ceiling mounted heating device of a ceiling mounted heating and cooling device according to a preferred embodiment of the present invention.

FIGS. 14A and 14B illustrate the preferred control unit and the corresponding actuated preferred heating elements of the ceiling mounted heating device of a ceiling mounted heating and cooling device according to a preferred embodiment of the present invention.

FIGS. 15A and 15B illustrate the preferred control unit and the corresponding actuated preferred heating elements of the ceiling mounted heating device of a ceiling mounted heating and cooling device according to a preferred embodiment of the present invention.

FIGS. 16A and 16B illustrate the preferred control unit and the corresponding actuated preferred heating elements of the ceiling mounted heating device of a ceiling mounted heating and cooling device according to a preferred embodiment of the present invention.

FIGS. 17A and 17B illustrate the preferred control unit and the corresponding actuated preferred heating elements of the ceiling mounted heating device of a ceiling mounted heating and cooling device according to a preferred embodiment of the present invention.

FIG. 18 is a partial cross-sectional side view of a ceiling mounted heating and cooling device according to an alternate embodiment of the present invention, showing alternate ceiling mounted heating devices that may be attached thereto.

FIG. 19 is a partial perspective view of a ceiling mounted heating and cooling device according to an alternate embodiment of the present invention.

FIG. 20 is a partial cutaway view of the air conditioning system of a ceiling mounted heating and cooling device according to an alternate embodiment of the present invention.

FIG. 21 is a partial cutaway view of the air conditioning system of a ceiling mounted heating and cooling device according to an alternate embodiment of the present invention.

FIG. 22 is a partial cross-sectional side view of a ceiling mounted heating and cooling device according to an alternate embodiment of the present invention.

FIG. 22A is a side view and partial cross-sectional side view of a ceiling mounted heating and cooling device according to an alternate embodiment of the present invention.

FIG. 22B is a partial cross-sectional side view of an evaporator of the air conditioning system of a ceiling mounted heating and cooling device according to an alternate embodiment of the present invention.

FIG. 23 is a side view and partial cross-sectional side view of a ceiling mounted heating and cooling device according to an alternate embodiment of the present invention.

FIG. 23A is a side view and partial cross-sectional side view of a ceiling mounted heating and cooling device according to an alternate embodiment of the present invention.

FIG. 24 is a schematic diagram of the preferred control circuitry for the air conditioning system of a ceiling mounted heating and cooling device according to an alternate embodiment of the present invention.

FIG. 25 is a side view and partial cross-sectional side view of a ceiling mounted heating and cooling device according to an alternate embodiment of the present invention, showing alternate ceiling mounted heating devices that may be attached thereto.

FIG. 26 is a side view and partial cross-sectional side view of a ceiling mounted heating and cooling device according to an alternate embodiment of the present invention.

FIG. 26A is a side view and partial cross-sectional side view of a ceiling mounted heating and cooling device according to an alternate embodiment of the present invention.

FIG. 27 is a cross-sectional top view of the air conditioning system of a ceiling mounted heating and cooling device according to an alternate embodiment of the present invention.

FIG. 28 is a schematic diagram of the preferred control circuitry for the air conditioning system of a ceiling mounted heating and cooling device according to an alternate embodiment of the present invention.

FIG. 29 is a side view of a ceiling mounted heating device according to an alternate embodiment of the present invention.

FIG. 29A is a side view and partial cross-sectional side view of a ceiling mounted heating and cooling device according to an alternate embodiment of the present invention, showing alternate ceiling mounted heating device A-5 attached thereto.

FIG. 30 is a side view of a ceiling mounted heating device according to an alternate embodiment of the present invention showing how a ceiling fan may adapt thereto.

FIG. 31 is a side view of a ceiling mounted heating device according to an alternate embodiment of the present invention showing a ceiling fan adapted thereto.

FIG. 31A is a side view of a ceiling mounted heating device according to an alternate embodiment of the present invention mounted independently of a ceiling fan.

FIG. 32 is a partially exploded view of a ceiling mounted heating device according to an alternate embodiment of the present invention.

FIG. 33 is a fully exploded view of a ceiling mounted heating device according to an alternate embodiment of the present invention.

FIG. 33A is a bottom perspective view of a lower support plate of a ceiling mounted heating device according to an alternate embodiment of the present invention.

FIG. 34 is a schematic diagram of the control circuitry for a ceiling mounted heating device according to an alternate embodiment of the present invention.

FIGS. 35A and 35B illustrate control units and the corresponding actuated heating elements of a ceiling mounted heating device according to an alternate embodiment of the present invention.

FIGS. 36A and 36B illustrate control units and the corresponding actuated heating elements of a ceiling mounted heating device according to an alternate embodiment of the present invention.

FIGS. 37A and 37B illustrate control units and the corresponding actuated heating elements of a ceiling mounted heating device according to an alternate embodiment of the present invention.

FIGS. 38A and 38B illustrate control units and the corresponding actuated heating elements of a ceiling mounted heating device according to an alternate embodiment of the present invention.

FIG. 39 is a partial cross-sectional top view of a ceiling mounted heating device according to an alternate embodiment of the present invention.

FIG. 40 is a partial cut-away, isometric view of the heating module of a ceiling mounted heating device according to an alternate embodiment of the present invention.

FIG. 41 is a partial cross-sectional top view of a ceiling mounted heating device according to an alternate embodiment of the present invention.

FIG. 42 is a cross-sectional side view of a ceiling mounted heating device according to an alternate embodiment of the present invention showing one or more heating devices mounted to the down rod of a ceiling fan.

FIG. 43 is a cross-sectional side view of a ceiling mounted heating device according to an alternate embodiment of the present invention.

### DETAILED DESCRIPTION OF THE PREFERRED AND ALTERNATE EMBODIMENT

In describing the preferred and various alternate embodiments of the present invention, as illustrated in the Figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions. References to three embodiments of previously patented ceiling mounted heating devices, designed and patented by Kenneth H. Reiker to be utilized in association with the present device will be referred to by a reference number associated with the specified patent. U.S. Pat. No. 6,438,322, “Ceiling Fan With Attached Heater and Secondary Fan” will be referred to as A-1, U.S. Pat. No. 6,240,247 “Room Conditioner With Ceiling Mounted Heater” will be referred to as A-2, U.S. Pat. No. 6,366,733 “Ceiling Fan Having One Or More Fan Heaters” will be referred to as A-3, and U.S. Pat. No. 6,477,321, “Ceiling Fan Room Conditioner With Ceiling Fan And Heater,” will be referred to as A-11, all of which are incorporated herein. Final embodiments of patent pending device “Air Recirculating and Heating Device,” referred to herein as A-4, and patent pending device “Ceiling Mounted Heating Device and Method Therefor,” referred to herein as A-5, are described in detail herein.

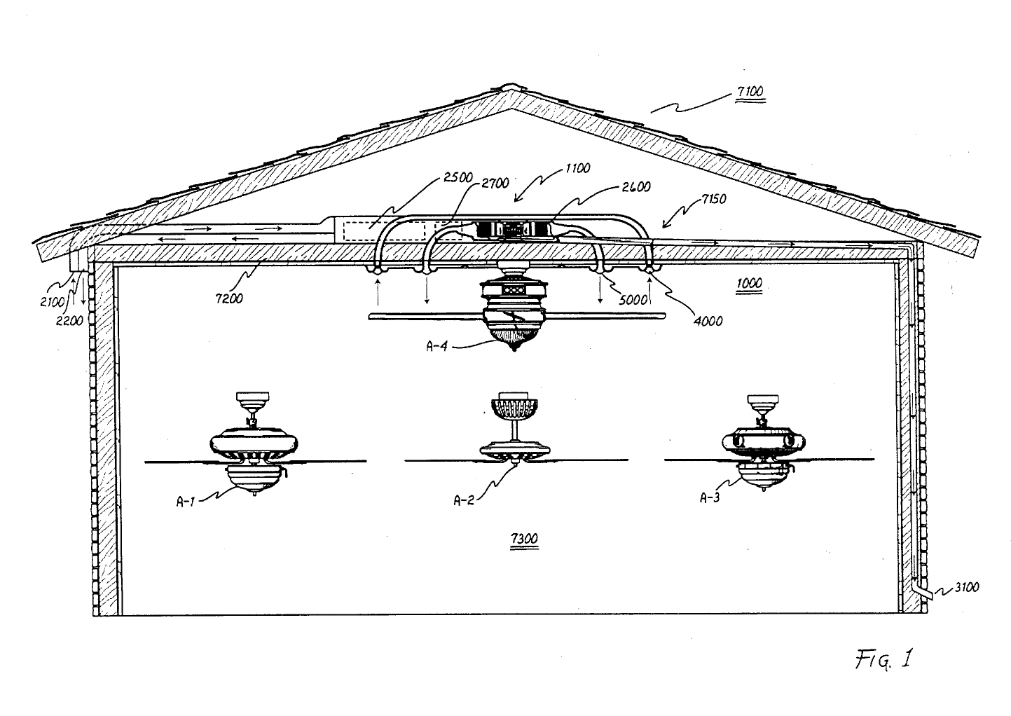

Referring now to FIG. 1, illustrated therein is a preferred ceiling mounted heating and cooling device 1000 mounted preferably to ceiling 7200 of room 7300 of a conventionally framed home 7100. Device 1000 preferably generally possesses air conditioning system 1100 in communication with preferred ceiling mounted heating device A-4, wherein air conditioning system 1100 is preferably disposed upwardly from device A-4 and preferably housed within attic 7150 of home 7100. It is contemplated in an alternate embodiment that the preferred and/or alternate embodiments of ceiling mounted heating devices A-1, A-2, A-3, A-11 and/or A-5 could be utilized in place of the preferred and/or alternate embodiments of device A-4 and in conjunction with air conditioning system 1100 of device 1000, as more fully described below.

In general, air conditioning system 1100 preferably possesses condenser 2500 and associated air inlet 2100 and air outlet 2200; evaporator unit 2600 with associated air inlet assembly 4000 and air outlet assembly 5000; and compressor 2700. An integral part of air conditioning system 1100 is water extraction means 3100, wherein water condensation produced by evaporator unit 2600 is moved outside home 7100, as more fully described below. When device 1000 is in the heating mode, device A-4, or alternatively devices A-1, A-2, A-3, A-11 and/or A-5, preferably operates independently of air conditioning system 1100 to create a heated airflow for subsequent distribution throughout room 7300. When device 1000 is in the cooling mode, device A-4, or alternatively devices A-1, A-2, A-3 and/or A-11, preferably initially functions as a ceiling fan to circulate and blow ambient air onto the occupants of room 7300, and then subsequently to distribute cold air produced by air conditioning system 1100 in either a downward or upward direction, as more fully described below.

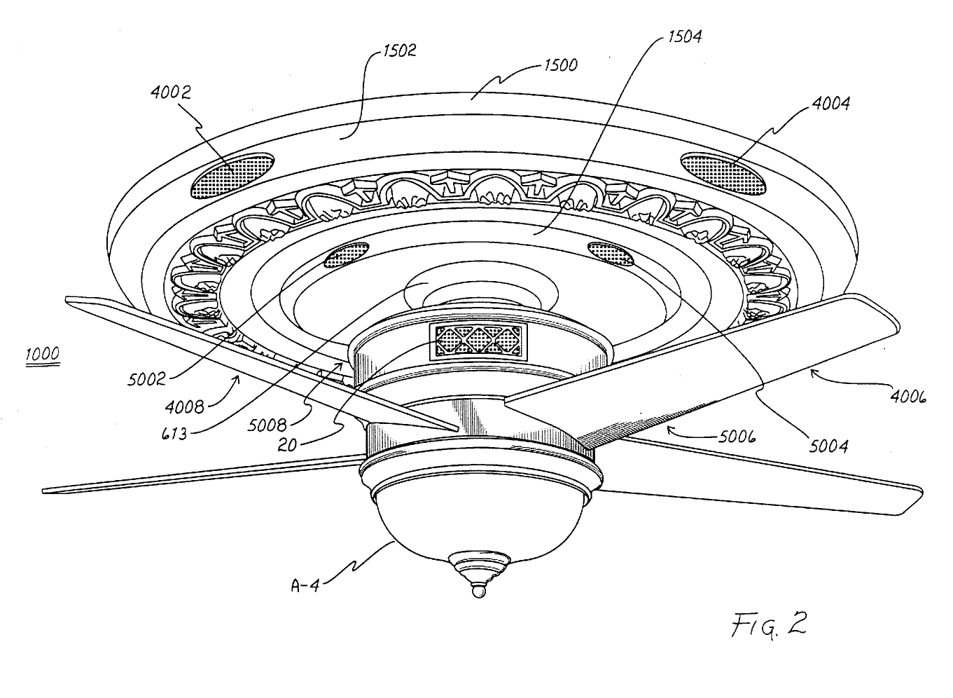

Referring now to FIG. 2, illustrated therein is the preferred external appearance of device 1000 showing device A-4 positioned preferably below and attached to circular-shaped decorative medallion 1500, wherein medallion 1500 is preferably attached to ceiling 7200 to preferably shield from view the internal components of device 1000 housed above ceiling 7200 and preferably within attic 7150, as more fully described below. Screened apertures 4002, 4004, 4006 and 4008 are preferably positioned on and equally spaced around outer periphery 1502 of medallion 1500, wherein screened apertures 4002, 4004, 4006 and 4008 are preferably in communication with inlet assembly 4000 of evaporator 2600, as more fully described below. Screened apertures 5002, 5004, 5006 and 5008 are preferably positioned on and equally spaced around inner periphery 1504 of medallion 1500, wherein screened apertures 5002, 5004, 5006 and 5008 are preferably in communication with outlet assembly 5000 of evaporator 2600, as more fully described below. Inlet assembly 4000 and outlet assembly 5000 of evaporator 2600 preferably function to process a cool airflow in the cooling mode of device 1000, while outlet 20 of device A-4 preferably functions to exhaust a heated airflow in the heating mode of device 1000, as more fully described below.

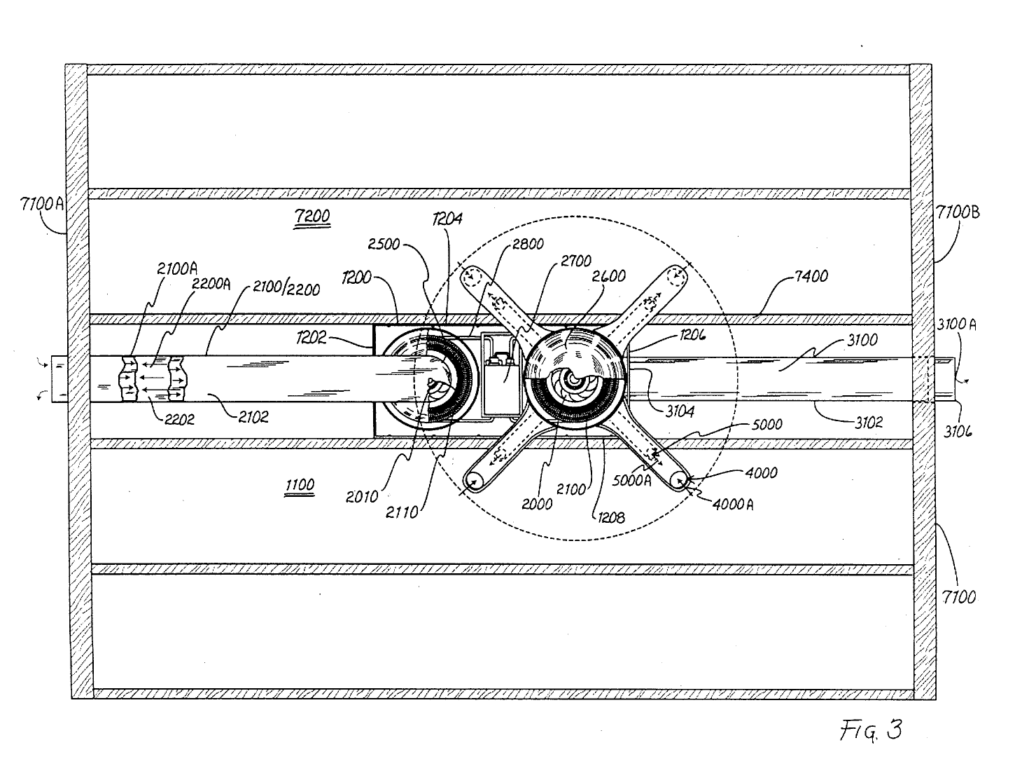

Referring now to FIGS. 3-6A, illustrated therein is air conditioning system/unit 1100 mounted preferably above ceiling 7200, between ceiling joists 7400 and within attic 7150 of home 7100. As known within the art, air conditioning systems function to transfer undesirable heat from within a building to outside the building. Specifically, an air conditioning system is a closed system wherein a compressor compresses cool refrigerant gas, causing the refrigerant gas to become hot, high-pressure gas. The hot gas then runs through a set of coils/heat exchanger, commonly termed a condenser, wherein the gas dissipates/releases its heat and condenses into a liquid via the assistance of a fan blowing air over the hot condenser to transfer excess heat from the hot refrigerant gas to the outside air. The refrigerant liquid then passes through an expansion valve and in the process evaporates, thus becoming a cold, low-pressure gas. The cold gas then runs through another set of coils/heat exchanger, commonly termed an evaporator, that enable the gas to absorb heat from within the building and cool down the air inside the building via the assistance of a fan blowing over the cooled coils/heat exchanger. Although conventional air conditioning systems and technology are known, it is the unique combination of air conditioning systems and technology with previously patented and present patent pending ceiling mounted heating devices that constitute the ingenuity of the present invention.

Preferably, air conditioning system 1100 generally possesses condenser 2500, wherein condenser 2500 preferably generally possesses fan 2010, condenser coils 2110, air inlet means 2100 having inlet airflow 2100a, and air outlet means 2200 having exhaust airflow 2200a, as more fully described below. Preferably, evaporator 2600 generally possesses fan 2000, evaporator coils 2100, air inlet assembly 4000 having inlet airflow 4000a, air outlet assembly 5000 having exhaust airflow 5000a, and water extraction means 3100 having water expulsion direction 3100a, as more fully described below.

Preferably, air conditioning system 1100 is securely packaged within rectangular-shaped container 1200, wherein container 1200 preferably possesses walls 1202, 1204, 1206 and 1208, and bottom 1210, and wherein container 1200 is secured between joists 7400 of home 7100 via insertion of screws or like through walls 1206 and 1208 of container 1200. Preferably, container 1200, in general, is constructed from a nonporous metal material; although other suitable material could be utilized, such as, for exemplary purposes only, plastic. Preferably, filler 1212 surrounds and securely positions condenser 2500, evaporator 2600, compressor 2700 and related components of air conditioning system 1100 within container 1200, wherein filler 1212 is preferably a polystyrene foam or the like, and wherein filler 1212 further preferably functions to muffle sound commonly associated with the general operation of air conditioning system 1100. Condenser 2500 is preferably positioned proximal wall 1202 of container 1200, and evaporator 2600 is preferably positioned proximal wall 1206 of container 1200, wherein compressor 2700 is preferably positioned between condenser 2500 and evaporator 2600; however, it is contemplated in an alternate embodiment that condenser 2500, evaporator 2600 and compressor 2700 could be positioned and arranged within container 1200 in any suitable manner that best accommodates application/installation of device 1000 within ceiling 7200 and attic 7150 of home 7100.

Preferably, condenser 2500 is a circular-shaped unit having fan 2010 centrally positioned within and surrounded by condenser coils 2110, wherein fan 2010 is preferably in communication with air inlet means 2100 and air outlet means 2200, and wherein condenser coils 2110 are preferably conventional condenser coils as known within the art. Specifically, air inlet means 2100 is a preferably rectangular-shaped tube 2102 having end 2104 and opposing end 2106, wherein end 2104 is preferably in direct communication with fan 2010 to enable the provision of air thereto, and wherein end 2106 is preferably positioned to the exterior of home 7100 so as to enable the drawing of air therefrom by fan 2010, as more fully described below. Similarly, air outlet means 2200 is a preferably rectangular-shaped tube 2202 preferably positioned below tube 2102 and having end 2204 and opposing end 2206, wherein end 2204 is preferably in direct communication with cavity 2500a of condenser 2500 to enable the expulsion of heated air therefrom, and wherein end 2206 is preferably positioned to the exterior of home 7100 so as to enable the heated air in cavity 2500a to be relived therefrom, as more fully described below. Preferably, tubes 2102 and 2202 extend from condenser 2500, past wall 1202 of container 1200, through joists 7400 of home 7100 and through wall 7100a of home 7100 to facilitate the exchange of air therethrough.

Compressor 2700 is preferably a conventional air conditioning compressor unit as known within the art, preferably possessing copper tubing 2900 in communication with condenser 2500 and evaporator 2600 to enable the conveyance of refrigerant gas thereto during operation of air conditioning system 1100. Compressor 2700 further possesses expansion valve 2800 for the conversion of chemical refrigerant into a cooled gas as known within the art.

Evaporator 2600 is a preferably circular-shaped unit having fan 2000 centrally positioned within and surrounded by evaporator coils 2100, wherein fan 2000 is preferably in communication with inlet assembly 4000 and outlet assembly 5000, and wherein evaporator coils 2100 are preferably conventional evaporator coils as known within the art. Specifically, air inlet assembly 4000 preferably possesses tubular-shaped tubes 4010, 4012, 4014 and 4016 having ends 4010a, 4012a, 4014a and 4016a, respectively and opposing ends 4010b, 4012b, 4014b and 4016b, respectively, wherein ends 4010a, 4012a, 4014a and 4016a are preferably in direct communication with fan 2000 such that tubes 4010, 4012, 4014 and 4016 are equally-spaced thereabout and extend preferably outwardly therefrom to enable the provision of air thereto, and wherein ends 4010b, 4012b, 4014b and 4016b are preferably positioned to extend to and communicate with screened apertures 4002, 4004, 4006 and 4008, respectively, of medallion 1500 attached to ceiling 7200 of home 7100, so as to enable the drawing of air therefrom by fan 2000, as more fully described below. Similarly, air outlet assembly 5000 preferably possesses tubular-shaped tubes 5010, 5012, 5014 and 5016 having ends 5010a, 5012a, 5014a and 5016a, respectively and opposing ends 5010b, 5012b, 5014b and 5016b, respectively, wherein ends 5010a, 5012a, 5014a and 5016a are preferably in direct communication with cavity 2600a of evaporator 2600 to enable the expulsion of cooled air therefrom, and wherein ends 5010b, 5012b, 5014b and 5016b are preferably positioned to extend to and communicate with screened apertures 5002, 5004, 5006 and 5008, respectively, of medallion 1500 attached to ceiling 7200 of home 7100, so as to enable the expulsion of cooled air from cavity 2600a of evaporator 2600 into room 7300 of home 7100, as more fully described below. Preferably, tubes 4010, 4012, 4014, 4016, 5010, 5012, 5014 and 5016 are generally downwardly arcuate-shaped to best facilitate the channeling of air into and out of room 7300 of home 7100.

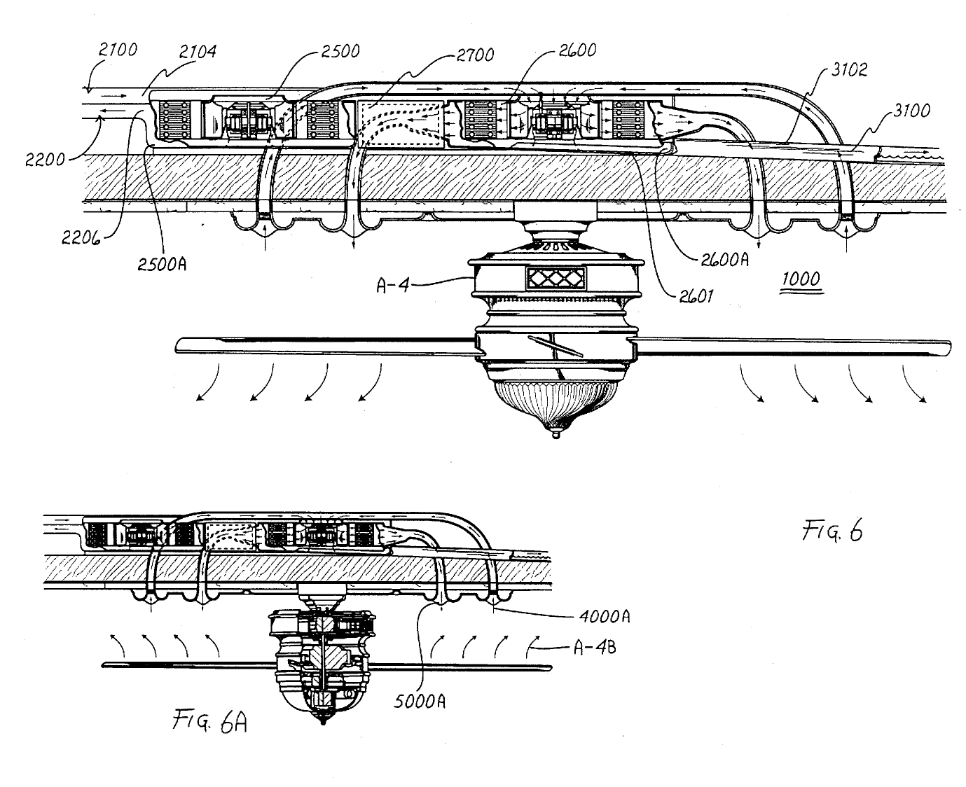

Water extraction means 3100 is a preferably rectangular-shaped tube 3102 having end 3104 and opposing end 3106, wherein end 3104 is preferably in direct communication with cavity 2600a of evaporator 2600 to enable the expulsion of condensed water therefrom, and wherein end 3106 is preferably positioned to the exterior of home 7100 so as to enable the water from cavity 2500a to be relived therefrom preferably in direction 3100a, as more fully described below. Preferably, tube 3102 extends from evaporator 2600, past wall 1204 of container 1200, through joists 7400 of home 7100 and through wall 7100b of home 7100. As best illustrated in FIG. 6, to assist in the gravitational expulsion of water from out of cavity 2600a of evaporator 2600, bottom wall 2601 of cavity 2600a is preferably downwardly angled, as is tube 3102 extending therefrom, to ensure that condensed water is removed therefrom and to prevent the occurrence of standing water within cavity 2600a and/or undesirable leakage/overflow of condensed water onto ceiling 7200 of room 7300 of home 7100.

In operation, fan 2010 of condenser 2500 preferably draws inlet airflow 2100a from the exterior of home 7100 through tube 2102 of air inlet means 2100, wherein inlet airflow 2100a preferably then passes through condenser coils 2110, thus transferring the heat from chemical refrigerant gas into cavity 2500a of condenser 2500 to be subsequently exhausted from home 7100 via tube 2202 of air outlet means 2200 as exhaust airflow 2200a. Fan 2000 of evaporator 2600 preferably draws inlet airflow 4000a from room 7300 via tubes 4010, 4012, 4014 and 4016 of inlet assembly 4000, wherein inlet airflow 4000a then passes through evaporator coils 2100 to create a cooled airflow 5000a that preferably passes into cavity 2600a of evaporator 2600 prior to exhausting into the room 7300 to be cooled. Compressor 2700 preferably moves chemical refrigerant through copper piping 2900 into condenser coils 2110, wherein the chemical refrigerant is then cooled and turned into a liquid. After becoming a liquid, the chemical refrigerant then travels through expansion valve 2800 where it is turned into a cooled gas, wherein the cooled gas is then conveyed into evaporator coils 2100 for subsequent transfer of cooled temperatures/airflows into room 7300 as described above.

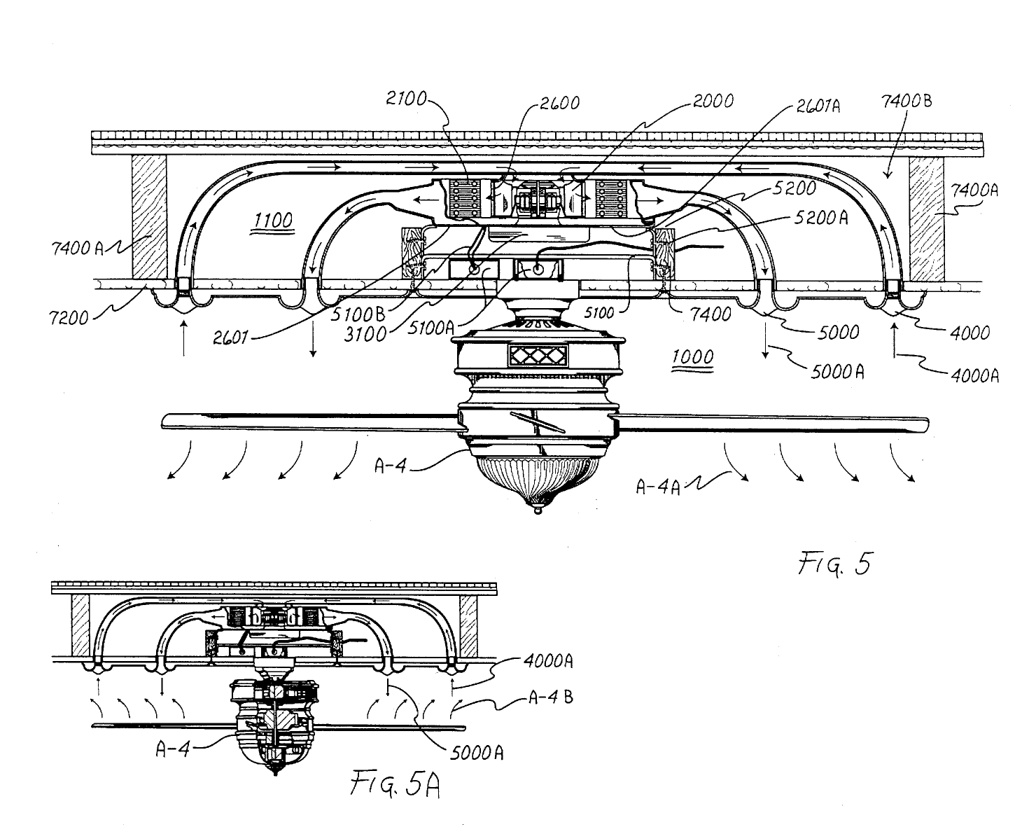

Referring specifically now to FIG. 5, cooled airflow 5000a produced by air conditioning system 1100 and exhausted through outlet assembly 5000 is preferably mixed or integrated with downward airflow A-4a created by heating device A-4, wherein the mixed airflows 5000a and A-4a are preferably then distributed throughout room 7300. As best illustrated in FIG. 5a, it is contemplated in an alternate embodiment that ceiling mounted heating device A-4 could also operate to create an upward airflow A-4b for mixing with and distributing cooled airflow 5000a throughout room 7300. Referring back to FIG. 5, further illustrated therein is ceiling 7200 and upper floor 7200A, wherein joists 7400a positioned and secured therebetween preferably form cavity 7400b between ceiling 7200 and upper floor 7200a, thus permitting air conditioning unit 1100 to be situated therein. Preferably, side 2601A of bottom wall 2601 of evaporator 2600 possesses bracket 5200 formed thereto, wherein bracket 5200 preferably enables the positioning and securing of air conditioning unit 1100 to joists 7400 via the assistance of screws 5200a. Standard ceiling fan brace 5100, electrical boxes 5100a and wiring 5100b preferably assist in the conveyance of electrical power to device 1000. As more fully described below, preferably attached to ceiling 7200 and in communication with air conditioning unit 1100 is ceiling mounted heating device A-4.

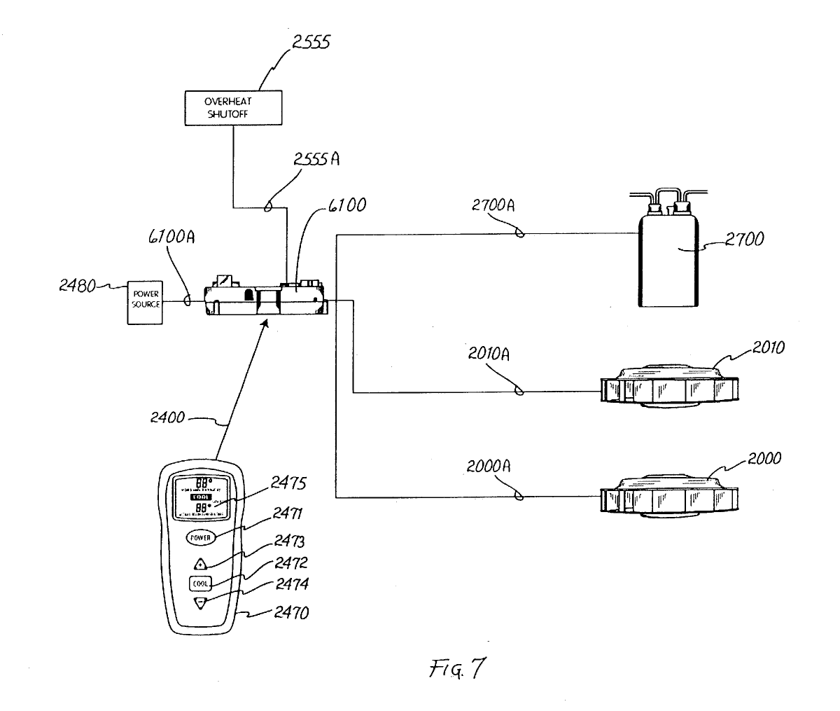

Referring now to FIG. 7, illustrated therein is a schematic diagram of a preferred apparatus for controlling operation of air conditioning device 1100 of device 1000. Remote control receiver unit 6100 and preferred transmitter 2470 are preferably commercially derived units that rely on digital readouts and computerization for size. Contained within the functions of transmitter 2470 and remote control receiver unit 6100 are air conditioning device 1100 activation and deactivation switches, switches for activating condenser fan 2010, evaporator fan 2000 and compressor 2700 via the assistance of wiring 2010a, 2000a and 2700a, respectively. Transmitter 2470 further preferably possesses power button 2471 for activation of air conditioning system 1100; cool mode button 2472 for activation of the cool mode of operation of air conditioning system 1100; and temperature adjustment buttons 2473 and 2474 to set the desired temperature of deactivation of air conditioning system 1100, or alternatively, for adjusting the temperature of cooled airflow 5000a. Digital display 2475 is preferably activated upon depressing power button 2471, wherein display 2475 preferably indicates the desired mode of operation and user-selected operating features such as current temperature and/or other programmed features.

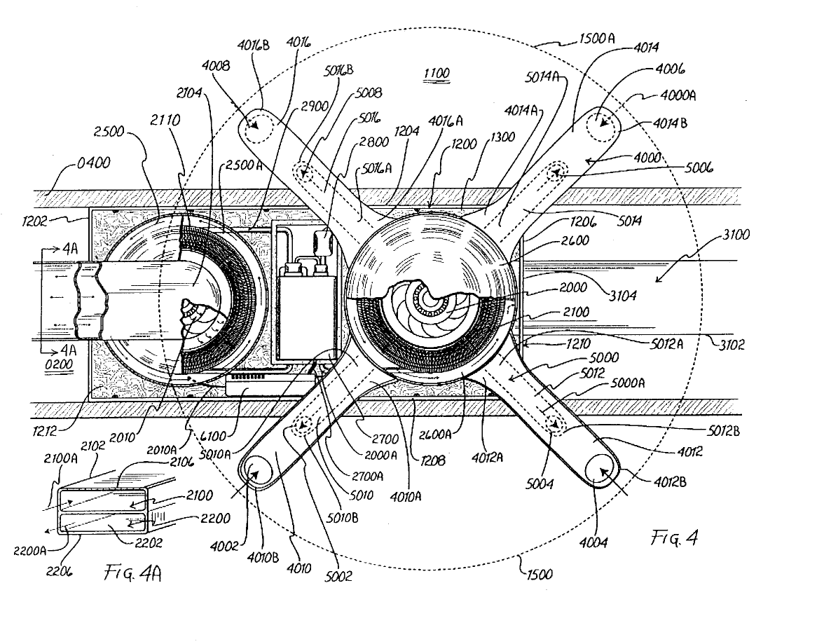

There are various ways in which to activate and deactivate an air conditioning unit, including, but not limited to, analog switches, pull chains, buttons, timers, thermostats, remote control devices and/or via any other suitable means as known within the art. Remote control receiver unit 6100 preferably receives control signals 2400 from transmitter 2470, wherein remote control receiver unit 6100 is preferably positioned between condenser 2500 and compressor 2700 within container 1200, as best illustrated in FIG. 4. It is contemplated in an alternate embodiment that remote control receiver unit 6100 could be positioned in any suitable location for the remote controlled operation of air conditioning unit 1100. Source of power 2480, such as, for exemplary purposes only, a conventional 120/220-volt alternating current, preferably provides power to remote control receiver unit 6100 via conductors 6100A; or, in an alternate embodiment, remote control receiver unit 6100 may be battery and/or solar power operated. Transmitter 2470 may also be battery powered or hard wired to a source of conventional 120/220-volt alternating current. On command, remote control receiver unit 6100 preferably energizes compressor 2700, condenser fan 2010 and evaporator fan 2000, wherein energization of compressor 2700 preferably enables chemical refrigerant to begin flowing through evaporator coils 2100 and condenser coils 2110, and wherein energization of evaporator fan 2000 and condenser fan 2010 preferably enables air to flow across evaporator coils 2100 and condenser coils 2110, respectively. For safety precautions, a preferred overheat shut-off module 2555 is preferably connected to remote control receiver unit 6100 via preferred conductor 2555a to preferably enable the de-energization of compressor 2700, condenser fan 2010 and evaporator fan 2000 upon overheating of same.

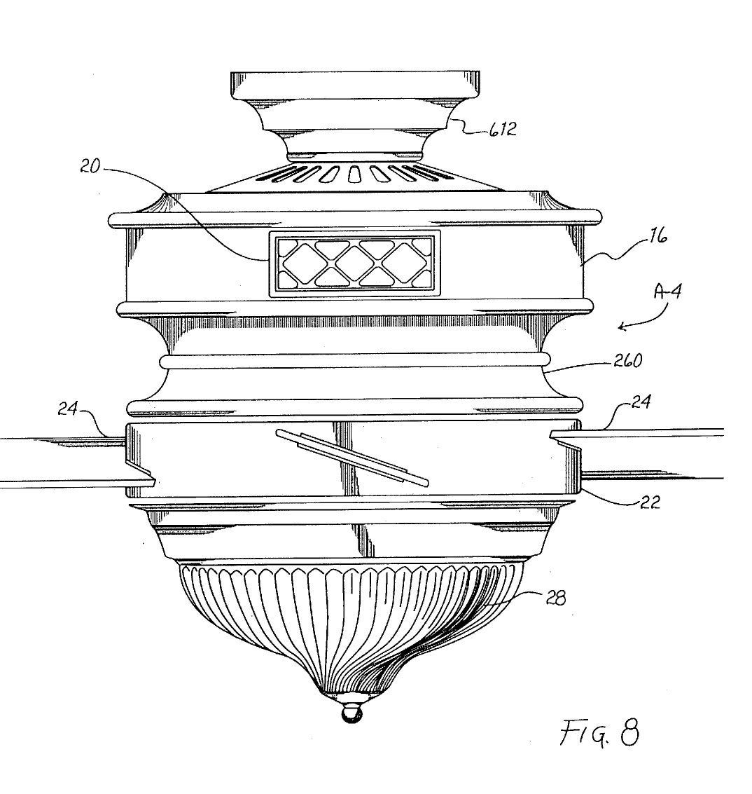

Referring now to FIG. 8, illustrated therein is a preferred ceiling mounted air recirculating and heating device A-4 enclosed within optional decorative housing, wherein heating device A-4 is preferably in communication with air conditioning unit 1100, as more fully described below. It is to be understood that the exterior configuration illustrated in FIG. 8 is simply one of a multitude of decorative exterior configurations that may be utilized. Heating device A-4 is preferably adapted from an upward location within room 7300 of home 7100, such as ceiling 7200 of room 7300, wherein a preferred cover 612 preferably shields the support and attachment mechanisms, as more fully described below. Heating device A-4 further comprises a preferred heating module 16, wherein heating module 16 has preferred outlets 20 disposed thereabout. Outlets 20 preferably provide a primary airflow path for heated air as a function of the amount of heating to be performed. A preferred auxiliary fan module 22 preferably comprises a preferred auxiliary fan motor 116 for rotating fan blades 24 to produce a secondary airflow, wherein secondary airflow is preferably upward during a heating phase and preferably downward during a cooling phase. Shroud 260 is preferably disposed between heating module 16 and auxiliary fan module 22 and an optional light module 28 is preferably adapted to auxiliary fan module 22, as more fully described below.

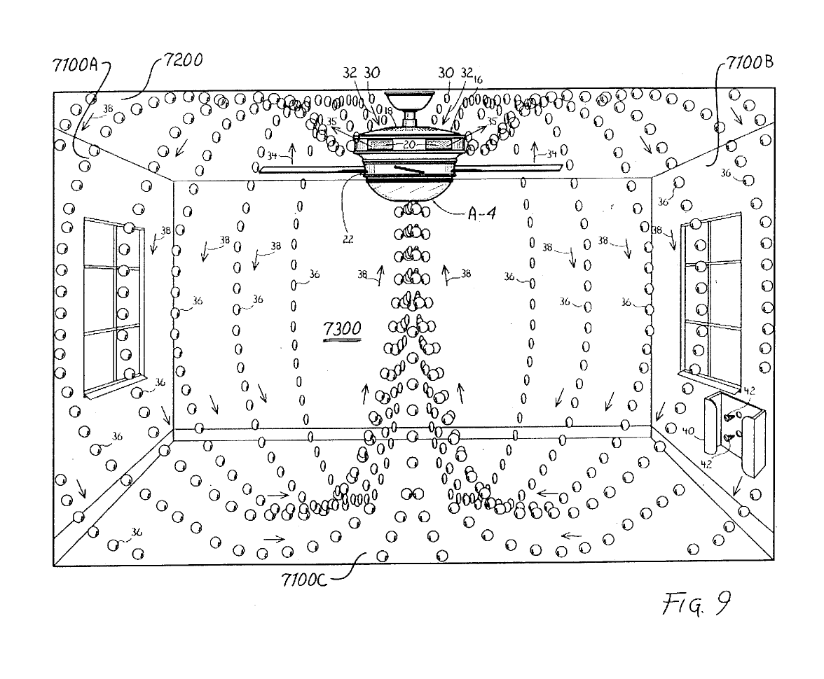

Referring now to FIG. 9, illustrated therein is the preferred operation of air recirculating and heating device A-4 when operating in the heating phase. Upon energization of heating module 16, molecules of air, represented by a stream of circles 30, are moved through preferred inlets 18 disposed on heating module 16, as representatively depicted by arrows 32. These molecules of air are heated within heating module 16 and exhausted as a primary heated airflow 35 through outlets 20. Upon energization of heating module 16, auxiliary fan module 22 is also energized to produce an upward secondary airflow 34, as depicted by arrows 34. Upward secondary airflow 34 preferably mixes with primary heated airflow 35 as secondary airflow 34 flows upwardly toward ceiling 7200 of room 7300. As depicted by a plurality of streams of molecules 36, the mixture of primary and secondary airflow preferably flows upwardly toward ceiling 7200, along ceiling 7200, downwardly along walls 7100a and 7100b, across floor 7100c and upwardly beneath air recirculating and heating device A-4. Arrows 38 appearing throughout FIG. 9 designate the movement of plurality of streams of heated air molecules 36.

Windows of a room are historically and notoriously responsible for adjacent cold spots resulting in downwardly flowing air thereby causing discomfort to an occupant in proximity to the window. As depicted in FIG. 9, the energy of heated air molecules 36 is sufficient to cause a scrubbing action as it flows adjacent the window(s) thereby resulting in the dislodging of the cold air molecule layer. Through such dislodgment, the cold air molecules are replaced with warm air molecules on a continuing basis resulting in warming of the window. Such removal of the cold air molecules and warming of the interior window surface will essentially eliminate the cold spots formerly associated with each window. As heated air molecules 36 continuously move throughout room 7100, a near uniform air temperature throughout the room corresponding with a preset desired temperature is preferably established and maintained without the production of unwanted hot and/or cold spots. Moreover, it is less expensive to maintain a desired temperature for a room having near uniform temperatures.

As more fully described below, a preferably portable control unit for setting the desired room temperature is provided, wherein portable control unit preferably comprises a thermostat and controls for selectively activating heating device A-4. Consequently, a user can position portable control unit at an elevation (i.e., floor, sofa or standing) that more accurately reflects his desired temperature at that level, thereby ensuring that heating device A-4 is controlled accurately to provide the desired temperature. In an alternate embodiment, the control unit may be attached to a wall of the room at a convenient location. The preferred or alternate embodiment of the control unit may be either automatically operated or manually operated. For illustrative purposes, a holder 40 (not to scale for purposes of clarity) for holding the control unit may be attached to a wall or other convenient surface by screws 42 or the like. As more fully described below, the control unit is preferably a wireless unit preferably using transmitted radio frequency (RF) signals preferably received by a receiver disposed within air recirculating and heating device A-4. Alternatively, other means for wireless transmission such as, for exemplary purposes only, infrared (IR) signals or any means known within the art may be utilized. Such a transmitter/receiver control unit eliminates the need for rewiring the wall and ceiling, which is of particular benefit when installing an air recirculating and heating device A-4 in an existing building. It should also be noted that the RF signals transmitted could be at different frequencies for various air recirculating and heating devices such that different control units will control different air recirculating and heating devices A-4. It is further contemplated that if infrared or other short-range signal control unit is utilized, one control unit could be utilized to operate a multitude of air recirculating and heating devices A-4, wherein the control unit is in relatively close proximity thereto. Alternatively, an RF or IR signal could be encoded to minimize inadvertent operation of another air recirculating and heating device A-4. Additionally, a single control unit could have controls for selectively controlling a multitude of air recirculating and heating devices A-4.

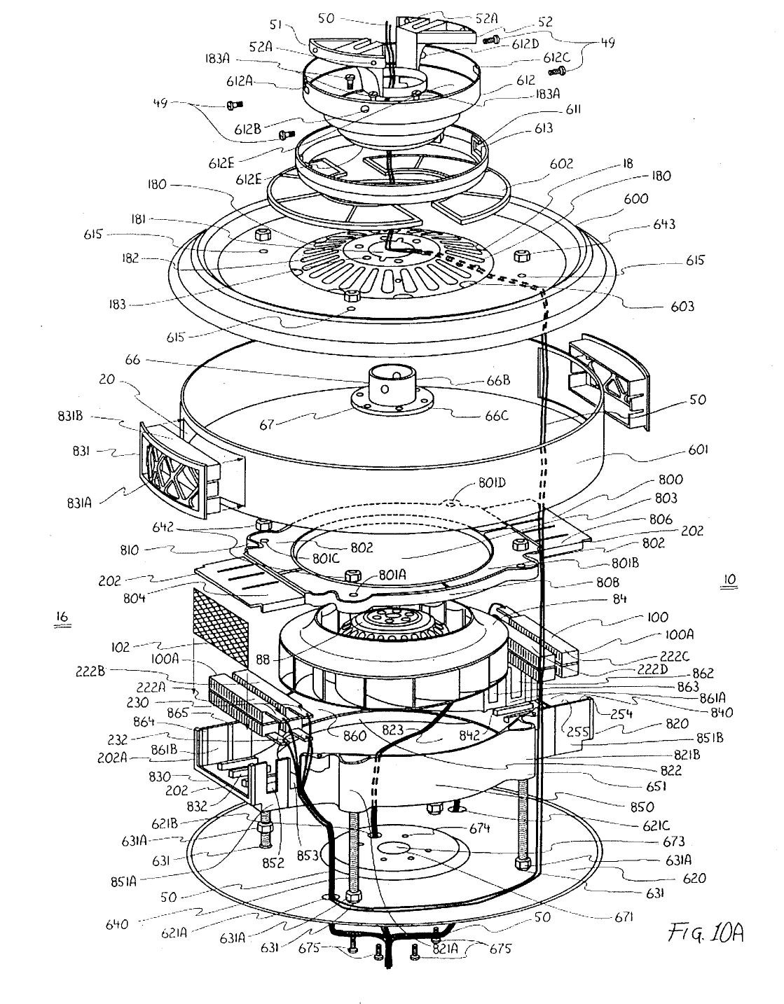

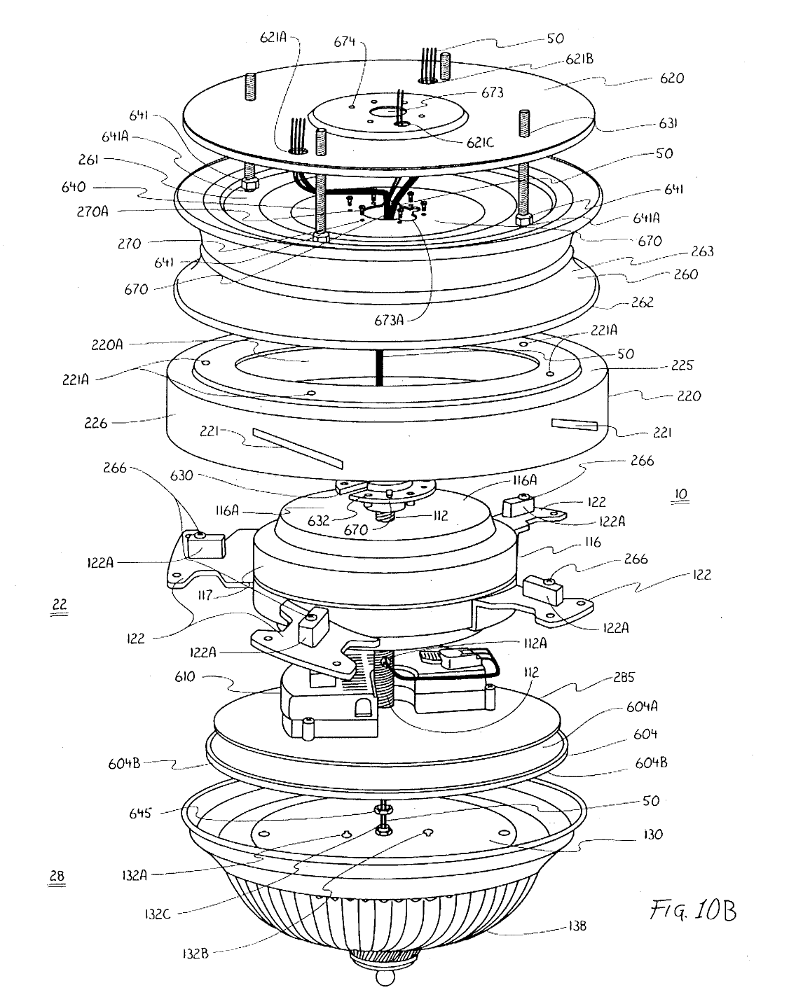

The presently preferred embodiment of the air recirculating and heating device A-4 is illustrated in FIGS. 10A-10C. Referring specifically now to FIG. 10A, a preferred support means 51 is preferably housed within cover 612, wherein support means 51 preferably comprises a preferred bracket 52 preferably attached to a conventional electrical box (not shown) and further attached to a joist in the ceiling or similar support member. A plurality of electrical conductors 50 are preferably electrically connected to a source of power within the ceiling and channeled through cover 612 as well as through the length of heating device A-4 so as to provide power to the various electrical components of heating device A-4. Cover 612 is preferably bowl-shaped and preferably has a preferred passage 612E centrally positioned and defined therethrough for the passage of electrical conductors 50 therethrough. Bracket 52 preferably protrudes from ceiling 7200 of room 7300 and through decorative medallion 1500, wherein cover 612 is preferably attached to bracket 52 preferably via insertion of preferred screws 49 into preferred throughholes 612A, 612B, 612C and 612D formed around the upper periphery of cover 612, and thereafter through preferred throughholes 52A formed on bracket 52. A preferred dress ring 613, comprising preferred slots 611 is then slid over cover 612 and turned such that slots 611 slidably engage screws 49. Dress ring 613 preferably serves to both cosmetically cover screws 49 and prevent the unwanted loosening of screws 49.

Heating module 16 preferably generally comprises a preferred upper support plate 600, a preferred lower support plate 620, a preferred inlet ring 601, a preferred upper heat shield 800, a preferred lower heat shield 820, a preferred motor 88, a preferred impeller 84 and preferred heating elements 100. Upper support plate 600 is preferably circular shaped and has a preferably centrally located shallow preferred cone section 180, wherein cone section 180 further has a preferred boss aperture 181 centrally positioned thereon and dimensioned for receiving a preferred boss 66. Preferably radially positioned around boss aperture 181 is a plurality of preferred radial slots 182 defining inlets 18 for airflow therethrough and into heating module 16 for heating. Located between radial slots 182 and boss aperture 181 are a plurality of preferred throughholes 183, wherein throughholes 183 are aligned with preferred throughholes 612F (not shown) positioned on the lower end of preferred cover 612, and wherein throughholes 183 are aligned with preferred throughholes 67 on preferred boss 66. Insertion of screws 183A through throughholes 612F, through throughholes 183 and through throughholes 67 secures upper support plate 600 between cover 612 and boss 66.

Specifically, upper support plate 600 is attached to boss 66 by sliding preferred head portion 66B of boss 66 through boss aperture 181 and aligning throughholes 183 of upper support plate 600 with throughholes 67 found on rim portion 66C of boss 66 and attaching the two via preferred screws 183A.

Preferably covering inlets 18 is a preferred filter 602, wherein filter 602 is preferably two C-shaped filters that are held in place by preferred tabs 603 located around the periphery of cone section 180. Filter 602 preferably serves to prevent accumulation of dust on the internal components of heating module 16.

Lower support plate 620 is preferably circular-shaped and has a preferably centrally located preferred mounting section 671, wherein mounting section 671 further has a preferred aperture 673 centrally positioned thereon and dimensioned for receiving the lower mounting location of motor 88 of impeller 84. Preferably radially positioned around aperture 673 is a plurality of preferred throughholes 674 for preferably attaching motor 88 and impeller 84 to mounting section 671 via preferred screws 675. Extending around mounting section 671 are preferably four equally spaced preferred throughholes 631 that are dimensioned to preferably each receive one of four preferred threaded posts 640, wherein threaded posts 640 stem from and are adapted to preferred decorative shroud 260 positioned below lower support plate 620, and wherein threaded posts 640 further function to secure all components of heating module 16 together. Lower support plate 620 further comprises preferably three preferred throughholes 621A, 621B and 621C for the channeling therethrough of electrical conductors 50 to the various electrical components of heating device A-4.

Positioned on and adapted to lower support plate 620 is preferred lower heat shield 820, wherein lower heat shield 820 comprises a generally circular shaped preferred body 822 having preferably two opposing substantially rectangular preferred planks 830 and 840 attached thereto. Body 822 preferably has a preferred aperture 823 centrally formed therethrough to permit contact between mounting section 671 of lower support plate 620 with motor 88 and impeller 84 and for attachment thereto via attaching screws 675. Extending around the periphery of body 822 and planks 830 and 840 are preferred walls 850 and 860, wherein wall 850 further comprises integrally formed preferred channels 821A and 821B and wall 860 further comprises integrally formed preferred channels 821C and 821D. Channels 821A-821D are dimensioned to receive threaded posts 640 when heating module 16, and heating device A-4 in general, is being assembled.

A preferred wall portion 851A of wall 850 proximal to plank 830 comprises preferred slots 852 and 853 formed thereon, and a preferred wall portion 861A of wall 860 proximal to plank 840 comprises preferred slots 862 and 863 formed thereon, wherein slots 852, 853, 862 and 863 are dimensioned to snuggly receive preferred tabs 230 and 232 of each preferred heating element 100. Furthermore, a preferred wall portion 851B of wall 850 proximal to plank 840 comprises preferred ridges 854 and 855 (not shown) formed thereon, and a preferred wall portion 861B of wall 860 proximal to plank 830 comprises preferred ridges 864 and 865 formed thereon, wherein the slots formed by ridges 854, 855, 864 and 865 are dimensioned to snuggly receive preferred ends 100A of each heating element 100. The distal ends of each plank 830 and 840 have a preferred slot 202 formed therein, wherein slot 202 is contiguous with preferred slots 202A formed on the distal ends of walls 850 and 860. Slots 202 and 202A are dimensioned to snuggly receive preferred protective screens 102, wherein protective screens 102 function to prohibit direct access to heating elements 100; yet still permit the egression of primary heated air 35 therethrough.

Preferably two juxtaposed preferred heating elements 222A and 222B are positioned on plank 830 and further rest on preferred supports 832 formed on plank 830. Likewise, preferably two juxtaposed preferred heating elements 222C and 222D are positioned on plank 840 and further rest on preferred supports 842 formed on plank 840. When heating elements 222A and 222B are positioned on plank 83q, tabs 230 and 232 of heating element 222A are situated within slot 852 and tabs 230 and 232 of heating element 222B are situated within slot 853. Similarly, when heating elements 222C and 222D are positioned on planks 840, tabs 230 and 232 of heating element 222C are situated within slot 862 and tabs 230 and 232 of heating element 222D are situated within slot 863. Heating elements 222A-222D are preferably generally elongated rectangular in shape and are dimensioned to be received within the confinements created by planks 830 and 840 and walls 850 and 860 of lower heat shield 820.

Referring specifically now to FIG. 10C, preferred impeller 84 and accompanying preferred motor 88 are illustrated therein, wherein impeller 84 and accompanying motor 88 are preferably positioned within body 822 of lower heat shield 820. Impeller 84 and accompanying motor 88 are preferably generally circular shaped and dimensioned to fit within the confinements inherent in the size of lower heat shield 820. Preferably, a preferred stator 90 of impeller 84 is mounted to mounting section 671 of lower heat shield 820 via insertion of screws 675 through throughholes 674 in mounting section 671 and into preferred holes 90A (not shown) of stator 90. In communication with stator 90 is a preferred rotor 86 having a preferred mounting 94 for attachment to a cylindrical segment of a preferred base 172 of impeller 84. Rotor 86 preferably includes a plurality of preferred apertures 87 formed in preferred upper housing 86A of rotor 86; further apertures, not shown, may be formed in top central preferred surface 89 of rotor 86. These apertures serve a primary purpose of ventilating preferred motor 88 to prevent a destructive heat build up. Preferably, a plurality of preferred curved vanes 174 extend upwardly from base 172 and are attached to a preferred upper member 176 defining a preferred circular opening 178, wherein circular opening 178 defines an inlet for impeller 84 from which air is drawn. Vanes 174, base 172 and upper member 176 may be constructed as separate components of similar or dissimilar material or molded as a single unit of the same material. Preferably, impeller 84 draws air through inlets 18 in upper support plate 600, pulling it through circular opening 178 and then exhausting the air laterally past heating elements 222A-222B and through outlets 20 proximal to heat shields 800 and 820.

It should be noted that there are various other configurations and combinations of fan and motor assemblies, such as, for exemplary purposes only, brushless motors, motors with stators and rotors, squirrel cage, blower, impeller fans and any other known means or devices that may be utilized. It should be construed that preferred impeller 84 with preferred motor 88 and its stator 90 and rotor 86 configuration as described herein to create a primary airflow could be any or all of the possible configurations described above or their equivalence and remain within the scope of the present invention. It is to be understood that preferred motor 88 and impeller 84 are commercially available from appropriate sources.

Referring again to FIG. 10A, heating elements 222A-222D, impeller 84 and accompanying motor 88 and protective screens 102 carried by lower heat shield 820 are covered by a preferred upper heat shield 800, wherein upper heat shield 800 caps lower heat shield 820. Upper heat shield 800 comprises a generally circular-shaped preferred body 802 having preferably two opposing substantially rectangular-shaped preferred planks 804 and 806 attached thereto. Body 802 preferably has a preferred aperture 803 centrally formed therethrough to permit impeller 84 to draw air therefrom and into heating module 16. Extending around the periphery of body 802 and planks 804 and 806 are preferred lips 808 and 810. Upper heat shield 800 in general is of the same shape of lower heat shield 820, but is fractionally larger than lower heat shield 820 such that when upper heat shield 800 is brought into contact with lower heat shield 820, lip 808 sits over wall 850 of lower heat shield 820, lip 810 sits over wall 860 of lower heat shield 820, and preferably four throughholes 801A-801D formed on body 802 and around the periphery of aperture 803 are aligned with channels 821A-D, respectively, of lower heat shield 820. Moreover, when upper heat shield 800 is joined with lower heat shield 820 is such a manner, the distal ends of planks 804 and 806 have defined thereunder slots 202 (not shown), dimensioned to fit over protective screens 102.

Although thermally insulative material, such as high-temperature plastic or ceramic, is the preferred material for heat shields 800 and 820, there are various other methods and materials contemplated for isolating heating elements 100 (i.e., 222A-222D) from components affected by adverse heat. Among them, but not limited to, are other thermally insulative materials, heat sink heat shield materials, reflective materials, distancing heating elements 100 from adjacent components and/or via other suitable means as known within the art. There are also various electric heating elements 100 that may serve the same purpose. Among them, but not limited to, are PTC, ceramic, coiled wire or any other known method or materials including their equivalence. Denying consumer access, as a safety precaution, to heating elements 100 can be performed in various ways. Among them, but not limited to, are screens such as screens 102, bars, molded plastic, wire mesh and/or any other known methods or devices including their equivalence. It should be construed that the preferred heat shields 800 and 820, heating elements 100 and screens 102 as used in this specification implies that any or all of the possible elements, listed above and their equivalence, are within the scope of the invention.

Preferably positioned around the joined upper and lower heat shields 800 and 820, respectively, is preferred inlet ring 601, wherein inlet ring 601 is a substantially circular flat ring defining preferably two opposing substantially rectangular outlets 20. When inlet ring 601 is placed around combined upper and lower heat shields 800 and 820, respectively, outlets 20 are aligned with protective screens 102. Outlets 20 each further carry a preferred insert 831 having a preferred screened end 831A attached to a preferred insert end 831B, wherein insert end 831B is dimensioned to fit within outlet 20 and abut heat shields 800 and 820 upon full insertion of insert 831, thereby ensuring the complete channeling and exhaustion of primary heated airflow 35 past heating elements 100, through insert end 831B and outlets 20 and past screened end 831A for mixture with secondary airflow 34.

Combined inlet ring 601 and heat shields 800 and 820 with enclosed impeller 84, motor 88, heating elements 100 and protective screens 102, are then secured between upper and lower support plates 600 and 620, respectively, via the aid of threaded posts 640. Threaded posts 640 extend first from support shroud 260 (as shown in FIG. 10B) and then through throughholes 631 of lower support plate 620, wherein lower support plate 620 is further secured thereto via preferred nuts 631A. Threaded posts 640 then extend through channels 821A-821D of lower heat shield 820, each channel 821A-821D receiving one threaded post 640. Threaded posts 640 next extend through throughholes 801A-801D of upper heat shield 800, each of throughholes 801A-801D receiving one threaded post, and are secured thereto via preferred nuts 642. Threaded posts 640 are finally extended through throughholes 615 on upper support plate 600 and secured thereto via preferred nuts 643, thereby securing inlet ring 601 between upper and lower support plates 600 and 602, respectively, such that inlet ring 601 encircles heat shields 800 and 820, thus securely housing within heat shields 800 and 820 impeller 84, motor 88, heating elements 100 and protective screens 102.

Referring specifically now to FIG. 10B, preferred decorative shroud 260 is preferably circular-shaped, comprising a preferred upper wall 261 joined to a preferably concave preferred peripheral wall 263, forming a hollow enclosure for partially housing auxiliary fan motor 116. Threaded posts 640 preferably extend through holes 641A formed preferably on upper wall 261 and are secured thereto via preferred nuts 641, wherein nuts 641 further function as spacers to provide the proper mounting height for the mounting of lower support plate 620 to decorative shroud 260. Upper wall 261 preferably comprises a recessed mounting section 670, wherein mounting section 670 preferably defines preferred coupler aperture 673A centrally positioned thereon and dimensioned for receiving the upper end of a coupler 630 of auxiliary fan module 22 for secured mounting and support of auxiliary fan module 22 thereto. Preferably radially positioned around coupler aperture 673A is a plurality of preferred throughholes 270 for preferably attaching coupler 630 thereto via preferred screws 270A. Coupler aperture 673A further functions as a passageway for extension of electrical conductors 50 therethrough.

Decorative ring 220 is preferably circular-shaped and preferably comprises a preferred top surface 225 joined to a preferred peripheral wall 226, wherein preferably four preferred throughholes 221A are formed around the periphery of top surface 225. Peripheral wall 226 preferably comprises four equally spaced preferred slots 221 dimensioned to each receive one of preferably four preferred fan blades 24 (see FIG. 8) adapted to preferred brackets 122, wherein brackets 122 are further adapted to auxiliary fan motor 116. Decorative ring 220 further defines a centrally positioned preferred aperture 220A for extension of electrical conductors 50 therethrough and for receiving upper portion 116A of auxiliary fan motor 116. Decorative ring 220 further functions to hide from view brackets 122 and auxiliary fan motor 116. Decorative ring 220 is attached to brackets 122 via insertion of preferred screws 266 through preferred throughholes 221A and into preferred spacers 122A positioned on brackets 122. As such, in operation, decorative ring 220 rotates in unison with auxiliary fan motor 116.

Auxiliary fan module 22 preferably comprises auxiliary fan motor 116, wherein auxiliary fan motor 116 is preferably a conventional auxiliary fan motor assembly and preferably includes a preferred rotor 117 rotatably secured to a preferred hollow shaft 112, wherein hollow shaft 112 extends through the length of auxiliary fan motor 116 and auxiliary fan module 22. A preferred stator 90 (not shown) of auxiliary fan motor 116 is preferably attached to hollow shaft 112. Each of fan blade brackets 122 is attached to rotor 117, wherein each fan blade bracket 122 preferably supports fan blades 24 (not shown). Fan blade brackets 122 are conventional fan blade brackets known within the art. The hollowness of shaft 112 provides for the routing of electrical conductors 50 therethrough and out of a throughhole 112A formed on shaft 112 for connection with preferred remote control receiver unit 610. Threadably engaged to the portion of hollow shaft 112 that extends past upper portion 116A of auxiliary fan motor 116 is preferred coupler 630, wherein coupler 630 is preferably generally disk-shaped and has a plurality of preferred throughholes 632 formed thereon. Throughholes 632 of coupler 630 align with throughholes 270 of mounting section 670 of shroud 260 so that upon insertion of preferred screws 270A into throughholes 632 and 670, auxiliary fan module 22 is secured and supported to shroud 260 via coupler 630. Coupler aperture 673A of shroud 260 receives the upper portion of coupler 630.

A preferably circular-shaped preferred support plate 604 positioned below auxiliary fan motor 116 is threadably engaged with hollow shaft 112 and secured thereto via preferred nut 645. Support plate 604 preferably has mounted on preferred side 604A a remote control receiver unit 610 and supports the adaptation of optional light module 28 on preferred side 604B. Preferably mounted between remote control receiver unit 610 and support plate 604 is preferred insulative barrier 285, wherein insulative barrier 285 functions to protect remote control receiver unit 610 from heat produced by optional light module 28. Remote control receiver unit 610 preferably controls the operation of heating module 16, auxiliary fan module 22 and optional lamp assembly 28 pursuant to manual or automatic signal outputs from a transmitter control unit 247 and received by remote control receiver unit 610. Remote control receiver unit 610 further preferably controls the number of heating elements 100 (i.e., 222A-222D) that are activated—any one or all of heating elements 222A-222D can be activated in any order desired.

Optional lamp assembly 28 is preferably conventionally attached to side 604B via a preferred base 130 having preferably apertures 132A and 132B for penetrably receiving screws or the like (not shown) that extend through support plate 604. A preferred central aperture 132C further allows routing of electrical conductors 50 to lamps 136 (not shown). One or more optional lamps 136 (not shown) are mounted on base 130. An optional transparent or translucent cover 138 is removably attached to base 130 to shield optional lamps 136 and permit transmission of light therethrough.

For powering of the various electrical components of heating device A-4, electrical conductors 50 are channeled through the entirety of heating device A-4. Electrical conductors 50 are preferably electrically connected to a source of power within the ceiling and channeled first through passage 612E of cover 612. Electrical conductors 50 are then routed through dress ring 613, through boss 20 aperture 181 of upper support plate 600, along the inner surface of upper support plate 600, down along the inner surface of inlet ring 601, along the outer surface of heat shields 800 and 820, through throughholes 621A-621C of lower support plate 620, through coupler aperture 673A of shroud 260, through aperture 264 of shroud 260, through coupler 630 and into hollow shaft 112, through hole 112A in shaft 112 and connected first to remote control receiver unit 610, then back up through throughholes 621A-621C to motor 88 and auxiliary fan motor 116 and then to heating elements 100, and finally to optional lamp assembly 28.

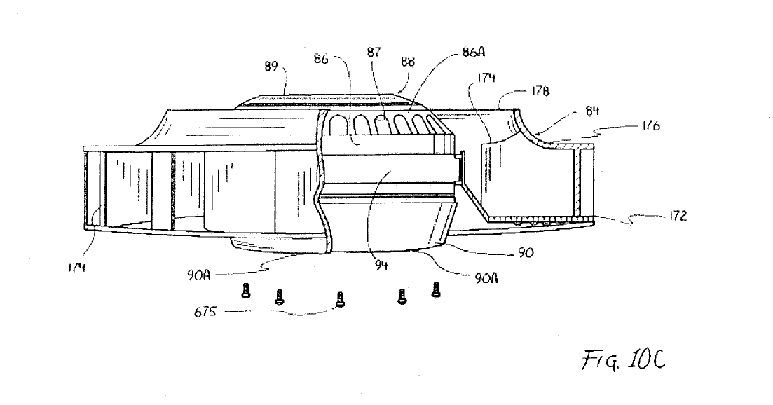

Referring now to FIG. 11, illustrated therein is an amplification and cutaway of lower heat shield 820, upper heat shield 800 and impeller 84 and motor 88 combination. Motor 88 and impeller 84 combination preferably draw air into circular opening 178 and create primary airflow 32 that exits along the outside radius of impeller 84. FIG. 11 depicts the unique preferred tandem or juxtaposed configuration of heating elements 100, wherein heating elements 100 are preferably Positive Thermal Coefficient Ceramic Heating Elements. It is this novel and preferred configuration that allows heating device A-4 to achieve an enhanced flow rate at a higher exit temperature using lower energy settings than in previous configurations. By transferring a more robust heated air stream over fan blades 24, the heated airspace achieves higher temperatures at a faster rate of change. Heat shields 800 and 820 are preferably made of a heat sink plastic that inhibits the conductive transfer of heat, generated by heating elements 100, from impacting the reliability of motor 88 or auxiliary fan motor 116. Further, lower heat shield 820 and upper heat shield 800 combination form an enclosure around impeller 84 to ensure the proper channeling of airflow away from impeller 84, through heating elements 100 and through outlets 20 where airflow is exhausted as primary heated airflow 35. Heating elements 100 are preferably aligned in a preferred tandem arrangement to enhance the efficiency of primary heated airflow 35.

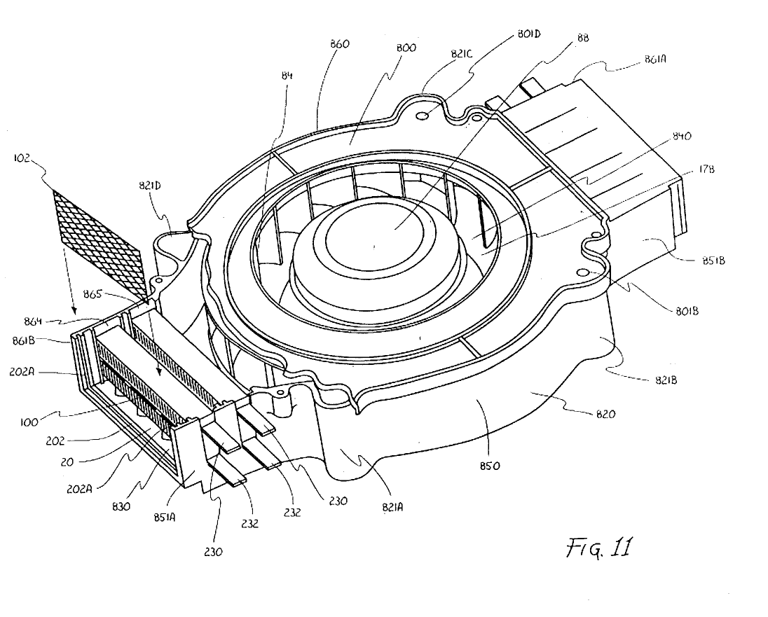

Referring now to FIG. 12, illustrated therein is a schematic diagram of a preferred apparatus for controlling operation of heating device A-4. It should be noted that both remote control receiver unit 610 and preferred transmitter 247 are commercially derived units that rely on digital readouts and computerization for size. New instructions for regulating heating elements 100 should be programmed into remote control receiver unit 610 and transmitter 247 for operation of heating device A-4. Contained within the functions of transmitter 247 and remote control receiver unit 610 are heating device A-4 activation and deactivation switches, switches for activating a desired number of heating elements 100, switches for activating auxiliary fan motor 116 and optional lamp assembly 28, as well as a digital display to indicate the chosen function, switches to increase or decrease desired temperature when in the heating mode, digital monitoring of both desired and actual temperature when in the heating mode, digital monitoring of the number of heating elements 100 activated when in the heating mode and switches to increase or decrease fan speed when in the fan mode.

There are various ways to regulate the amount of heat generated by a heating device. Among them, but not limited to, are analog switches, pull chains, buttons, timers, thermostats, remote control devices, their equivalence or any known means. It should be construed that the preferred manual or automatic remote control devices with their associated remote control receiver unit 610 could be, in alternate embodiments, any or all of the possible ways to regulate, as listed above, and are within the scope of the invention. A remote control receiver unit 610 preferably receives control signals 240 from transmitter 247. It is to be understood that the functions to be described of transmitter 247 may be incorporated into either a single unit or multitude of units. A source of power 248, such as conventional 120/220-volt alternating current available in all dwellings and office buildings, provides power via conductors 50 to remote control receiver unit 610; or, in an alternate embodiment, remote control receiver unit 610 may be battery or solar operated. Transmitter 247 may be battery powered or hard wired to a source of conventional 120/220-volt alternating current. Remote control receiver unit 610, on command, energizes one or more of heating elements 222 (A, B, C and/or D) via preferred conductors 220 (A, B, C and/or D, respectively) under command of transmitter 247. Along with energization of one or more of heating elements 222A-222D, motor 88 and impeller 84 are energized via preferred conductor 88A, to cause a primary airflow 32 to move past heating elements 222A-222D and exhaust from heating module 16 as primary heated airflow 35. To distribute primary heated airflow 35 throughout a room, auxiliary fan motor 116 is energized via preferred conductor 116B to cause attached fan blades 24 to provide an upward secondary airflow 34 for mixing with primary heated airflow 35, resulting in the subsequent distribution of a mixture of airflows 36 throughout the room in which heating is desired. If attached, transmitter 247 through remote control receiver unit 610 can also energize optional lamp assembly 28 via preferred conductor 28A. For safety reasons, a preferred overheat shut-off module 250 may be connected via preferred conductor 250A through remote control receiver unit 610 to cause de-energization of heating elements 222A-222D upon overheating.

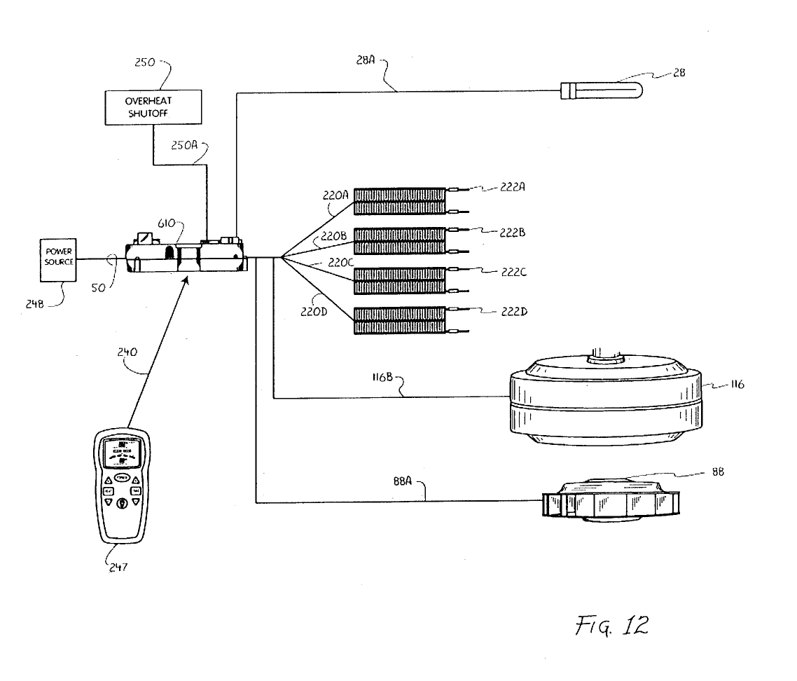

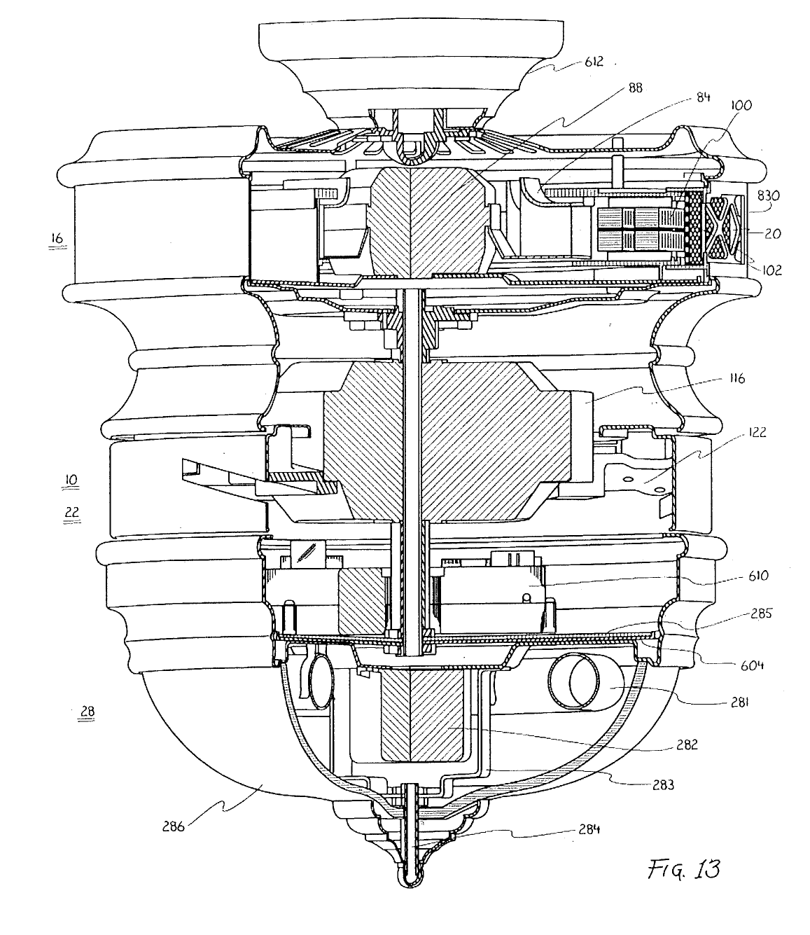

Referring to FIG. 13, heating device A-4 is shown in the assembled version, depicting the modularity and relative locations of heating module 16, auxiliary fan module 22 and optional light module 28. Each module acts in an integrated fashion to first produce a heated air stream from heating module 16 with a flow of air created by impeller 84 rotated by primary motor 88 and heated by heating elements 100 before being exhausted through outlets 20. The resulting primary heated airflow 35 in turn mixes with upward secondary airflow 34 produced by rotation of fan blades 24 of auxiliary fan module 22, wherein the mixing of upward secondary airflow 34 with primary heated airflow 35 results in upward secondary airflow 34 becoming heated and subsequently distributed throughout room 7300. Preferably located downward of auxiliary fan motor 116 is remote control receiver unit 610, wherein remote control receiver unit 610 preferably controls the electrical components of heating device A-4. Shown in this embodiment is a commercially available preferred fluorescent light kit 281 with associated ballast resistor 282. Optional lamp assembly 28 is preferably attached to plate 604, wherein plate 604 supports a preferred bracket 283. Bracket 283 preferably supports a conventional mounting assembly 284 to support decorative globe 286 of optional lamp assembly 28. Preferably mounted upward of plate 604 is a preferred insulative barrier 285 to reduce the transfer of heat from optional light module 28 to remote control receiver unit 610.

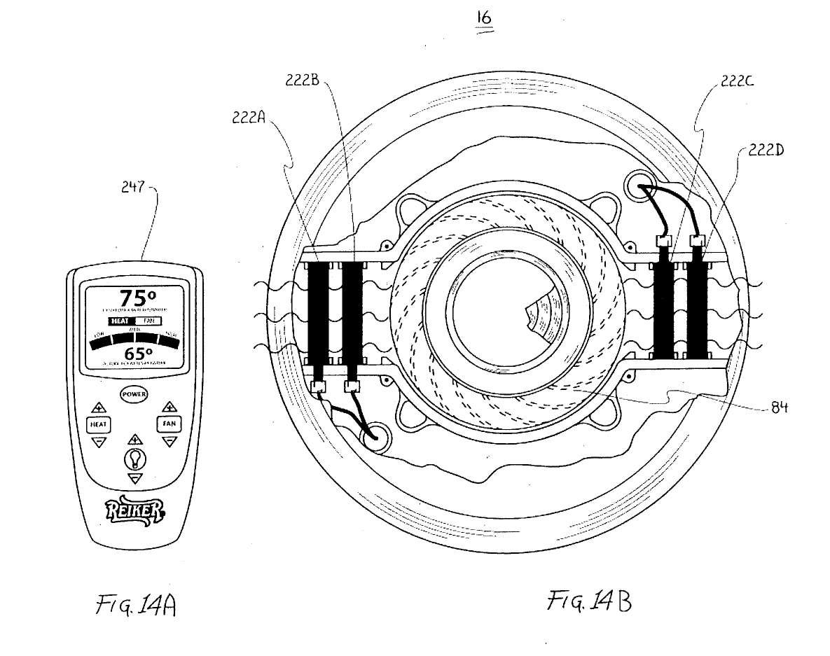

Referring now to FIGS. 14A through 17B, there is illustrated the operation of preferred transmitter 247 and the resulting effect on heating module 16 and its main components, motorized impeller 84 and heating elements 222A, 222B, 222C and 222D, to create primary heated airflow 35. As depicted, preferred transmitter 247 includes options for power-on or power-off of heating device A-4; monitoring and selecting heat or fan settings; monitoring and setting desired temperature; monitoring actual room temperature; adjusting fan speed; adjusting illumination of optional light module 28 and monitoring the number of heating elements 100 currently in use. If room 7300 is to be heated, the power button on preferred transmitter 247 is depressed and the digital display is actuated. The heat button is then depressed highlighting the word “heat” on the digital display and activating the heating module. The desired temperature is then set with the + and − buttons above and below the heat button, wherein depression of the + and − buttons changes the desired temperature digital display. Heating module 16 then automatically activates preferably motorized impeller 84, one or more of heating elements 222A, 222B, 222C and 222D depending on the temperature range between desired and, actual temperature and auxiliary fan module 22 to rotate in the upward direction. If only the fan is required for cooling, the fan button is depressed, causing the word “fan” to become highlighted on the digital display and auxiliary fan module 22 to rotate fan blades 24 in the downward direction. The speed of fan rotation is adjusted with the + or − buttons above and below the fan button. Upon initial startup, in the heat mode, and assuming that the desired temperature is at least three degrees higher than the actual temperature, preferred transmitter 247 will activate all heating elements 222A-222D in order to quickly narrow the gap between actual room temperature and desired room temperature. As the gap narrows heating elements 222A-222D will be automatically deactivated until only the minimum required to maintain the desired temperature are producing heat. It is to be noted that any computer algorithm may be applied to preferred transmitter 247 and preferred remote control receiver unit 610 combination to activate the timing of heating element 100 activation or deactivation. Any or all of those algorithms must be considered within the scope of the present invention.

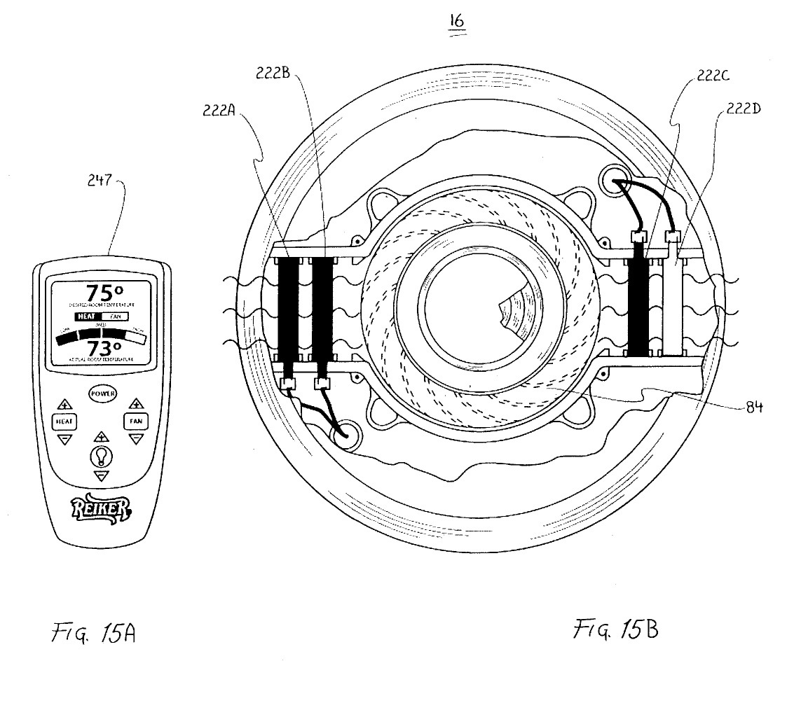

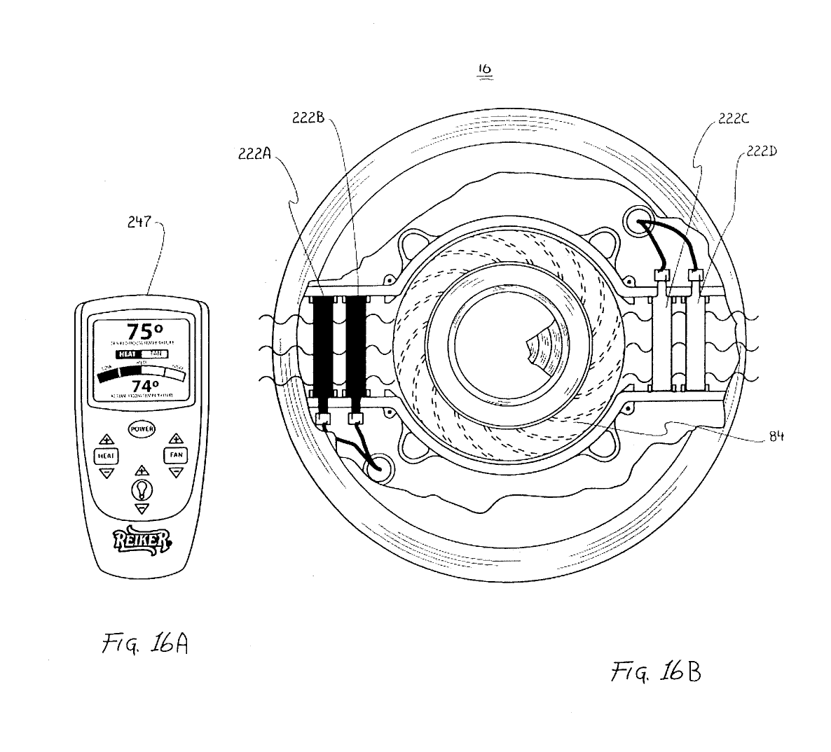

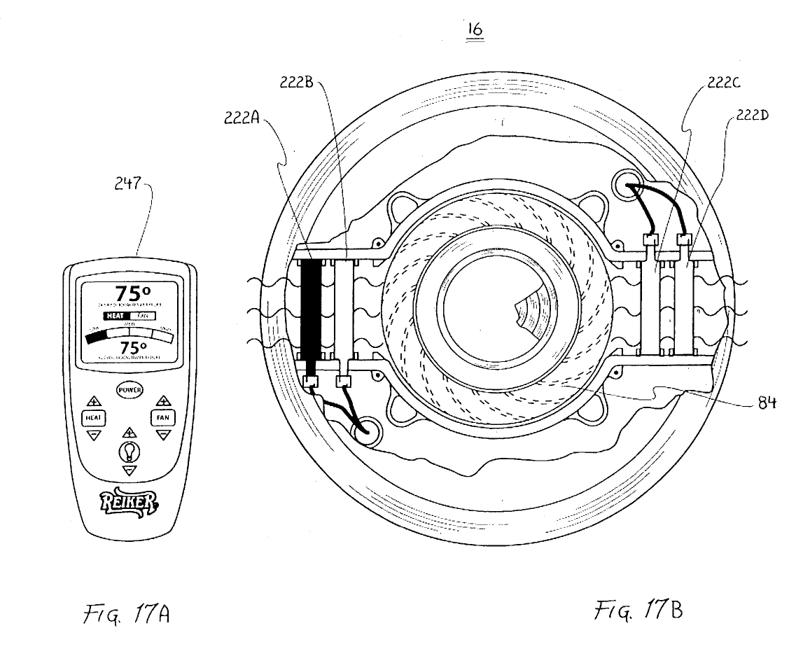

As illustrated in FIGS. 14A and 14B, desired temperature 75 degrees and actual room temperature are separated by 10 degrees causing all heating elements 222A-222D to be activated for increasing the room temperature. As illustrated in FIGS. 15A and 15B, when the desired temperature and actual temperature as indicated on preferred transmitter 247 near, heating elements 222A-222D will start to deactivate in order to maintain the desire room temperature. FIGS. 15A and 15B illustrate the condition where only three heating elements 222A, 222B and 222C are activated. FIGS. 16A and 16B illustrate a condition where only two heating elements 222A and 222B are activated, and FIGS. 17A and 17B illustrate the ultimate condition where only heating element 222A is activated to maintain the desired temperature. Should the actual temperature drop due to a decrease in outside air temperature, an open door or open window, transmitter 247 will command the reactivation of heating elements 222B, 222C or 222D to maintain the desired room temperature. It is this preferred function that enables air recirculating and heating device A-4 to efficiently use electrical energy to heat a room.

In use, fan blades 24 are preferably rotated by auxiliary fan motor 116 of ceiling mounted heating device A-4 to create an upward or downward secondary airflow 34 for mixture with primary heated airflow 35 created by ceiling mounted heating device A-4 or for mixture with cooled airflow 5000a produced by air conditioning unit 1100, wherein the resulting mixed airflow is preferably subsequently distributed throughout room 7300 of home 7100. Additionally, fan blades 24 may be operated independently to produce secondary airflow 34 only for the sole purpose of moving stagnant air and/or breaking up stratification layers within room 7300.

Although ceiling mounted heating device A-4 is the preferred apparatus for producing primary heated airflow 35, it is contemplated in an alternate embodiment that any of heating devices A-1, A-2, A-3, A-11 and/or A-5 could be utilized to create an equally efficient primary heated airflow 35 for subsequent mixture and distribution with secondary airflow 34 throughout room 7300 of home 7100, as best illustrated in FIG. 1.

It is contemplated in an alternate embodiment that heating module 16, auxiliary fan motor 116, optional lamp assembly 28 and air conditioning system 1100 may be controlled in any manner that enables portable transmitters 247 and 2470 to provide the requisite radio frequency transmissions to remote control receiver units 610 and 6100, respectively.

It is contemplated in an alternate embodiment that although portable transmitters 247 and 2470 are the preferred form of controlling heating device A-4 and air conditioning unit 1100, respectively, fixed wireless transmitters and/or fixed hard-wired transmitters could also be utilized to control heating device A-4 and air conditioning unit 1100.

It is contemplated in yet another alternate embodiment that any number of fans, fan motors, evaporator fans/fan motors and/or condenser fans/fan motors could be utilized.

It is contemplated in yet another alternate embodiment that any number of fan blades 24 may be utilized for generating secondary airflow 34. It is further contemplated that other means for generating airflow may be incorporated.

It is contemplated in still another alternate embodiment that one or more heating elements 222 of various wattage and/or variously sized air conditioning components may be utilized to increase the overall efficiency of device 1000 based upon the required standards and/or desires.

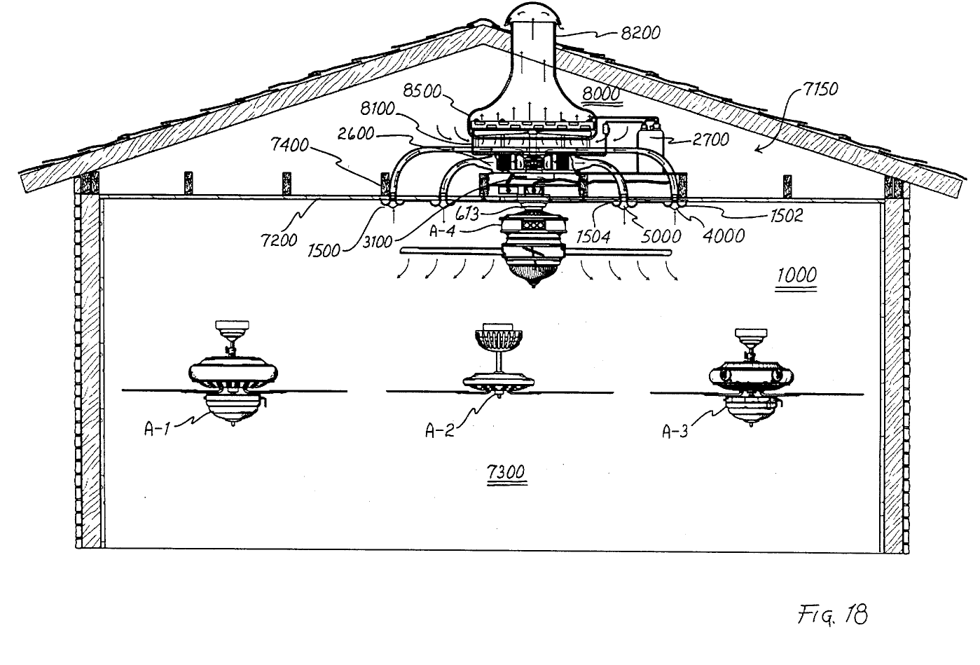

Referring now to FIG. 18, illustrated therein is an alternate embodiment of ceiling mounted heating and cooling device 1000 mounted to ceiling 7200 of room 7300 of a conventionally framed home 7100. Device 1000 generally possesses air conditioning system 8000 in communication with preferred ceiling mounted heating device A-4, wherein air conditioning system 8000 is disposed upwardly from device A-4 and housed within attic 7150 of home 7100. It is contemplated in another alternate embodiment that ceiling mounted heating devices A-1, A-2, A-3, A-11 and/or A-5 could be utilized in place of device A-4 and in conjunction with air conditioning system 8000 of device 1000, as more fully described below.

In general, air conditioning system 8000 possesses condenser 8500 and associated air inlet 8100 and air outlet 8200; evaporator unit 2600 with associated air inlet assembly 4000 and air outlet assembly 5000; and compressor 2700. An integral part of air conditioning system 8000 is water extraction means 3100, wherein water condensation produced by evaporator unit 2600 is moved outside home 7100, as more fully described below. When device 1000 is in the heating mode, device A-4, or alternatively devices A-1, A-2, A-3, A-11 and/or A-5, operates independently of air conditioning system 8000 to create a heated airflow for subsequent distribution throughout room 7300. When device 1000 is in the cooling mode, device A-4, or alternatively devices A-1, A-2, A-3, A-11 and/or A-5, initially functions as a ceiling fan to circulate and blow ambient air onto the occupants of room 7300, and then subsequently to distribute cold air produced by air conditioning system 8000 in either a downward or upward direction, as more fully described below.

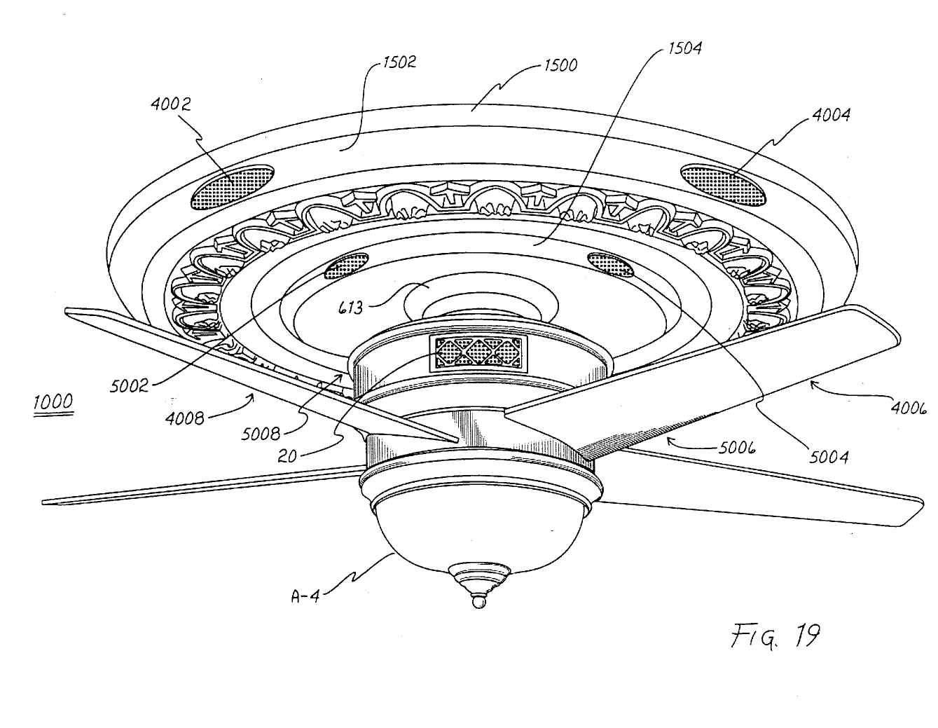

Referring now to FIG. 19, illustrated therein is the external appearance of device 1000 showing heating device A-4 positioned below and attached to circular-shaped decorative medallion 1500, wherein medallion 1500 is attached to ceiling 7200 to shield from view the internal components of device 1000 housed above ceiling 7200 and within attic 7150, as more fully described below. Screened apertures 4002, 4004, 4006 and 4008 are positioned on and equally spaced around outer periphery 1502 of medallion 1500, wherein screened apertures 4002, 4004, 4006 and 4008 are in communication with inlet assembly 4000 of evaporator 2600, as more fully described below. Screened apertures 5002, 5004, 5006 and 5008 are positioned on and equally spaced around inner periphery 1504 of medallion 1500, wherein screened apertures 5002, 5004, 5006 and 5008 are in communication with outlet assembly 5000 of evaporator 2600, as more fully described below. Inlet assembly 4000 and outlet assembly 5000 of evaporator 2600 function to process a cool airflow in the cooling mode of device 1000, while outlet 20 of device A-4 functions to exhaust a heated airflow in the heating mode of device 1000.

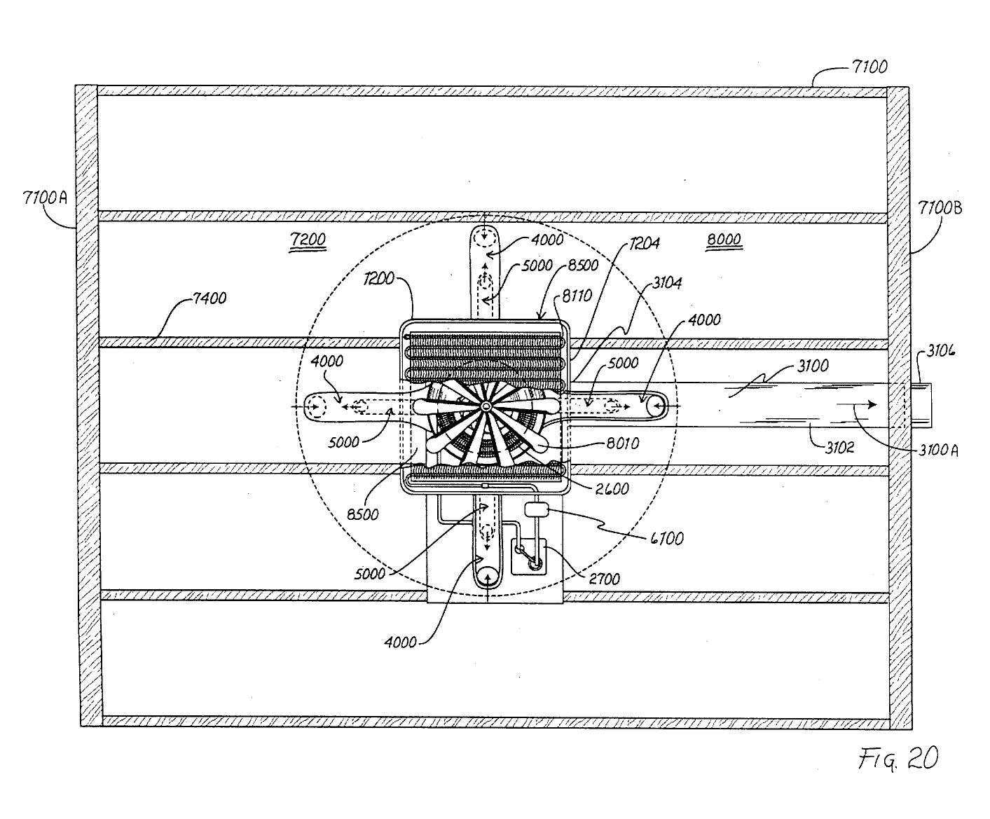

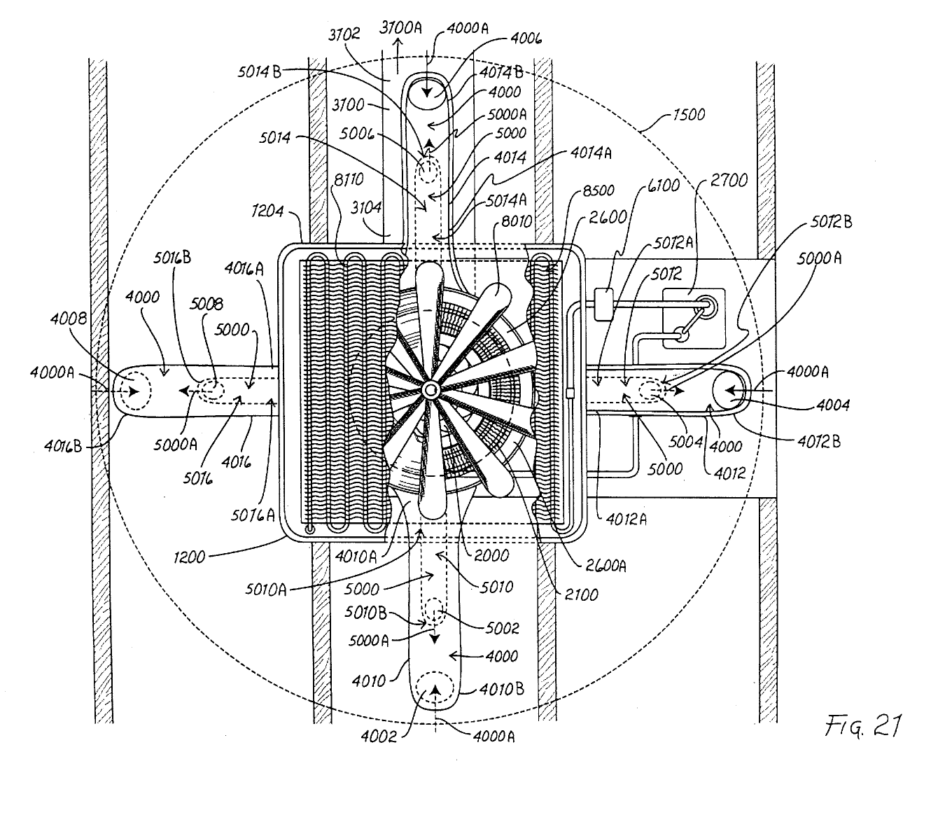

Referring now to FIGS. 20-23A, illustrated therein is air conditioning system/unit 8000 mounted above ceiling 7200, between ceiling joists 7400 and within attic 7150 of home 7100. Air conditioning system 8000 generally possesses condenser 8500, wherein condenser 8500 generally possesses fan 8010, condenser coils 8110, air inlet means 8100 having inlet airflow 8100a, and air outlet means 8200 having exhaust airflow 8200a, as more fully described below. Evaporator 2600 generally possesses fan 2000, evaporator coils 2100, air inlet assembly 4000 having inlet airflow 4000a, air outlet assembly 5000 having exhaust airflow 5000a, and water extraction means 3100 having water expulsion direction 3100a, as more fully described below.

Condenser 8500 is positioned above and in communication with evaporator 2600, wherein compressor 2700 is positioned proximal to and in communication with condenser 8500 and evaporator 2600 as known within the art; however, it is contemplated in another alternate embodiment that condenser 8500, evaporator 2600 and compressor 2700 could be positioned and arranged within in any suitable manner that best accommodates application/installation of device 1000 within ceiling 7200 and attic 7150 of home 7100.

Condenser 8500 is a generally bell-shaped unit having bottom wall 8501, top wall 8502 and outer wall 8503 that collectively function to house fan 8010 and condenser coils 8110 therein, wherein fan 8010 is positioned just above bottom wall 8500a of condenser 8500 and beneath condenser coils 8110, and wherein condenser coils 8110 are conventional condenser coils as known within the art. Specifically, air inlet means 8100 is a plurality of air inlet holes 8016 formed through bottom wall 8501 of condenser 8500, thus enabling fan 8010 to draw air therethrough for the conveyance of air over condenser coils 8110, as more fully described below. Air outlet means 8200 is an aperture 8205 formed proximal to top wall 8502, wherein aperture 8205 is in direct communication with cavity 8500a of condenser 8500 to enable the expulsion of heated air therefrom, and wherein aperture 8205 of top wall 8502 is positioned to the exterior of home 7100 so as to enable the heated air in cavity 8500a to be relived therefrom, as more fully described below.

Compressor 2700 is a conventional air conditioning compressor unit as known within the art, possessing copper tubing 2900 in communication with condenser 8500 and evaporator 2600 to enable the conveyance of refrigerant gas thereto during operation of air conditioning system 8000. Compressor 2700 further possesses expansion valve 2800 for the conversion of chemical refrigerant into a cooled gas as known within the art.

Evaporator 2600 is a circular-shaped unit having fan 2000 centrally positioned within and surrounded by evaporator coils 2100, wherein fan 2000 is in communication with inlet assembly 4000 and outlet assembly 5000, and wherein evaporator coils 2100 are conventional evaporator coils as known within the art. Specifically, air inlet assembly 4000 possesses tubular-shaped tubes 4010, 4012, 4014 and 4016 having ends 4010a, 4012a, 4014a and 4016a, respectively and opposing ends 4010b, 4012b, 4014b and 4016b, respectively, wherein ends 4010a, 4012a, 4014a and 4016a are in direct communication with fan 2000 such that tubes 4010, 4012, 4014 and 4016 are equally-spaced thereabout and extend outwardly therefrom to enable the provision of air thereto, and wherein ends 4010b, 4012b, 4014b and 4016b are positioned to extend to and communicate with screened apertures 4002, 4004, 4006 and 4008, respectively, of medallion 1500 attached to ceiling 7200 of home 7100, so as to enable the drawing of air therefrom by fan 2000, as more fully described below. Similarly, air outlet assembly 5000 possesses tubular-shaped tubes 5010, 5012, 5014 and 5016 having ends 5010a, 5012a, 5014a and 5016a, respectively and opposing ends. 5010b, 5012b, 5014b and 5016b, respectively, wherein ends 5010a, 5012a, 5014a and 5016a are in direct communication with cavity 2600a of evaporator 2600 to enable the expulsion of cooled air therefrom, and wherein ends 5010b, 5012b, 5014b and 5016b are positioned to extend to and communicate with screened apertures 5002, 5004, 5006 and 5008, respectively, of medallion 1500 attached to ceiling 7200 of home 7100, so as to enable the expulsion of cooled air from cavity 2600a of evaporator 2600 into room 7300 of home 7100, as more fully described below. Tubes 4010, 4012, 4014, 4016, 5010, 5012, 5014 and 5016 are generally downwardly arcuate-shaped to best facilitate the channeling of air into and out of room 7300 of home 7100.

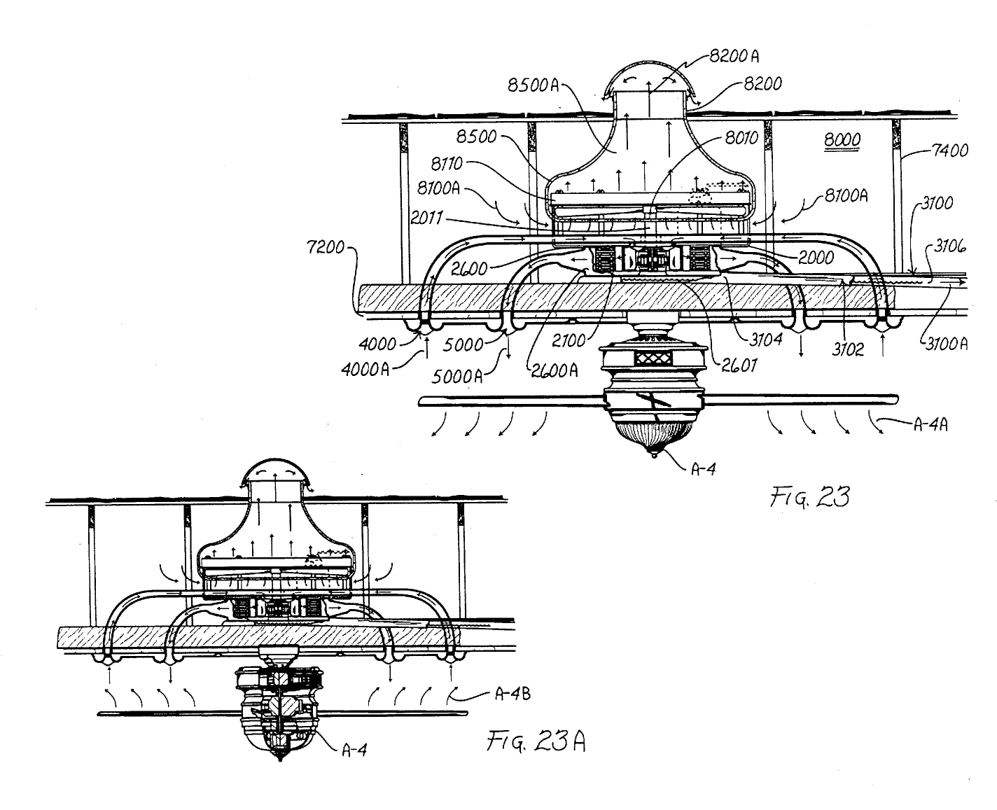

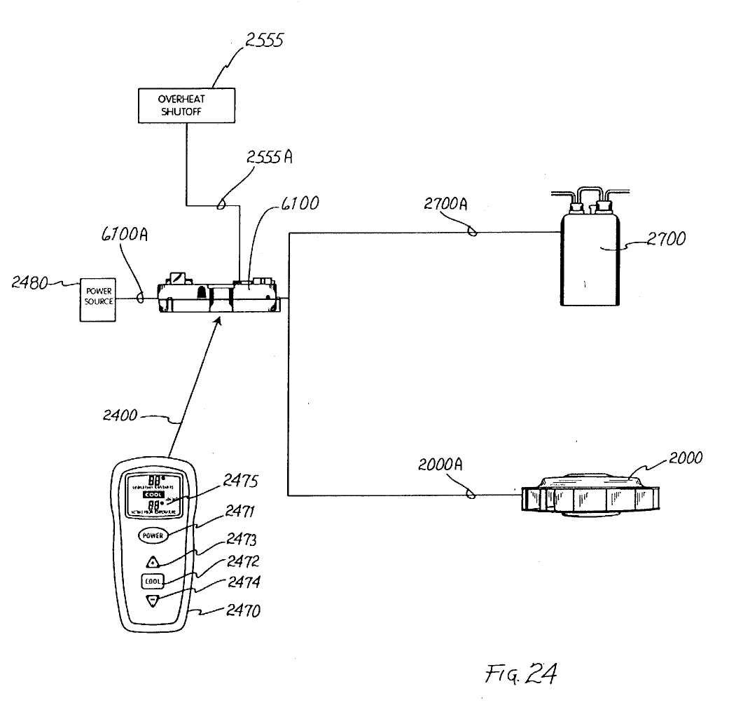

Water extraction means 3100 is a rectangular-shaped tube 3102 having end 3104 and opposing end 3106, wherein end 3104 is in direct communication with cavity 2600a of evaporator 2600 to enable the expulsion of condensed water therefrom, and wherein end 3106 is positioned to the exterior of home 7100 so as to enable-the water from cavity 2500a to be relived therefrom in direction 3100a, as more fully described below. Tube 3102 extends from evaporator 2600, past wall 1204 of container 1200, through joists 7400 of home 7100 and through wall 7100b of home 7100. As best illustrated in FIG. 23, to assist in the gravitational expulsion of water from out of cavity 2600a of evaporator 2600, bottom wall 2601 of cavity 2600a is downwardly angled, as is tube 3102 extending therefrom, to ensure that condensed water is removed therefrom and to prevent the occurrence of standing water within cavity 2600a and/or undesirable leakage of condensed water onto ceiling 7200 of room 7300 of home 7100.

In operation, fan 8010 of condenser 8500 draws inlet airflow 8100a from within attic 7150 of home 7100 through air inlet holes 8016 of air inlet means 8100, wherein inlet airflow 8100a then passes through condenser coils 8110, thus transferring the heat from chemical refrigerant gas into cavity 8500a of condenser 8500 to be subsequently exhausted from home 7100 via aperture 8205 of air outlet means 8200 as exhaust airflow 8200a. Fan 2000 of evaporator 2600 draws inlet airflow 4000a from room 7300 via tubes 4010, 4012, 4014 and 4016 of inlet assembly 4000, wherein inlet airflow 4000a then passes through evaporator coils 2100 to create a cooled airflow 5000a that passes into cavity 2600a of evaporator 2600 prior to exhausting into the room 7300 to be cooled. Compressor 2700 moves chemical refrigerant through copper piping 2900 into condenser coils 8110, wherein the chemical refrigerant is then cooled and turned into a liquid. After becoming a liquid, the chemical refrigerant then travels through expansion valve 2800 where it is turned into a cooled gas, wherein the cooled gas is then conveyed into evaporator coils 2100 for subsequent transfer of cooled temperatures/airflows into room 7300 as described above.

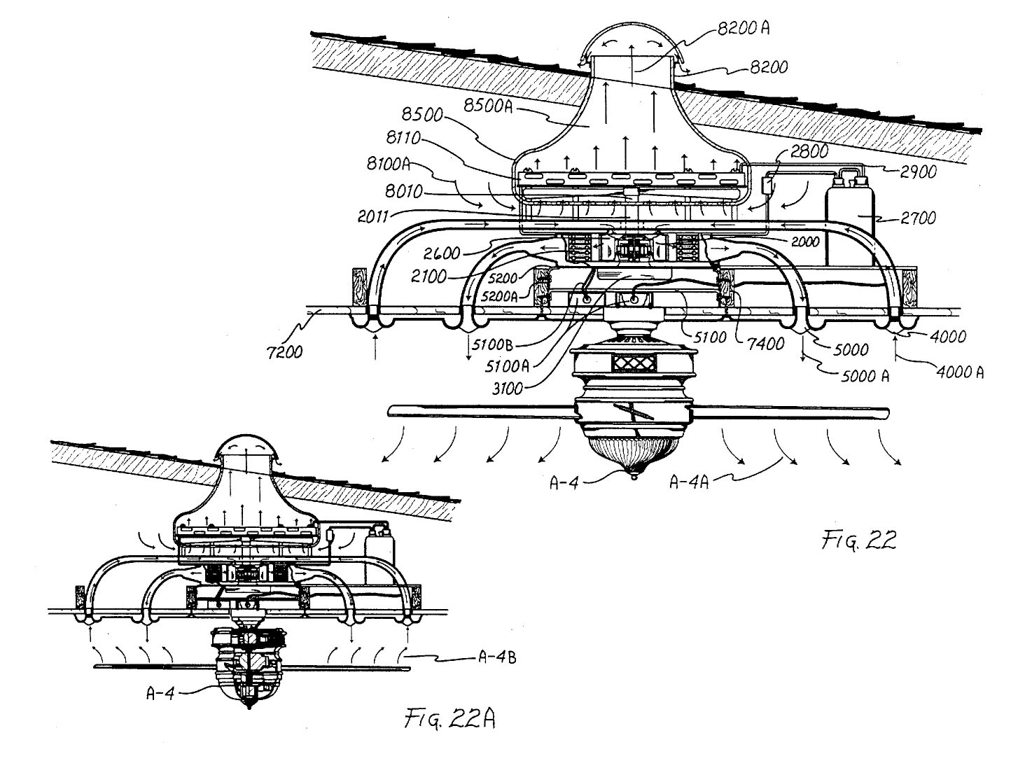

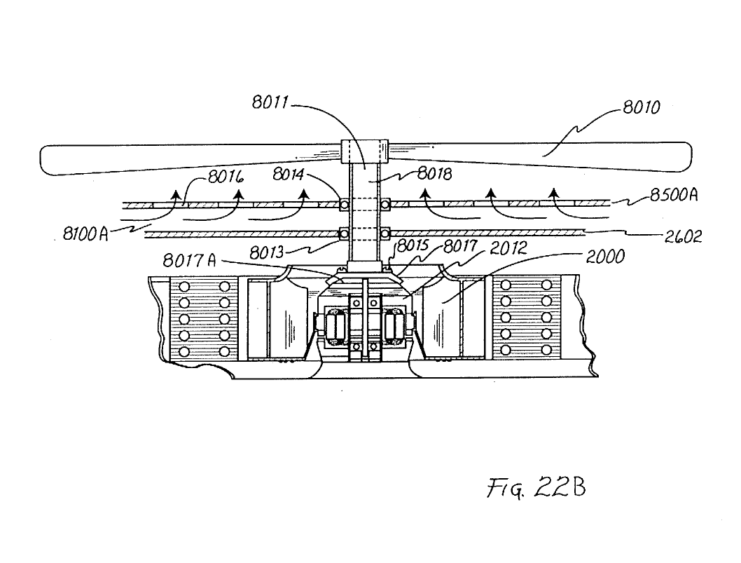

Referring specifically now to FIG. 22, cooled airflow 5000a produced by air conditioning system 8000 and exhausted through outlet assembly 5000 is mixed or integrated with downward airflow A-4a created by heating device A-4, wherein the mixed airflows 5000a and A-4a are then distributed throughout room 7300. As best illustrated in FIG. 22a, it is contemplated in another alternate embodiment that ceiling mounted heating device A-4 could also operate to create an upward airflow A-4b for mixing with and distributing cooled airflow 5000a throughout room 7300. Referring back to FIG. 22, side 2601A of bottom wall 2601 of evaporator 2600 possesses bracket 5200 formed thereto, wherein bracket 5200 enables the positioning and securing of air conditioning unit 8000 to joists 7400 via the assistance of screws 5200a. Standard ceiling fan brace 5100, electrical boxes 5100a and wiring 5100b assist in the conveyance of electrical power to device 1000.

Referring now to FIG. 22B illustrated therein is connection means 8011 utilized to connect fan 8010 of condenser 8500 to motor 2012 of fan 2000 of evaporator 2600, wherein connection means 8011 is a shaft 8018 in communication with motor 2012 to permit in line rotation of fan 8010 with fan 2000. Shaft 8018 passes through bottom wall 8501 of condenser 8500 and then through top wall 2602 of evaporator 2600, wherein bearing 8013 embedded in top wall 2602 and bearing 2014 embedded in bottom wall 8501 support shaft 2018 and permit in line rotation with motor 2012 of fan 2000 of evaporator 2600. Attachment means 8017 conforms to the top of motor 2012 and is secured thereto via screws 8015, wherein attachment means 8017 is a bracket 8017a.

Referring now to FIG. 24, illustrated therein is a schematic diagram of an apparatus for controlling operation of air conditioning device 8000 of device 1000. Remote control receiver unit 6100 and transmitter 2470 are commercially derived units that rely on digital readouts and computerization for size. Contained within the functions of transmitter 2470 and remote control receiver unit 6100 are air conditioning device 8000 activation and deactivation switches, switches for activating condenser fan 8010, evaporator fan 2000 and compressor 2700 via the assistance of wiring 8010a, 2000a and 2700a, respectively. Transmitter 2470 further possesses power button 2471 for activation of air conditioning system 8000; cool mode button 2472 for activation of the cool mode of operation of air conditioning system 8000; and temperature adjustment buttons 2473 and 2474 to set the desired temperature of deactivation of air conditioning, system 8000, or alternatively, for adjusting the temperature of cooled airflow 5000a. Digital display 2475 is activated upon, depressing power button 2471, wherein display 2475 indicates the desired mode of operation and user-selected operating features such as current temperature and/or other programmed features.

Remote control receiver unit 6100 receives control signals 2400 from transmitter 2470, wherein remote control receiver unit 6100 is positioned proximal to condenser 8500 and compressor 2700, as best illustrated in FIG. 21. It is contemplated in another alternate embodiment that remote control receiver unit 6100 could be positioned in any suitable location for the remote controlled operation of air conditioning unit 8000. Source of power 2480, such as, for exemplary purposes only, a conventional 120/220-volt alternating current, provides power to remote control receiver unit 6100 via conductors 6100A; or, in another alternate embodiment, remote control receiver unit 6100 may be battery and/or solar power operated. Transmitter 2470 may also be battery powered or hard wired to a source of conventional 120/220-volt alternating current. On command, remote control receiver unit 6100 energizes compressor 2700, condenser fan 2010 and evaporator fan 2000, wherein energization of compressor 2700 enables chemical refrigerant to begin flowing through evaporator coils 2100 and condenser coils 2110, and wherein energization of evaporator fan 2000 and condenser fan 2010 enables air to flow across evaporator coils 2100 and condenser coils 2110, respectively. For safety precautions, an overheat shut-off module 2555 is connected to remote control receiver unit 6100 via conductor 2555a to enable the de-energization of compressor 2700, condenser fan 8010 and evaporator fan 2000 upon overheating of same.

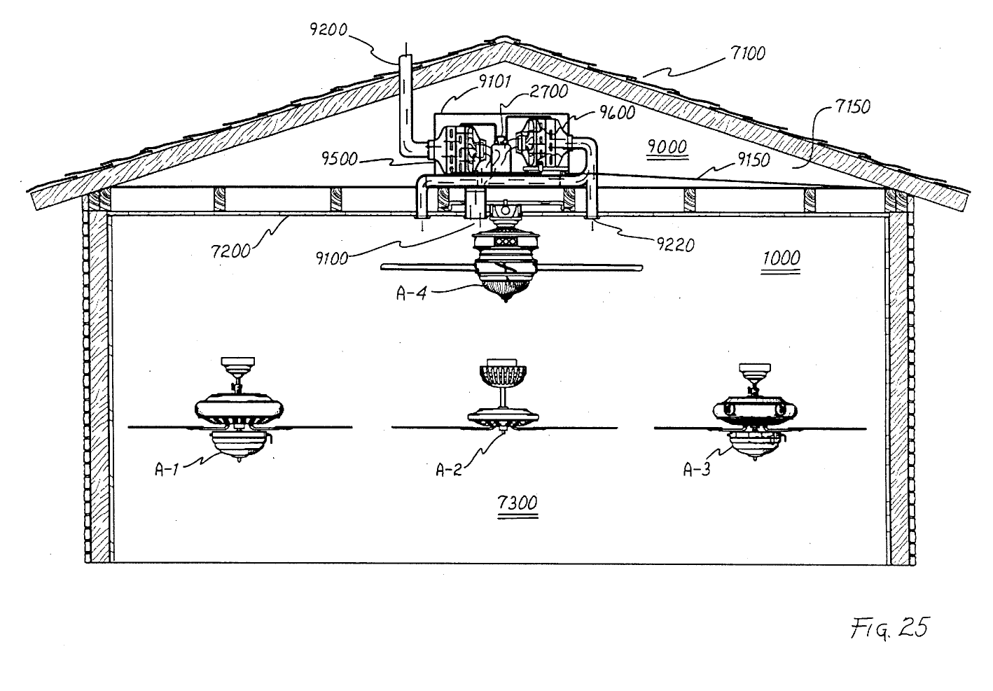

Referring now to FIG. 25, illustrated therein is an alternate embodiment of ceiling mounted heating and cooling device 1000 mounted to ceiling 7200 of room 7300 of a conventionally framed home 7100. Device 1000 generally possesses air conditioning system 9000 in communication with preferred ceiling mounted heating device A-4, wherein air conditioning system 9000 is disposed upwardly from device A-4 and housed within attic 7150 of home 7100. It is contemplated in another alternate embodiment that ceiling mounted heating devices A-1, A-2, A-3, A-11 and/or A-5 could be utilized in place of device A-4 and in conjunction with air conditioning system 9000 of device 1000, as more fully described below.

In general, air conditioning system 90b0 possesses condenser 9500 and associated air inlet 9100 and air outlet 9201; evaporator unit 9600 with associated/shared air inlet 9100 and air outlet 9200; and compressor 2700. An integral part of air conditioning system 9000 is water extraction means 9150, wherein water condensation produced by evaporator unit 9600 is moved outside home 7100, as more fully described below. When device 1000 is in the heating mode, device A-4, or alternatively devices A-1, A-2, A-3, A-11 and/or A-5, operates independently of air conditioning system 9000 to create a heated airflow for subsequent distribution throughout room 7300. When device 1000 is in the cooling mode, device A-4, or alternatively devices A-1, A-2, A-3 and/or A-11, initially functions as a ceiling fan to circulate and blow ambient air onto the occupants of room 7300, and then subsequently to distribute cold air produced by air conditioning system 9000 in either a downward or upward direction, as more fully described below.

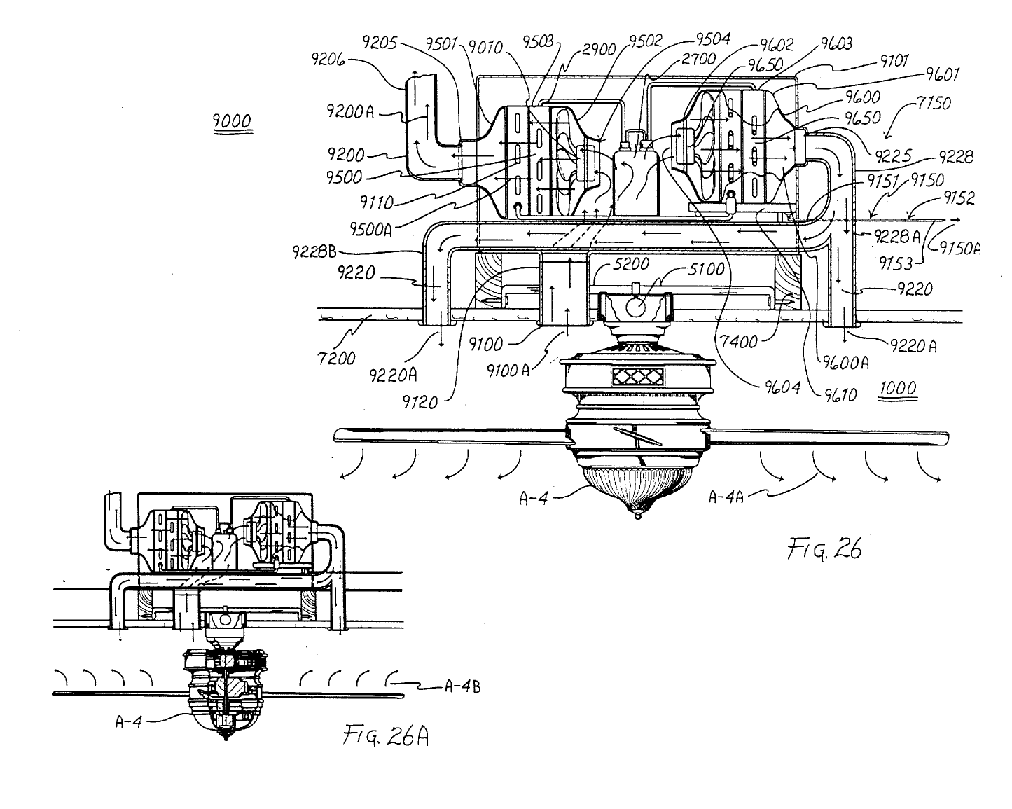

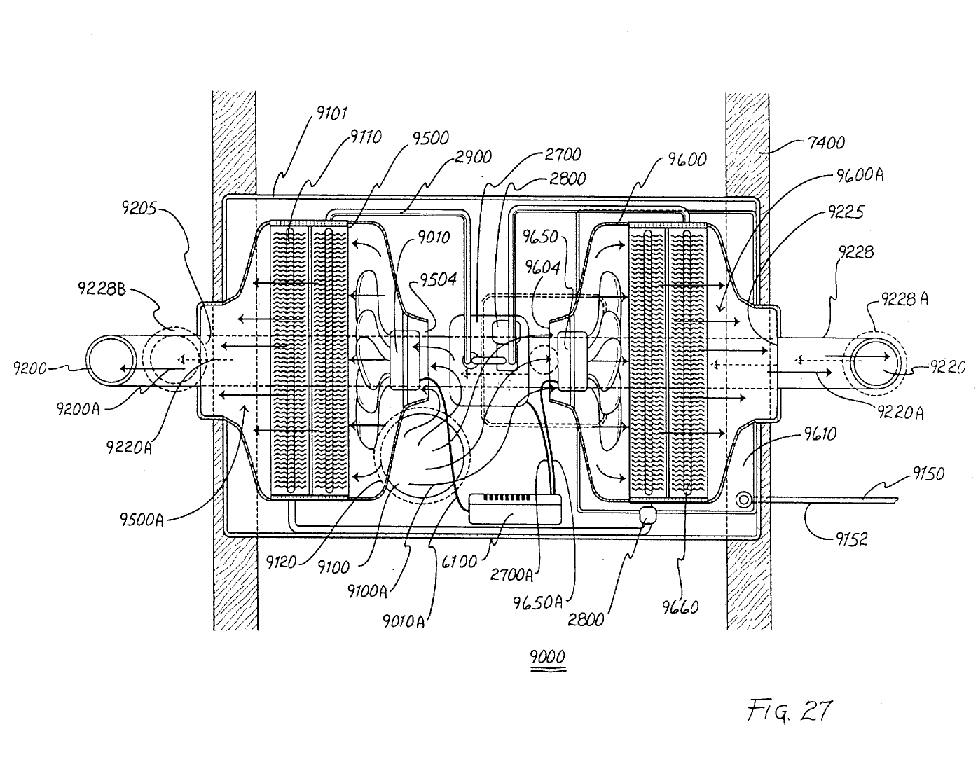

Referring now to FIGS. 26-27, illustrated therein is air conditioning system/unit 9000 mounted above ceiling 7200, between ceiling joists 7400 and within attic 7150 of home 7100. Air conditioning system 9000 generally possesses condenser 9500, wherein condenser 9500 generally possesses fan 9010, condenser coils 9110, air inlet 9100 having inlet airflow 9100a, and air outlet 9200 having exhaust airflow 9200a, as more fully described below. Evaporator 9600 generally possesses fan 9650, evaporator coils 9660, shared air inlet 9100 having shared inlet airflow 9100a, air outlet 9220 having exhaust airflow 9220a, and water extraction means 9150 having water expulsion direction 9150a, as more fully described below.

As best illustrated in FIG. 26, enclosure 9101 houses condenser 9500, evaporator 9600, and compressor 2700, wherein condenser 9500 and evaporator 9600 are opposingly situated and flank compressor 2700, and wherein compressor 2700 is in communication with condenser 9500 and evaporator 9600 as known within the art; however, it is contemplated in another alternate embodiment that condenser 9500, evaporator 9600 and compressor 2700 could be positioned and arranged within in any suitable manner that best accommodates application/installation of device 1000 within ceiling 7200 and attic 7150 of home 7100.

Condenser 9500 is a generally cylindrically-shaped unit having front wall 9501, rear wall 9502 and outer wall 9503 that collectively function to house fan 9010 and condenser coils 9110 therein, wherein fan 9010 is positioned between rear wall 9502 and condenser coils 9110, and wherein condenser coils 9110 are conventional condenser coils as known within the art. Specifically, air inlet means 9100 is a tube 9120, wherein tube 9120 leads from ceiling 7200 of home 7100 into enclosure 9101, thus enabling fan 9010 of condenser 9500 to draw air therethrough from room 7300 and then through aperture 9504 formed through rear wall 9502 of condenser 9500, thereby permitting the conveyance of air over condenser coils 9110, as more fully described below. Air outlet means 9200 is an aperture 9205 formed through front wall 9501 of condenser 9500, wherein aperture 9205 is in direct communication with cavity 9500a of condenser 9500 to enable the expulsion of heated air therefrom, and wherein aperture 9205 of front wall 9501 is in communication with a tube 9206 that leads to the exterior of home 7100 so as to enable the heated air in cavity 9500a to be relived therefrom, as more fully described below.

Compressor 2700 is a conventional air conditioning compressor unit as known within the art, possessing copper tubing 2900 in communication with condenser 9500 and evaporator 9600 to enable the conveyance of refrigerant gas thereto during operation of air conditioning system 9000. Compressor 2700 further possesses expansion valve 2800 for the conversion of chemical refrigerant into a cooled gas as known within the art.

Evaporator 9600 is a generally cylindrically-shaped unit having front wall 9601, rear wall 9602 and outer wall 9603 that collectively function to house fan 9650 and evaporator coils 9660 therein, wherein fan 9650 is positioned between rear wall 9602 and evaporator coils 9660, and wherein evaporator coils 9660 are conventional condenser coils as known within the art. Specifically, evaporator 9600 shares tube 9120, and air inlet means 9100 in general, with condenser 9500, wherein fan 9650 of evaporator 9600 draws air through tube 9120 of air inlet means 9100 from room 7300 and then through aperture 9604 formed through rear wall 9602 of evaporator 9600, thereby permitting the conveyance of air over evaporator coils 9660, as more fully described below. Air outlet means 9220 is an aperture 9225 formed through front wall 9601 of evaporator 9600, wherein aperture 9225 is in direct communication with cavity 9600a of evaporator 9600, and wherein aperture 9225 is in communication with tube 9228 that branches into tubes 9228a and 9228b that extend through ceiling 7200 of home 7100, thus enabling fan 9650 of evaporator 9600 to expel cooled air received from cavity 9600A of evaporator 9600 therethrough and into room 7300 of home 7100, as more fully described below.

Water extraction means 9150 is a pipe 9152 having end 9151 and opposing end 9153, wherein end 9151 is in direct communication with drainage pan 9610 of evaporator 2600 to enable the drainage/expulsion of condensed water therefrom, and wherein end 9153 is positioned to the exterior of home 7100 so as to enable the water from drainage pan 9610 to be relived therefrom in direction 9150a, as more fully described below. As best illustrated in FIG. 26, to assist in the gravitational expulsion of water from out of drainage pan 9610 of evaporator 9600, drainage pan 9610 is downwardly angled, as is pipe 9228 extending therefrom, to ensure that condensed water is removed therefrom and to prevent the occurrence of standing water within cavity drainage pan 9610 and/or undesirable leakage of condensed water onto ceiling 7200 of room 7300 of home 7100.

In operation, fan 9010 of condenser 9500 draws inlet airflow 9100a from within room 7300 of home 7100 through tube 9120 of air inlet 9100, wherein inlet airflow 9100a then passes through condenser coils 9110, thus transferring the heat from chemical refrigerant gas into cavity 9500a of condenser 9500 to be subsequently exhausted from home 7100 via aperture 9205 and tube 9206 of air outlet 9200 as exhaust airflow 9200a. Fan 9650 of evaporator 9600 draws inlet airflow 9100a from room 7300 via tube 9120 of air inlet 9100, wherein inlet airflow 9100a then passes through evaporator coils 9660 to create a cooled airflow 9220a that passes into cavity 9600a of evaporator 9600 prior to exhausting into the room 7300 to be cooled. Compressor 2700 moves chemical refrigerant through copper piping 2900 into condenser coils 9110, wherein the chemical refrigerant is then cooled and turned into a liquid. After becoming a liquid, the chemical refrigerant then travels through expansion valve 2800 where it is turned into a cooled gas, wherein the cooled gas is then conveyed into evaporator coils 9660 for subsequent transfer of cooled temperatures/airflows into room 7300 as described above.

Referring specifically now to FIG. 26, cooled airflow 9220a produced by air conditioning system 9000 and exhausted through outlet assembly 9220 is mixed or integrated with downward airflow A-4a created by heating device A-4, wherein the mixed airflows 9220a and A-4a are then distributed throughout room 7300. As best illustrated in FIG. 26a, it is contemplated in another alternate embodiment that ceiling mounted heating device A-4 could also operate to create an upward airflow A-4b for mixing with and distributing cooled airflow 9220a throughout room 73-00. Referring back to FIG. 26, bracket 5200 enables the positioning and securing of air conditioning unit 9000 to joists 7400 via the assistance of screws 5200a. Standard ceiling fan brace 5100, electrical boxes 5100a and wiring 5100b assist in the conveyance of electrical power to device 1000.

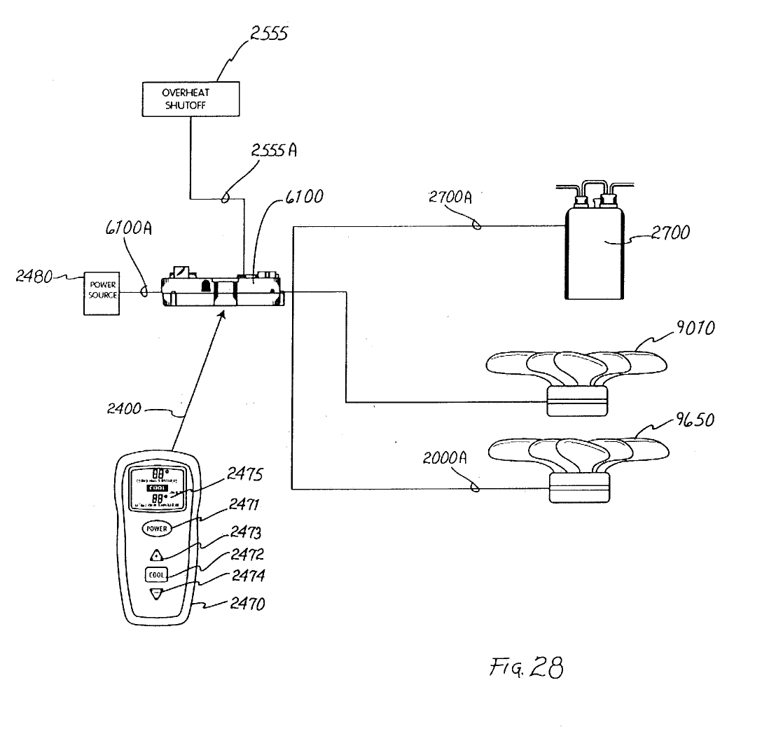

Referring now to FIG. 28, illustrated therein is a schematic diagram of an apparatus for controlling operation of air conditioning device 9000 of device 1000. Remote control receiver unit 6100 and transmitter 2470 are commercially derived units that rely on digital readouts and computerization for size. Contained within the functions of transmitter 2470 and remote control receiver unit 6100 are air conditioning device 9000 activation and deactivation switches, switches for activating condenser fan 9010, evaporator fan 9650 and compressor 2700 via the assistance of wiring 9010a, 9650a and 2700a, respectively. Transmitter 2470 further possesses power button 2471 for activation of air conditioning system 9000; cool mode button 2472 for activation of the cool mode of operation of air conditioning system 9000; and temperature adjustment buttons 2473 and 2474 to set the desired temperature of deactivation of air conditioning system 9000, or alternatively, for adjusting the temperature of cooled airflow 9220a. Digital display 2475 is activated upon depressing power button 2471, wherein display 2475 indicates the desired mode of operation and user-selected operating features such as current temperature and/or other programmed features.

Remote control receiver unit 6100 receives control signals 2400 from transmitter 2470, wherein remote control receiver unit 6100 is positioned proximal to condenser 9500 and evaporator 9600, as best illustrated in FIG. 27. It is contemplated in another alternate embodiment that remote control receiver unit 6100 could be positioned in any suitable location for the remote controlled operation of air conditioning unit 9000. Source of power 2480, such as, for exemplary purposes only, a conventional 120/220-volt alternating current, provides power to remote control receiver unit 6100 via conductors 6100A; or, in another alternate embodiment, remote control receiver unit 6100 may be battery and/or solar power operated. Transmitter 2470 may also be battery powered or hard wired to a source of conventional 120/220-volt alternating current. On command, remote control receiver unit 6100 energizes compressor 2700, condenser fan 9010 and evaporator fan 9650, wherein energization of compressor 2700 enables condenser coils 9110 and evaporator coils 9660, and wherein energization of evaporator fan 9650 and condenser fan 9010 enables air to flow across evaporator coils 9660 and condenser coils 9110, respectively. For safety precautions, an overheat shut-off module 2555 is connected to remote control receiver unit 6100 via conductor 2555a to enable the de-energization of compressor 2700, condenser fan 9010 and evaporator fan 9650 upon overheating of same.

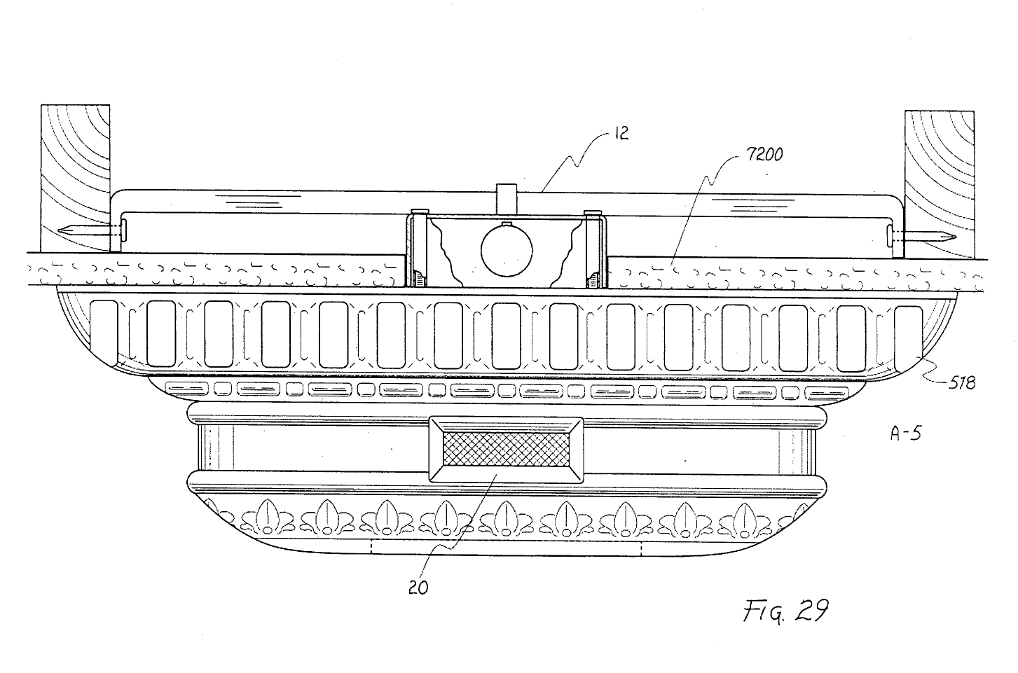

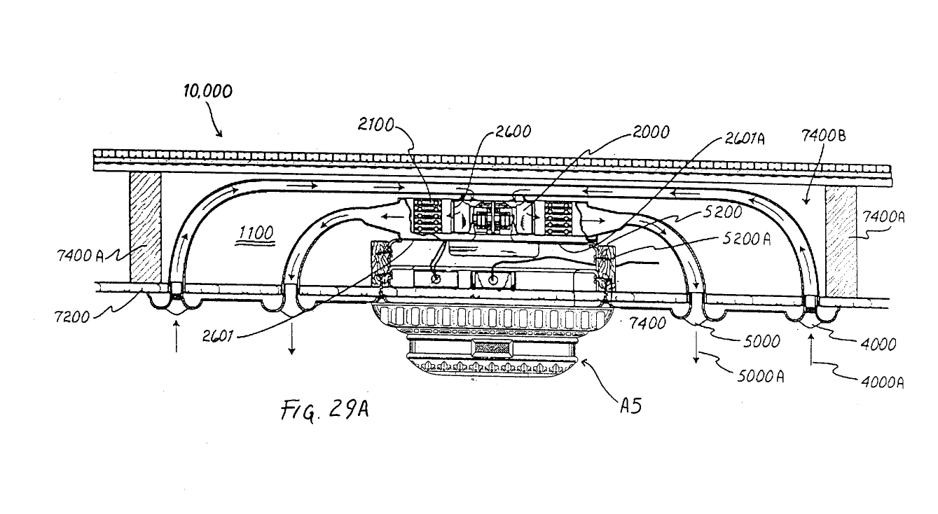

Referring now to FIGS. 29-38B, although the preferred embodiment of the present invention preferably integrates air conditioning system 1100 with heating device A-4, or alternatively, heating devices A-11, A-3, A-2 and/or A-1, having ceiling fan 22 adapted thereto, it is contemplated in an alternate embodiment that air conditioning system 1100, or alternatively, air conditioning systems 8000 and/or 9000, could associate with an independent/detached heating device A-5, wherein heating device does not specifically incorporate a ceiling fan 22, but possesses the ability to incorporate ceiling fan 22 if desired, as more fully described below.

Referring now more specifically to FIG. 29, illustrated therein is heating device A-5 with optional decorative elements or housings. It is to be understood that the exterior configuration illustrated is simply one of a multitude of decorative exterior configurations that may be used. Heating device A-5 is adapted from an upward location within room 7300, such as ceiling 7200 of room 7300, wherein fan brace 12 may be incorporated for adapting heating device A-5 thereto. Heating device A-5 includes inlets 518 for moving air to be heated into heating device A-5 and also further includes outlets 20 disposed thereabout for expelling the primary airflow of heated air as a function of the amount of heating to be performed. As best illustrated in FIG. 29A, heating device A-5 can be incorporated with air conditioning system 1100 to create ceiling mounted heating and cooling device 10,000. It is contemplated in an alternate embodiment that heating device A-5 could be combined with air conditioning systems 8000 and/or 9000 to create additional alternate embodiments of a ceiling mounted heating and cooling device.

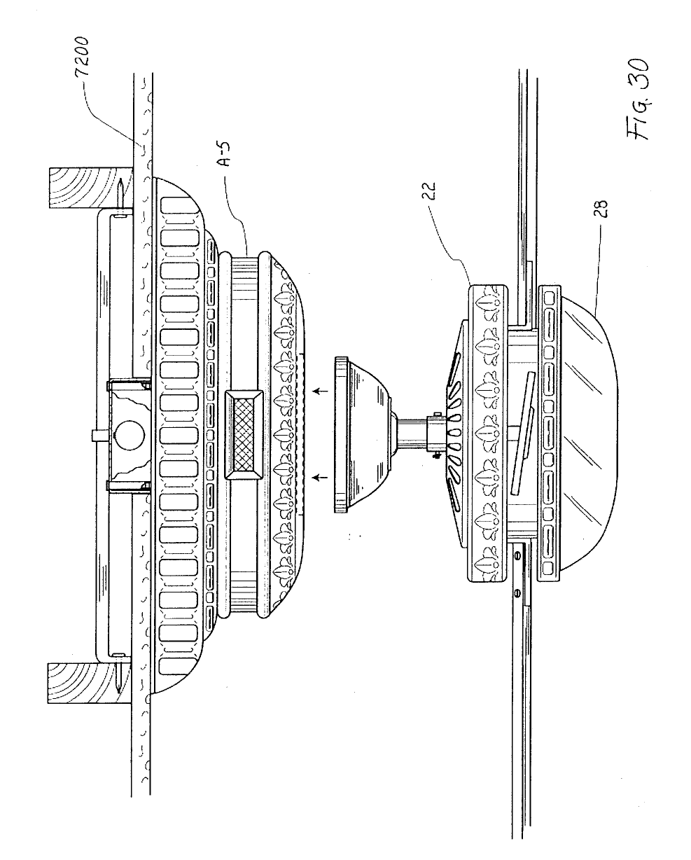

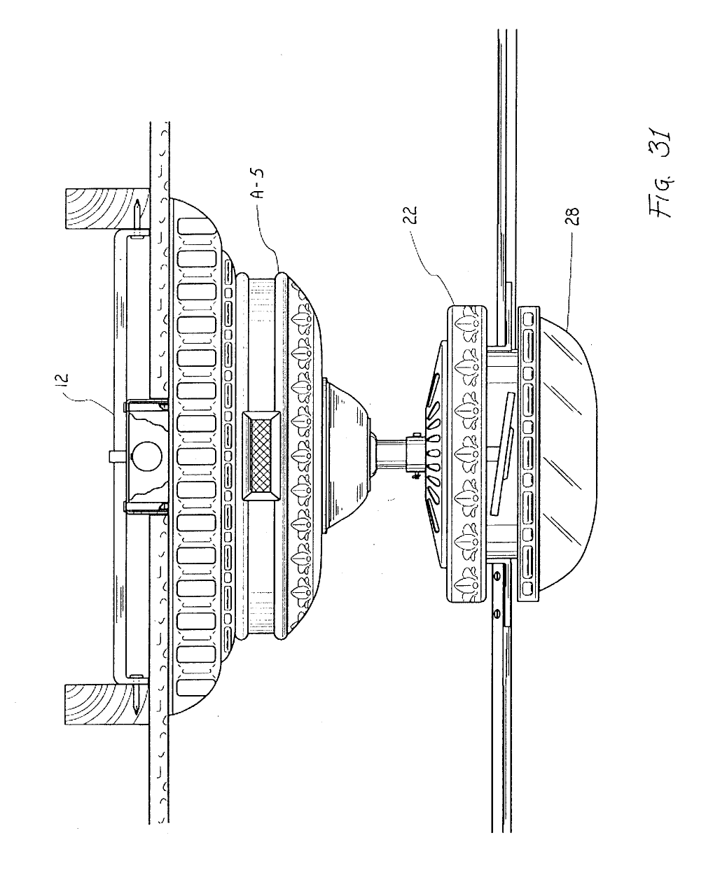

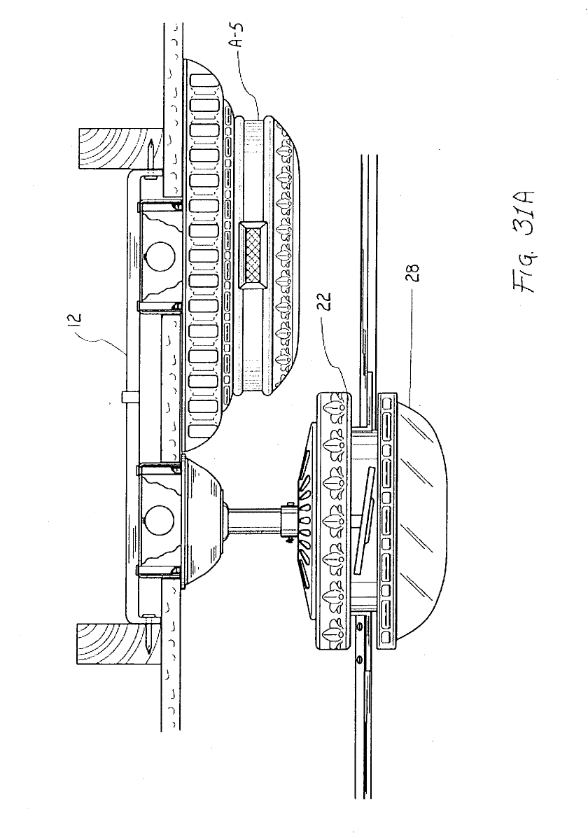

Referring now to FIG. 30, illustrated therein is the load-bearing heating device A-5 adapted to ceiling fan 22 and optional light module 28. Ceiling fan 22 produces a secondary airflow that is directed upward during a heating phase and downward during a cooling phase. FIG. 31 is a side view of heating device A-5 depicting the association of ceiling fan 22 and optional light module 28 in assembled configuration if ceiling fan 22 were to be utilized. FIG. 31A is a side view of heating device A-5 and ceiling fan 22 shown detached from and adjacent to one another. Although not aesthetically pleasing, the cyclonic airflow created by ceiling fan 22, in either an upward or downward airflow, serves to distribute the heated airflow produced by heating device A-5 throughout room 7300.

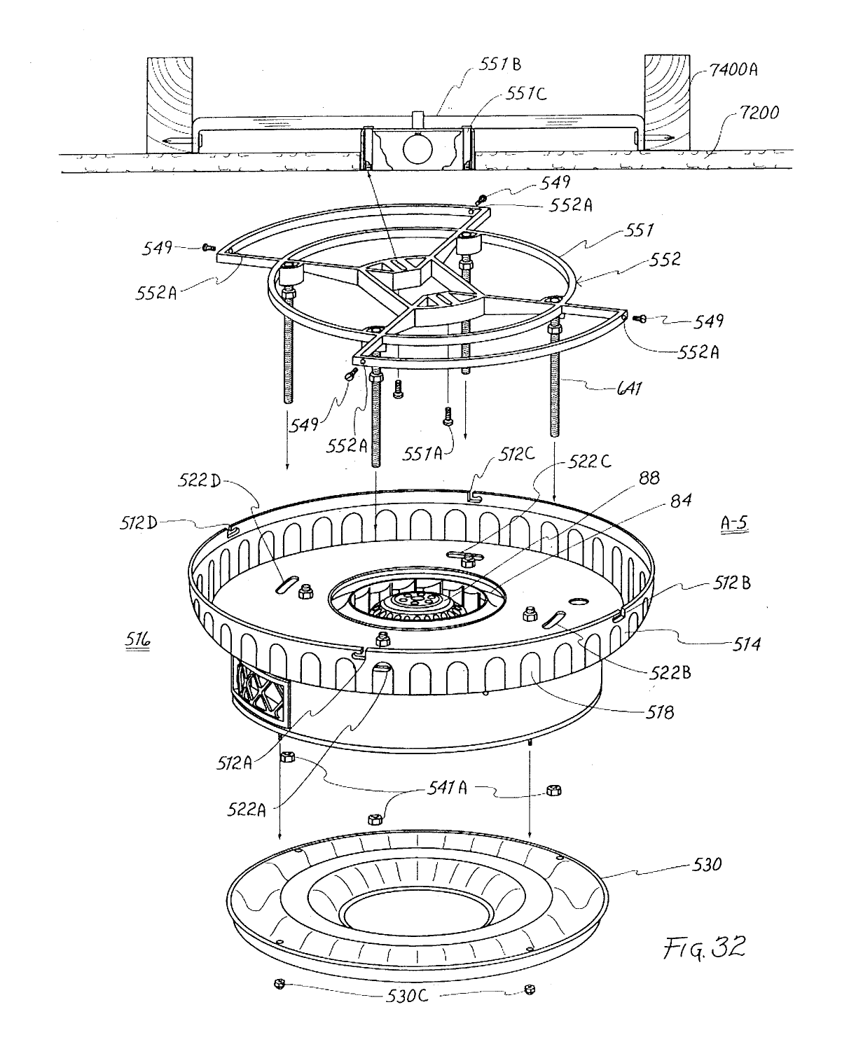

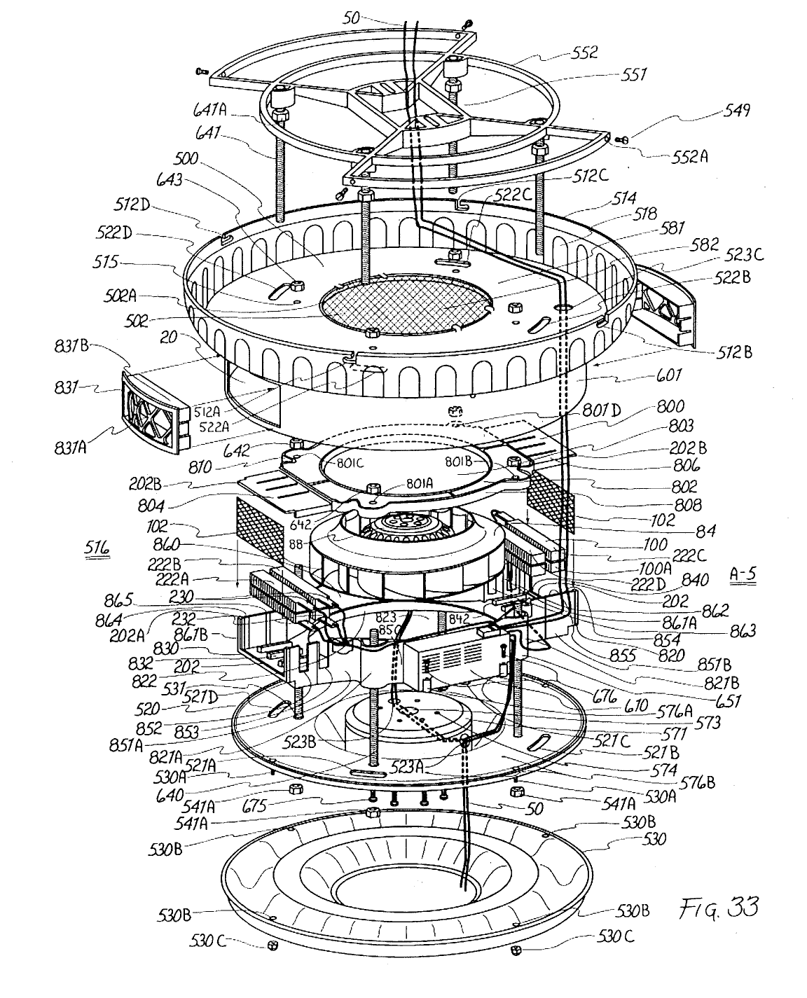

Referring now to FIGS. 32-33, illustrated therein are the components of heating device A-5 in its preassembled, exploded configuration, including support means 551, heating module 516 and decorative cover 530. Also shown is ceiling fan brace 551B and electrical box mounting locations 551C. Support means 551 comprises a bracket 552 attached to a conventional electrical box (not shown) or ceiling fan brace 551B and further attached to joists 7400A above ceiling 7200. A plurality of electrical conductors 50 are electrically connected to a source of power within ceiling 7200 and channeled through support means 551 and through the length of heating device A-5 so as to provide power to the various electrical components of heating device A-5. A circular-shaped inlet support ring 514 is attached to bracket 552 via insertion of screws 549 into slots 512A, 512B, 512C and 512D formed around the upper periphery of inlet support ring 514, and thereafter through throughholes 552A formed on bracket 552.

Heating module 516 of heating device A-5 generally comprises inlet support ring 514, lower support plate 520, upper heat shield 800, lower heat shield 820, motor 88, impeller 84 and heating elements 100. Inlet support ring 514 further has a recessed upper support plate section 581, wherein upper support plate section 581 has an aperture 582 for directing air to impeller 84. Covering aperture 582 is filter 502 for filtering air prior to passing through impeller 84, wherein filter 502 is secured over aperture 582 via tabs 502A. Upper support plate section 581 further has throughhole 523C formed therethrough, wherein throughhole 523C functions to allow the passage of electrical conductors 50 therethrough.

Lower support plate 520 serves as the lower support structure for heating module 516 and as a mounting location for ceiling fan 22. Lower support plate 520 is circular-shaped and has a centrally located mounting section 571, wherein mounting section 571 further has an aperture 573 centrally positioned thereon and dimensioned for receiving the lower mounting location of motor 88 of impeller 84. Radially positioned around aperture 573 is a plurality of throughholes 574 for attaching motor 88 and impeller 84 to mounting section 571 via screws 675. Extending around mounting section 571 are four equally spaced throughholes 531 that are dimensioned to each receive one of four threaded posts 640, wherein threaded posts 640 function to secure all components of heating module 516 together. Lower support plate 520 further comprises four throughholes 521A, 521B, 521C and 521D for accepting threaded posts 641, wherein threaded posts 641 are attached to support means 551 by threaded engagement and locked in place by nuts 541A after first passing through throughholes 522A, 522B, 522C and 522D of upper support plate section 581, thereby securing heating module 516 to support means 551. Mounting section 571 also has throughholes 523A and 523B formed thereon for channeling therethrough electrical conductors 50 to various electrical components of heating device A-5.

Positioned on and adapted to lower support plate 520 is preferred lower heat shield 820, wherein lower heat shield 820 comprises a generally circular-shaped body 822 having two opposing substantially rectangular planks 830 and 840 attached thereto. Body 822 has an aperture 823 centrally formed therethrough to permit contact between mounting section 571 of lower support plate 520 with motor 88 and impeller 84 and for attachment thereto via attaching screws 675. Extending around the periphery of body 822 and planks 830 and 840 are walls 850 and 860, wherein wall 850 further comprises integrally formed channels 821A and 821B and wall 860 further comprises integrally formed channels 821C and 821D. Channels 821A-821D are dimensioned to receive threaded posts 640 when heating module 516, and heating device A-5 in general, is being assembled.

Wall portion 851A of wall 850 proximal to plank 830 comprises slots 852 and 853 formed thereon, and a wall portion 861A of wall 860 proximal to plank 840 comprises slots 862 and 863 formed thereon, wherein slots 852, 853, 862 and 863 are dimensioned to snuggly receive tabs 230 and 232 of each heating element 100. Furthermore, wall portion 851B of wall 850 proximal to plank 840 comprises ridges 854 and 855 (not shown) formed thereon, and wall portion 861B of wall 860 proximal to plank 830 comprises ridges 864 and 865 formed thereon, wherein the slots formed by ridges 854, 855, 864 and 865 are dimensioned to snuggly receive ends 100A of each heating element 100. The distal ends of each plank 830 and 840 have slot 202 formed therein, wherein slot 202 is contiguous with slots 202A formed on the distal ends of walls 850 and 860. Slots 202 and 202A are dimensioned to snuggly receive protective screens 102, wherein protective screens 102 function to prohibit direct access to heating elements 100, yet still permit the egression of primary heated air 35 therethrough.

Two juxtaposed heating elements 222A and 222B are positioned on plank 830 and further rest on supports 832 formed on plank 830. Likewise, two juxtaposed heating elements 222C and 222D are positioned on plank 840 and further rest on supports 842 formed on planks 840. When heating elements 222A and 222B are positioned on plank 830, tabs 230 and 232 of heating element 222A are situated within slot 852 and tabs 230 and 232 of heating element 222B are situated within slot 853. Similarly, when heating elements 222C and 222D are positioned on planks 840, tabs 230 and 232 of heating element 222C are situated within slot 862 and tabs 230 and 232 of heating element 222D are situated within slot 863. Heating elements 222A-222D are generally elongated rectangular in shape and are dimensioned to be received within the confinements created by planks 830 and 840 and walls 850 and 860 of lower heat shield 820. Impeller 84 and accompanying motor 88 are positioned within body 822 of lower heat shield 820. Impeller 84 and accompanying motor 88 are generally circular-shaped and dimensioned to fit within the confinements inherent in the size of lower heat shield 820.

Heating elements 222A-222D, impeller 84 and accompanying motor 88 and protective screens 102 carried by lower heat shield 820 are covered by upper heat shield 800, wherein upper heat shield 800 caps lower heat shield 820. Upper heat shield 800 possesses a generally circular-shaped body 802 having two opposing substantially rectangular-shaped planks 804 and 806 attached thereto. Body 802 has a an aperture 803 centrally formed therethrough to permit impeller 84 to draw air therefrom and into heating module 516. Extending around the periphery of body 802 and planks 804 and 806 are lips 808 and 810. Upper heat shield 800 in general is of the same shape of lower heat shield 820, but is fractionally larger than lower heat shield 820 such that when upper heat shield 800 is brought into contact with lower heat shield 820, lip 808 sits over wall 850 of lower heat shield 820, lip 810 sits over wall 860 of lower heat shield 820, and four throughholes 801A-801D formed on body 802 and around the periphery of aperture 803 are aligned with channels 821A-D, respectively, of lower heat shield 820. Moreover, when upper heat shield 800 is joined with lower heat shield 820 is such a manner, the distal ends of planks 804 and 806 have defined there under slots 202B (not shown), dimensioned to fit over protective screens 102.

Positioned around the joined upper and lower heat shields 800 and 820, respectively, is inlet support ring 514 and circular ring 601, wherein circular ring 601 is a substantially circular flat ring defining preferably two opposing substantially rectangular outlets 20. When circular ring 601 is placed around combined upper and lower heat shields 800 and 820, respectively, outlets 20 are aligned with protective screens 102. Outlets 20 each further carry insert 831 having screened end 831A attached to insert end 831B, wherein insert end 831B is dimensioned to fit within outlet 20 and abut heat shields 800 and 820 upon full insertion of insert 831, thereby ensuring the complete channeling and exhaustion of primary airflow past heating elements 100, through insert end 831B and outlets 20 and past screened end 831A for expulsion into room 7300 or for mixture with secondary upward airflow created by ceiling fan 22 if attached.

Heat shields 800 and 820 with enclosed impeller 84, motor 88, heating elements 100 and protective screens 102, are then secured between inlet support ring 514 and lower support plates 520 via the assistance of threaded posts 640. Threaded posts 640 extend first from lower support plate 520 through throughholes 531. Threaded posts 640 then extend through channels 821A-821D of lower heat shield 820, each channel 821A-821D receiving one threaded post 640. Threaded posts 640 next extend through throughholes 801A-801D of upper heat shield 800, each of throughholes 801A-801b receiving one threaded post, and are secured thereto via preferred nuts 642. Threaded posts 640 are finally extended through throughholes 515 on inlet support plate 500 and secured thereto via nuts 643.

Remote control receiver 610, which controls the electrical components of heating device A-5, is mounted to lower support plate 520 via screws 676 which pass through throughholes 576A into threaded engagement with holes 576B.

Donut-shaped decorative cover 530 attaches to lower support plate 520 through the positioning of threaded studs 530A into throughholes 530B into threaded engagement with decorative nuts 530C.

Referring now to FIG. 33A, illustrated therein is the bottom view of lower support plate 520. Support plate 520 performs the further function as a mounting location for ceiling fan 22 if desired by a user of heating device A-5 or device 1000 in general. Hollow enclosure 524 is recessed for the purpose of housing electrical conductors 50 and lip area 522 forms a mating surface for conventional ceiling fan bracket 526. Ceiling fan bracket 526 is attached to lower support plate 520 via screws 525A passing first through slots 525B and ending in threaded engagement with preferred holes 525.

Referring now to FIG. 34, a schematic diagram of an apparatus for controlling operation of heating device A-5 is illustrated. It should be noted that both remote control receiver unit 610 and preferred transmitter 247 are commercially derived units that rely on digital readouts and computerization for size. New instructions for regulating heating elements 100 should be programmed into remote control receiver unit 610 and transmitter 247 for operation of heating device A-5. Contained within the functions of transmitter 247 and remote control receiver unit 610 are heating device A-5 activation and deactivation switches, switches for activating a desired number of heating elements 100, switches for powering an attached ceiling fan 22, as well as a digital display to indicate the chosen function, switches to increase or decrease desired temperature when in the heating mode, digital monitoring of both desired and actual temperature when in the heating mode, and digital monitoring of the number of heating elements 100 activated when in the heating mode.

There are various ways to regulate the amount of heat generated by a heating device. Among them, but not limited to, are analog switches, pull chains, buttons, timers, thermostats, remote control devices, their equivalence or any known means. It should be construed that the manual or automatic remote control devices with their associated remote control receiver unit 610 could be, in alternate embodiments, any or all of the possible ways to regulate, as listed above, and are within the scope of the invention. A remote control receiver unit 610 receives control signals 240 from transmitter 247. It is to be understood that the functions to be described of transmitter 247 may be incorporated into either a single unit or multitude of units. A source of power 248, such as conventional 120/220-volt alternating current available in all dwellings and office buildings, provides power via conductors 50 to remote control receiver unit 610; or, in an alternate embodiment, remote control receiver unit 610 may be battery or solar operated. Transmitter 247 may be battery powered or hard wired to a source of conventional 120/220-volt alternating current. Remote control receiver unit 610, on command, energizes one or more of heating elements 222 (A, B, C and/or D) via conductors 220 (A, B, C and/or D, respectively) under command of transmitter 247. Along with energization of one or more of heating elements 222A-222D, motor 88 and impeller 84 are energized via conductor 88A to cause a primary airflow 32 to move past heating elements 222A-222D and exhaust from heating module 516 as primary heated airflow 35. To assistance in the distribution of primary heated airflow 35 throughout a room, an attached ceiling fan 22 is energized via conductor 116B to provide a secondary airflow 34 for mixing with primary heated airflow 35, resulting in the subsequent distribution of a mixture of airflows throughout the room in which heating is desired. For safety reasons, overheat shut-off module 250 may be connected via conductor 250A through remote control receiver unit 610 and cause de-energization of heating elements 222A-222D upon the occurrence of an overheat condition.

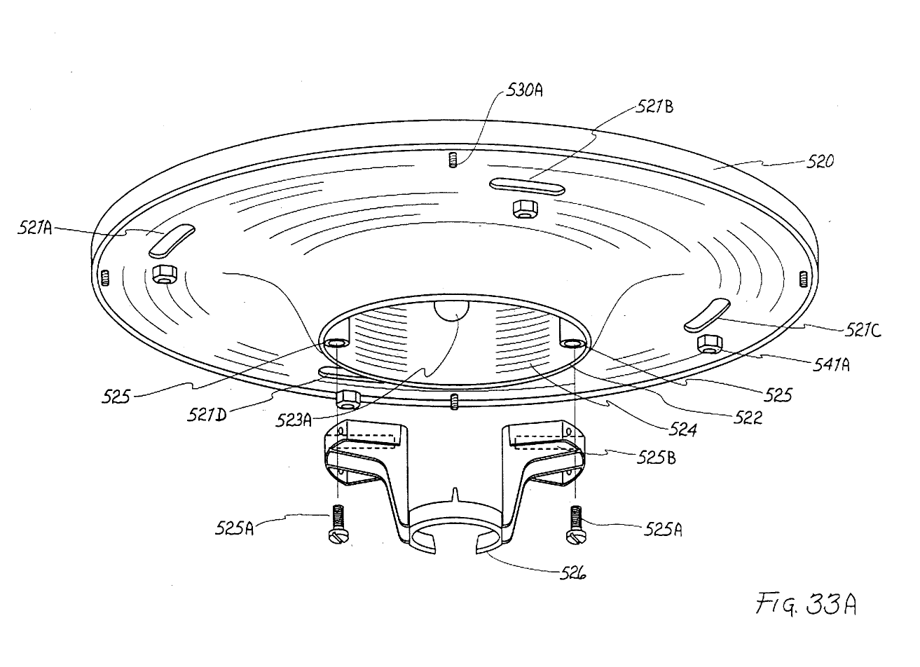

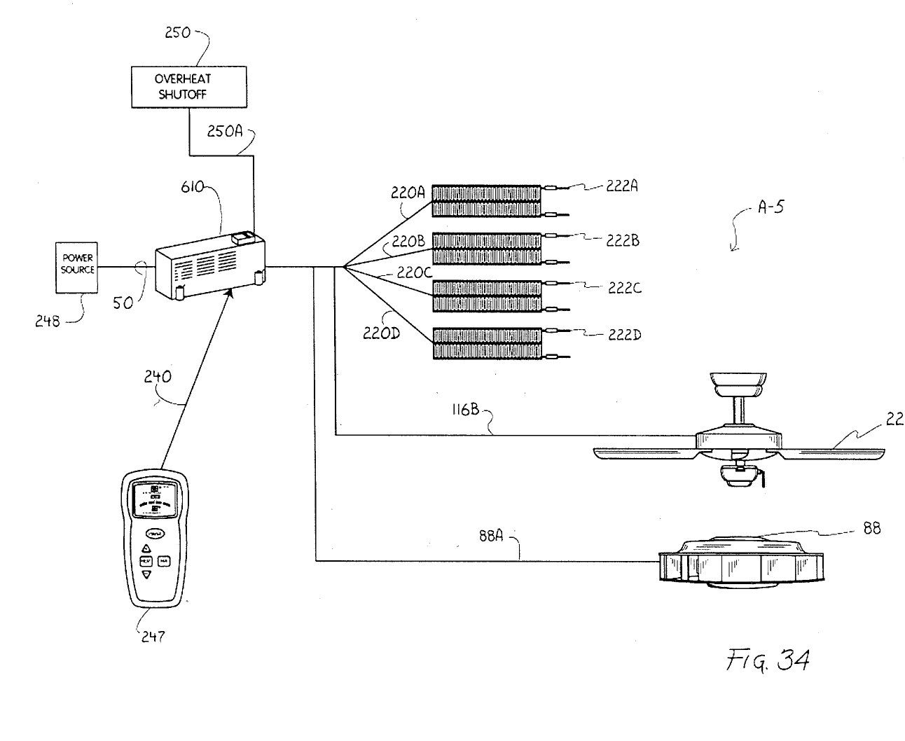

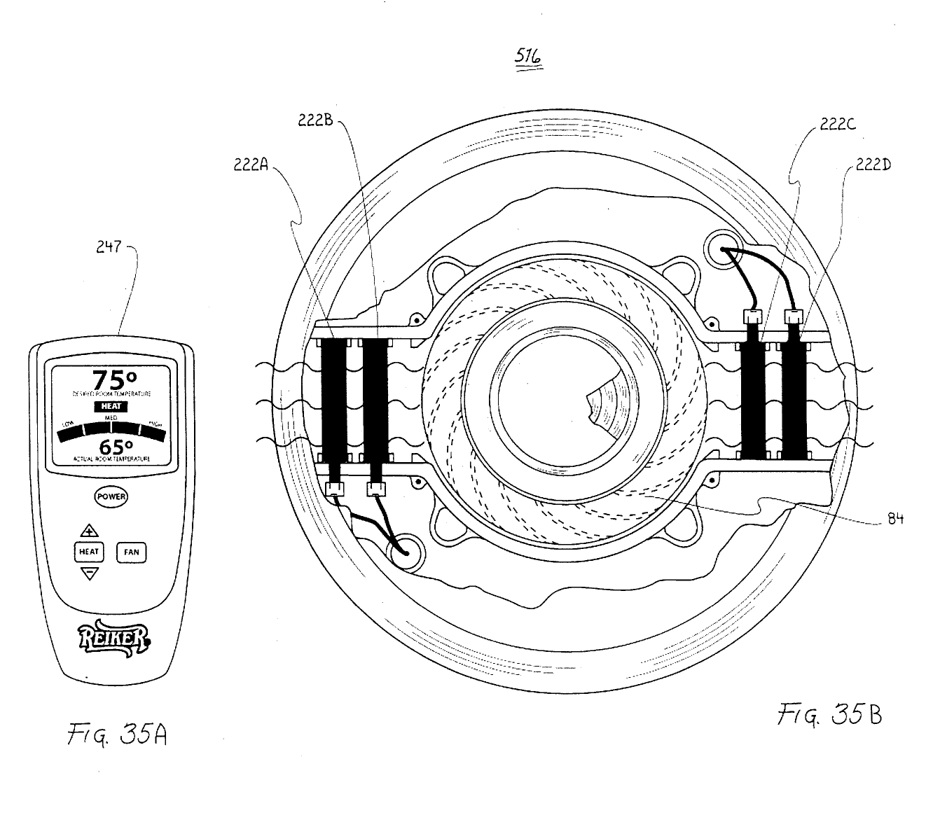

Referring now to FIGS. 35A through 38B, illustrated therein is the operation of transmitter 247 and the resulting effect on heating module 516 and its main components, impeller 84 and heating elements 222A, 222B, 222C and 222D, to create a primary heated airflow. As depicted, transmitter 247 includes options for power-on or power-off of heating device A-5; monitoring and selecting heat and fan settings; monitoring and setting desired temperature; monitoring actual room temperature; and monitoring the number of heating elements 100 currently in use. Also depicted is the tandem configuration of heating elements 100. In this configuration, the temperature of the exhausted airflow is enhanced by first passing through one heating element 100 and subsequently through another heating element 100 to raise the temperature of the exiting airflow. If the heating device A-5 is to be used, the power button on preferred transmitter 247 is depressed and the digital display is actuated. For heating, the “HEAT” button is depressed, highlighting the word “HEAT” on the digital display and activating heating module 516. The desired temperature is then set with the “+” and “−” buttons above and below the heat button, wherein depression of the “+” and “−” buttons changes the desired temperature digital display. Heating module 516 then automatically activates impeller 84, one or more of heating elements 222A, 222B, 222C and 222D depending on the temperature range between desired and actual temperature. If attached, ceiling fan 22 is also powered and should preferably be set, through its endemic control capability, to rotate in the preferably upward direction. If only the fan is required for cooling, the “FAN” button is depressed, causing the word “FAN” to become highlighted on the digital display, thus only ceiling fan 22 is activated and controlled via the endemic control capability of ceiling fan 22. Upon initial startup, in the heat mode, and assuming that the desired temperature is at least three degrees higher than the actual temperature, transmitter 247 will activate all heating elements 222A-222D in order to quickly narrow the gap between actual room temperature and desired room temperature. As the gap narrows heating elements 222A-222D will be automatically deactivated until only the minimum required to maintain the desired temperature are producing heat. It is to be noted that any computer algorithm may be applied to transmitter 247 and remote control receiver unit 610 combinations to activate the timing of heating element 100 activation or deactivation. Any or all of those algorithms must be considered within the scope of the present invention.

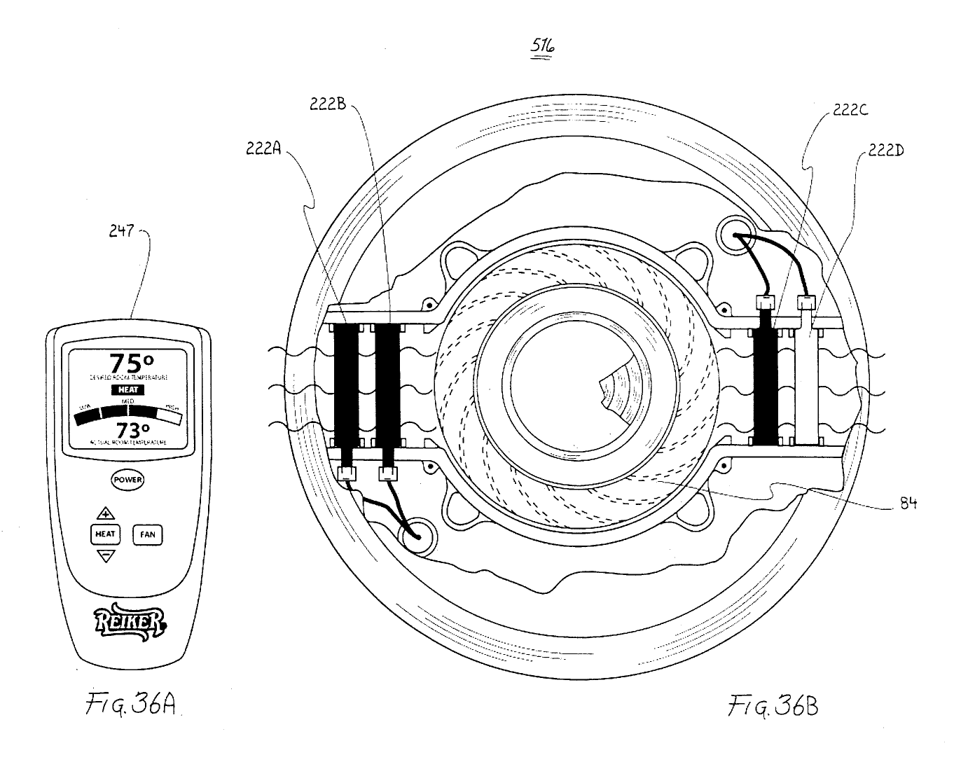

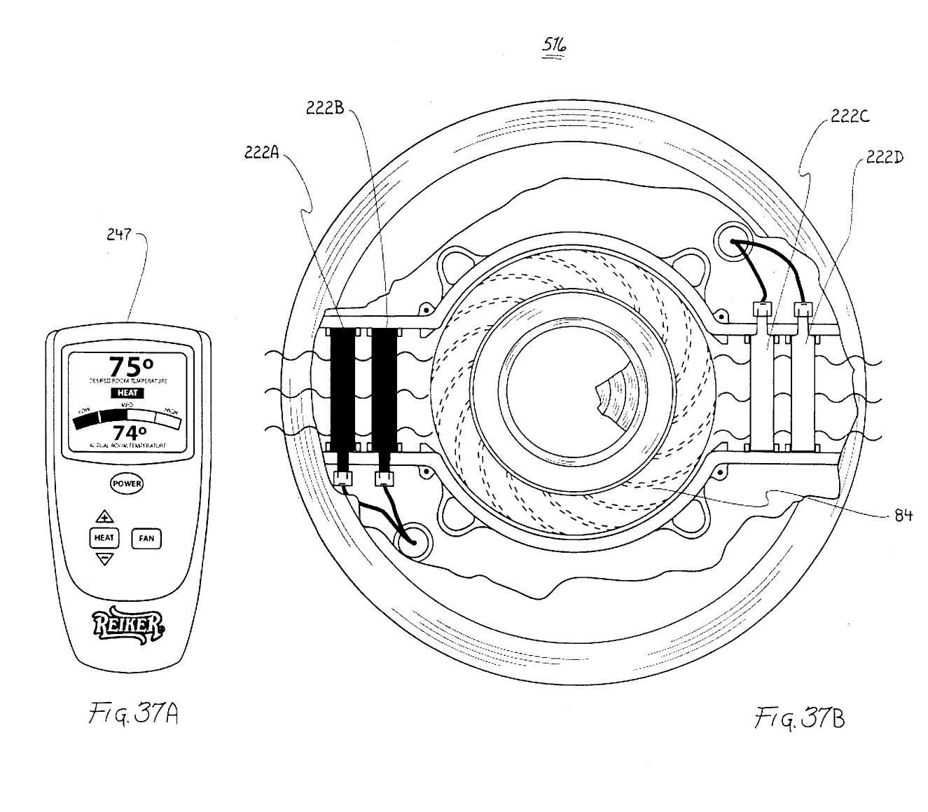

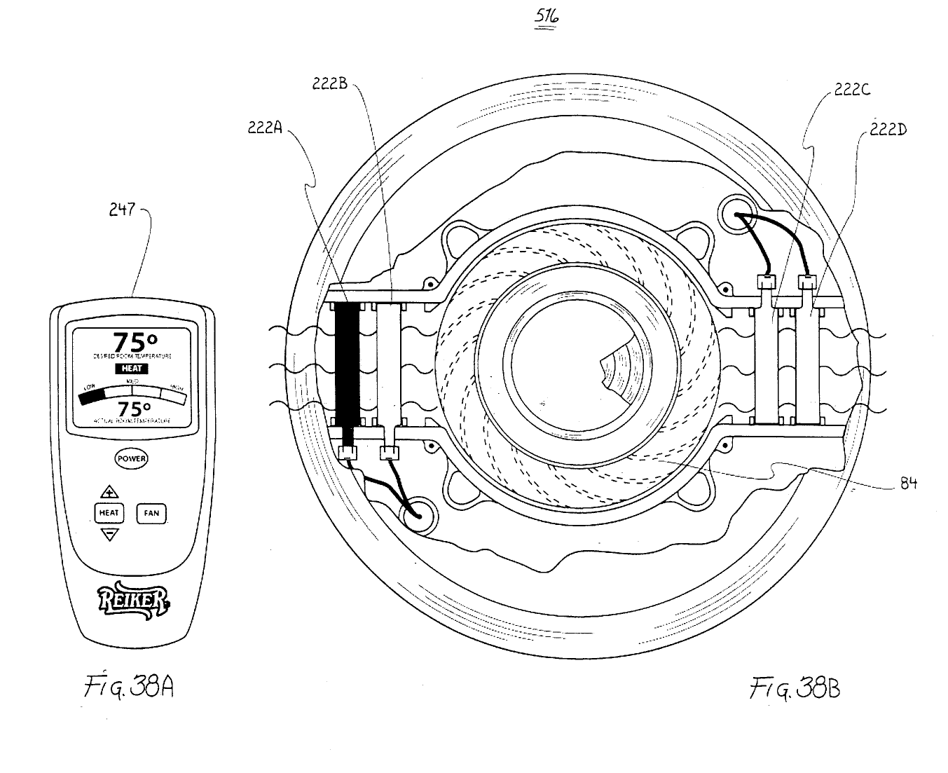

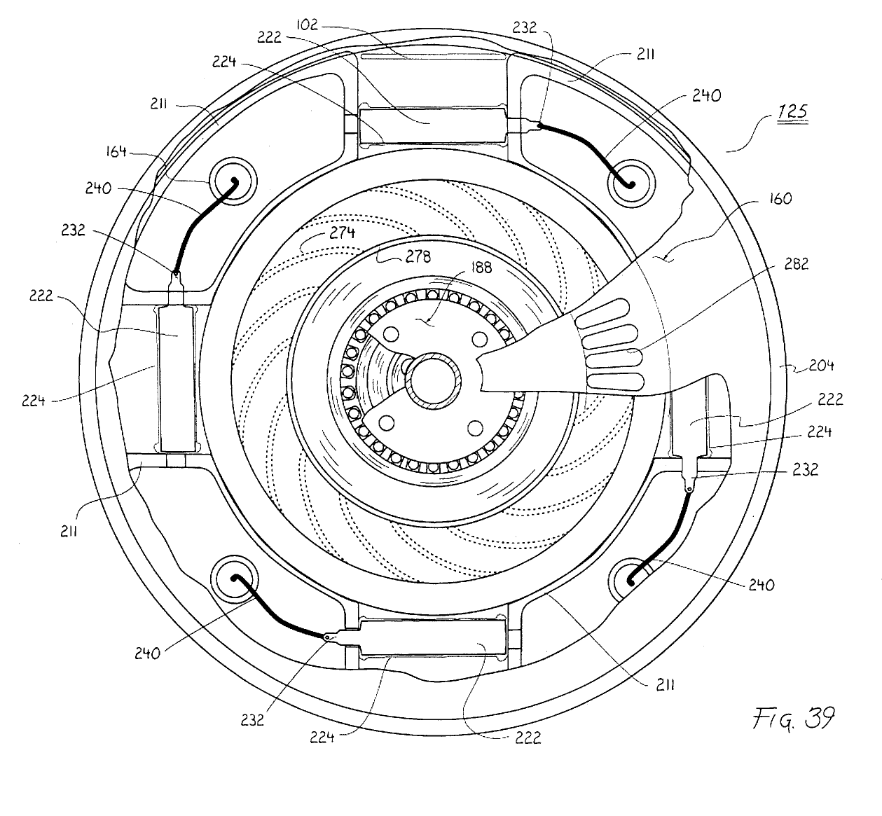

As illustrated in FIGS. 35A and 35B, desired temperature 75 degrees and actual room temperature are separated by 10 degrees causing all heating elements 222A-222D to be activated for increasing the room temperature. As illustrated in FIGS. 36A and 36B, when the desired temperature and actual temperature as indicated on transmitter 247 near, heating elements 222A-222D will start to deactivate in order to maintain the desired room temperature. FIGS. 36A and 36B illustrate the condition where only three heating elements 222A, 222B and 222C are activated. FIGS. 37A and 37B illustrate a condition where only two heating elements 222A and 222B are activated, and FIGS. 38A and 38B illustrate the ultimate condition where only heating element 222A is activated to maintain the desired temperature. Should the actual temperature drop due to a decrease in outside air temperature, an open door or open window, transmitter 247 will command the reactivation of heating elements 222B, 222C or 222D to maintain the desired room temperature. It is this function that enables heating device A-5 to efficiently use electrical energy to heat a room.

Although heating elements 100/222 are tandemly arranged within heating device A-5, it is contemplated in an alternate embodiment that heating elements 100/222 could be arranged in a different manner within heating device A5, and/or any of heating devices A-4, A-11, A-3, A-2 and/or A-1, as best illustrated in FIG. 39. Specifically, FIG. 39 is a top partial cut-away view of heating module 125, showing the equally spaced individual heating elements 222 disposed therein. Support plate 160 is partially shown along with slots 282 formed therein and the top of pin 164. The perimeter of upper support plate 160 is nestled within lip 204 of heat shield 180. As illustrated, electrical conductors 240 are electrically secured to tabs 230 and 232 (of which only tab 232 is shown) and routed through a central passageway extending through pin 164 as an alternative. Electrical conductors 240 are routed to heating elements 222 via channels disposed in support plate 160. An apertured screen 102 is mounted within its slots 202 to prevent physical contact with heating element 222 upstream therefrom. It may also be noted that wall sections 211 on opposed sides of the ends of each heating elements 222 in combination with the connecting surfaces of each heat shield 180 and 182 define the passageway for exhausting the heated primary airflow induced by impeller 184.

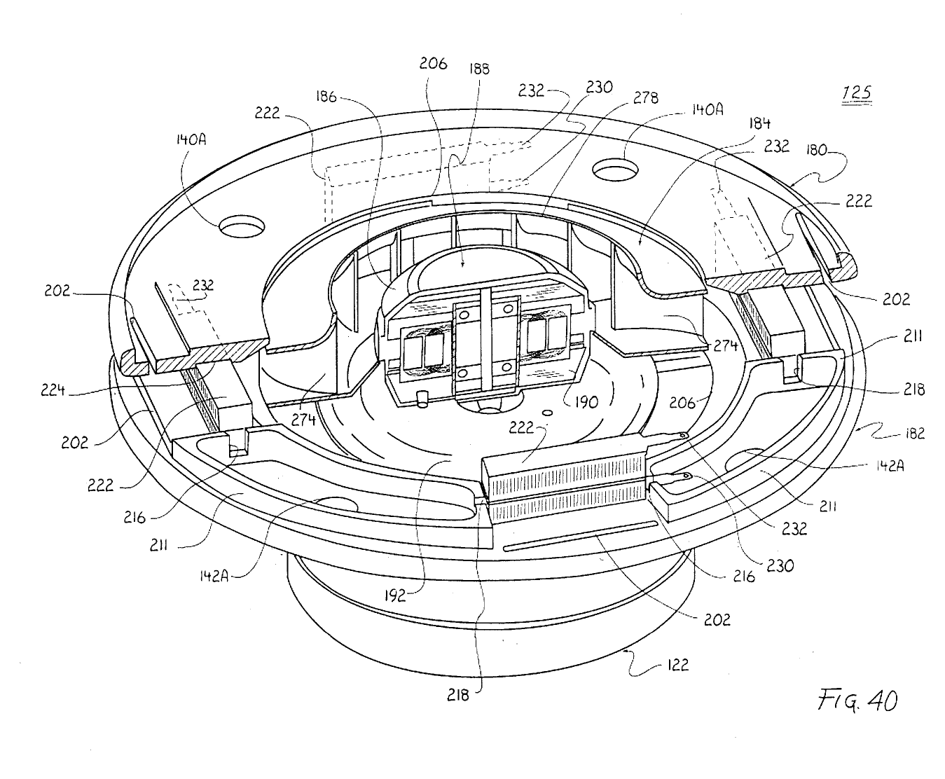

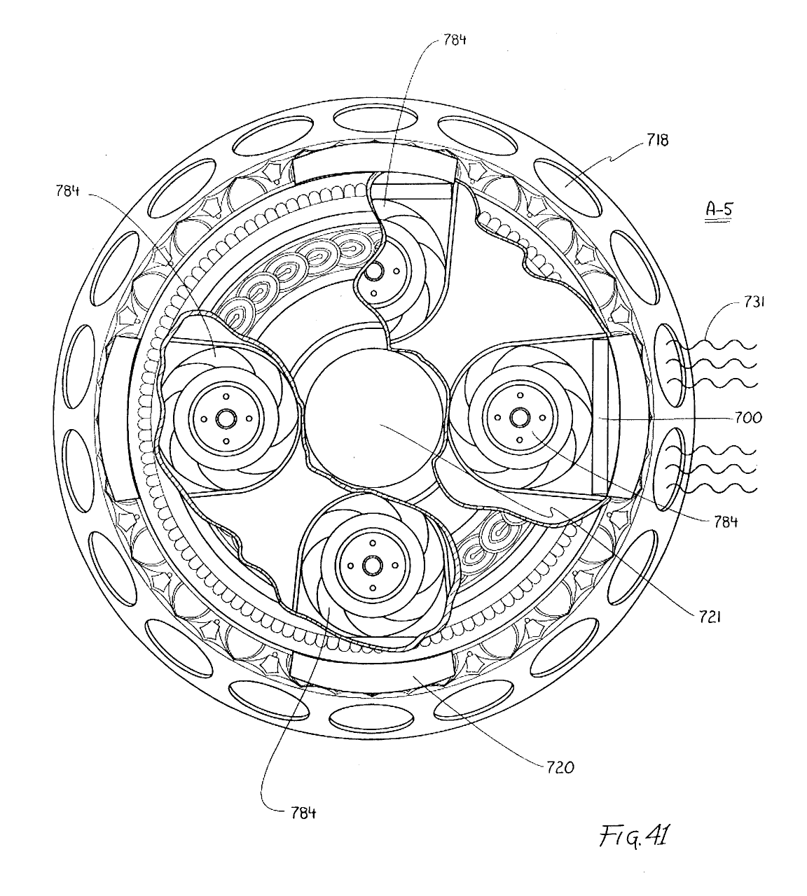

Referring now FIG. 40, illustrated therein is a partial cut-away view of heating module 125, showing the structures intermediate heat shields 180 and 182. Various heat shield designs were evaluated to perform three basic functions: support heating elements 222; prevent the transfer of heat between heating elements 222 and proximate components; and promote the channeling of the primary airflow. The design of heating module 125 as illustrated in FIG. 40 is but one of many ways to accomplish these tasks. Among those designs evaluated but not limited to were, metal structures with heat sink inserts, full heat sink structure, open architecture and combinations thereof. The chosen design lent to ease of manufacturability but all of the designs, listed above and their equivalence, are within the scope of the invention. More particularly, FIG. 40 depicts each of four (4) heating elements 222 retained equiangularly intermediate heat shields 180 and 182. Each of heat shields 180 and 182 includes a depression 224 for nestingly receiving the body of a heating elements 222. Optional disk 192, disposed centrally of opening 206 supports stator 190, and rotor 186 of motor 188 supports impeller 184. It is noted that opening 206 in heat shield 180 is generally coincident with the perimeter of impeller 184. Upon inspection it will become evident that as air is drawn through circular opening 278 of impeller 184, such air flows past motor 188 and will have a cooling effect thereon. The air exhausted by vanes 274 of impeller 184 will be channeled proximal to wall sections 211 of heat shields 180 and 182 and through each of heating elements 222. As described more fully below, some or all of heating elements 222 may be energized and those that are, will raise the temperature of the air flowing therethrough. Each of heating elements 222 includes tabs 230 and 232, wherein tabs 230 and 232 are located within respective ones of slots 216 and 218 in wall sections 211 of each of heat shields 180 and 182. As such, retention of heating elements 222 is enhanced by locking action resultant from tabs 230 and 232 being disposed within their respective slots 216 and 218.

Referring now to FIG. 41, it is contemplated in yet another alternate embodiment that heating device A-5 could possess more than one impeller. Specifically, as best depicted in FIG. 41, heating elements 700 of heating device A-5 could each individually possess an impeller 784 positioned proximal thereto for the urging of air through heating elements 700 to create a primary heated airflow 731 exhausted via outlets 720. It is recognized in an alternate embodiment that device A-5 may incorporate any number of inlets 718 and outlets 720.

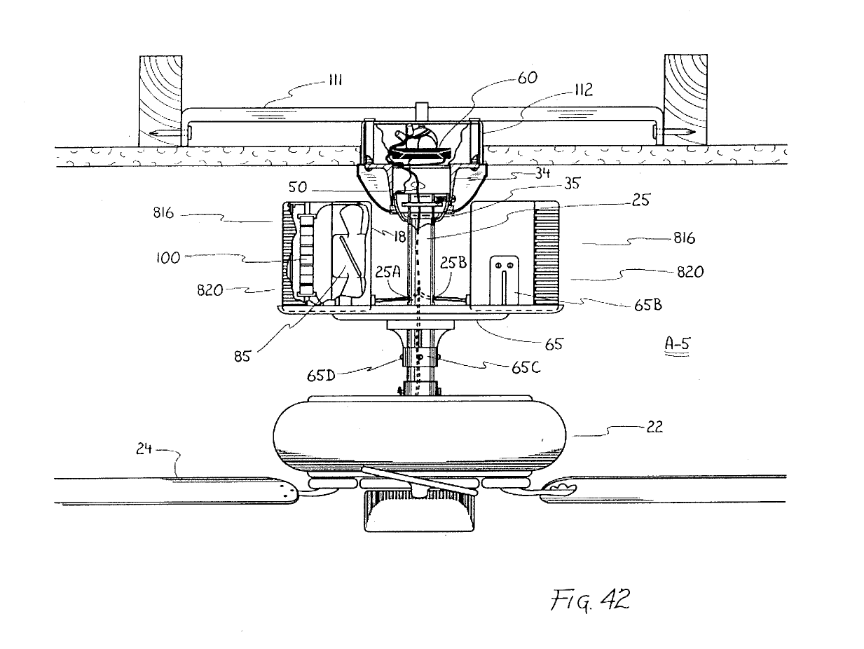

Referring now to FIG. 42, illustrated therein is another alternate embodiment of heating device A-5, having two opposingly positioned heating modules 816, a ceiling fan 22 conventionally mounted to a ceiling fan brace 111, an electric box 112 connected to a standard electrical power source, such as 120/220AC, to supply power to preferred remote control receiver 60 and, via conductors 50, to associated electrically powered components. Attached to electric box 112 is standard ceiling fan hanger bracket 34, wherein hanger bracket 34 cradles standard hanger ball 35 conventionally attached to down rod 25, thereby completing the supporting mechanism for ceiling fan 22. In this alternate embodiment, ceiling fan down rod 25 is replaced with another down rod having apertures 25A and 25B for the further routing of conductors 50 to heating modules 816. Attached to down rod 25 is mounting plate 65 with attached collar 65C secured to down rod 25 by setscrews 65D. A bracket 65B extends from mounting plate 65 to secure heating modules 816. Heating modules 816 perform the task of directing heated airflow into the path of an upward airflow created by ceiling fan 22 and ceiling fan blades 24. The upward airflow directs the mixed warm air first against the ceiling then into circulation down the walls, across the floor and back again into circulation. Heating modules 816 create this heated airflow by first drawing air through inlet 818 (not shown) in response to rotation of a motorized fan 85. The resultant airflow is then directed past heating elements 100 prior to being exhausted past outlets 820 for mixing with the upward airflow created by ceiling fan 22. Remote control receiver 60 receives transmissions from either a remote or hard-wired device as explained previously in this specification in previous embodiments.

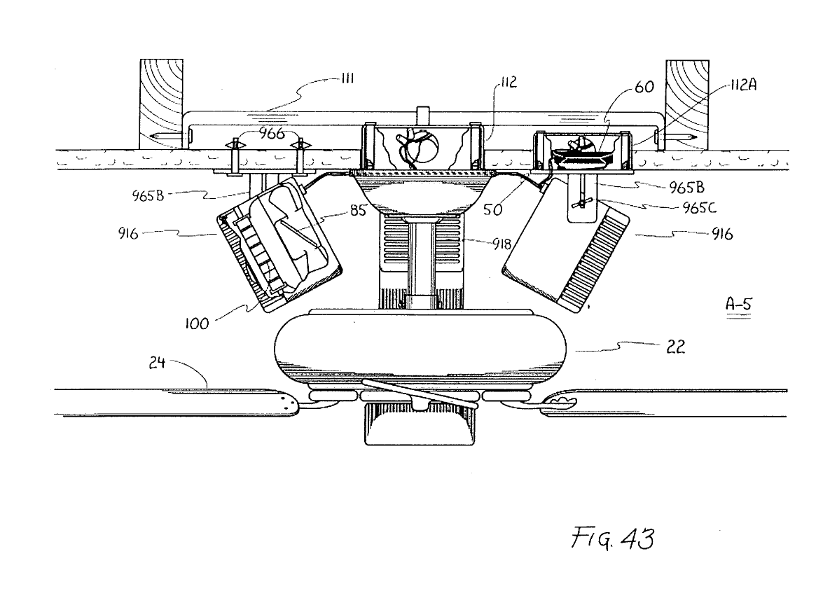

Referring now to FIG. 43, illustrated therein is another alternate embodiment of device A-5, showing heating modules 916 mounted independent from ceiling fan 22. The association between the heating modules 916 and ceiling fan 22 has no mechanical interface and is functional only. Ceiling fan 22 is conventionally mounted to a preferred ceiling fan brace 111 and electrical box 112. Heating modules 916 can be independently and upwardly attached within the furthest arc created by blades 24 of ceiling fan 22 and can be mounted as a single unit or in multiples depending on the amount of heating required/desired. In the present alternate embodiment, primary heating modules 916 are mounted to an electrical box 112A via brackets 965B and wing nut/conventional nut 965C. Electrical box 112A houses remote control receiver 60 and is further connected to a standard 120/220AC household current. Furthermore, heating modules 916 can be mounted using a variety of attachment means including, screws, nuts and bolts, adhesives and/or expansion screws 966. Remote control receiver 60 is activated by a hand-held device as previously explained in this specification or hardwired to receive controls that direct the amount of heat produced by heating module 916. Ceiling fan 22 is controlled by conventional means as supplied by the manufacturer of ceiling fan 22. Electrical conduit 50 provides the electrical power to activate motorized fan 85 and heating elements 100. Heated airflow is created in response to the rotation of at least one motorized fan 85 drawing air through inlet 918 and then forcing the created airflow through heating element 100. The heated airflow is thereafter exhausted through outlet 920 for mixing with the preferred upward flow of air created by ceiling fan 22.

It is contemplated in an alternate embodiment that device 1000 could combine any of the above-described embodiments of air conditioning systems, and/or alternate embodiments thereof, with any of the above-described heating devices, including, but not limited to, the preferred and/or alternate embodiments of A-5, the preferred and/or alternate embodiments of A-4, the preferred and/or alternate embodiments of A-1, the preferred and/or alternate embodiments of A-2, the preferred and/or alternate embodiments of A-3 and the preferred and/or alternate embodiments of A-11.

It is contemplated in an alternate embodiment that any of the above-referenced air conditioning systems could be replaced with, and/or operate in conjunction with, other suitable air cooling apparatuses such as, for exemplary purposes only, heat pumps, thermocouplers, or the like.

It is contemplated in an alternate embodiment that any of the above-referenced air conditioning systems could be placed in any position relative to the preferred and/or alternate embodiments of heating devices.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An air recirculating, heating and cooling device, comprising:
a ceiling mounted heating device adapted to heat and distribute a first airflow; and,
means for generating a cooled airflow for mixing with said first airflow.

2. The air recirculating, heating and cooling device of claim 1, wherein said means for generating a cooled airflow is at least one air conditioning unit positioned above said heating device.

3. The air recirculating, heating and cooling device of claim 1, wherein said means for generating a cooled airflow is at least one air conditioning unit in thermal communication with said air recirculating, heating and cooling device.

4. The air recirculating, heating and cooling device of claim 1, wherein said means for generating a cooled airflow is at least one air conditioning unit positioned above said heating device and between floors of a building structure equipped with said air recirculating, heating and cooling device.

5. The air recirculating, heating and cooling device of claim 1, wherein said means for generating a cooled airflow is at least one air conditioning unit positioned above said heating device and in the attic of a building structure equipped with said air recirculating, heating and cooling device.

6. The air recirculating, heating and cooling device of claim 1, wherein said means for generating a cooled airflow is at least one heat pump positioned above said heating device.

7. The air recirculating, heating and cooling device of claim 1, wherein said means for generating a cooled airflow is at least one heat pump in thermal communication with said air recirculating, heating and cooling device.

8. The air recirculating, heating and cooling device of claim 2, wherein said at least one air conditioning unit comprises at least one condensed water extraction means.

9. The air recirculating, heating and cooling device of claim 8, wherein said at least one condensed water extraction means is at least one tube extending from at least one water collecting reservoir positioned beneath an evaporator of said at least one air conditioning unit, wherein said at least one tube extends to the outside of a building structure equipped with said air recirculating, heating and cooling device.

10. The air recirculating, heating and cooling device of claim 2, wherein said at least one air conditioning unit comprises at least one air intake tube and at least one air expelling tube for supplying air to and expelling air from said at least one air conditioning unit, respectively, wherein said at least one air intake tube and said at least one air expelling tube extend from a condenser of said at least one air conditioning unit to the outside of a building structure equipped with said air recirculating, heating and cooling device.

11. The air recirculating, heating and cooling device of claim 2, wherein said at least one air conditioning unit comprises at least one air intake port and at least one air expelling port positioned above said ceiling mounted heating device.

12. The air recirculating, heating and cooling device of claim 2, wherein said at least one air intake port is adapted to draw ambient air therein and over evaporator coils for generating said cooled airflow for subsequent expelling of said cooled airflow through said at least one air expelling port.

13. The air recirculating, heating and cooling device of claim 2, wherein said cooled airflow expelled through said at least one air expelling port is distributed over at least one fan blade of said heating device, said at least one fan blade adapted to uniformly mix and distribute said cooled airflow with said first airflow.

14. The air recirculating, heating and cooling device of claim 1, wherein said air recirculating, heating and cooling device is capable of establishing different temperatures in different rooms on the same floor of a building structure equipped with said air recirculating, heating and cooling device.

15. The air recirculating, heating and cooling device of claim 1, wherein said air recirculating, heating and cooling device is capable of establishing different temperatures in different rooms on different floors of a building structure equipped with said air recirculating, heating and cooling device.

16. The air recirculating, heating and cooling device of claim 2, wherein said at least one air conditioning unit is selectively activated or deactivated via receiver-transmitter technology.

17. The air recirculating, heating and cooling device of claim 1, wherein said means for generating a cooled airflow is substantially housed within a noise reducing enclosure, said enclosure comprising noise absorbing filler material to absorb and muffle noises and sounds emitted from said means for generating a cooled airflow during operation of same.

18. An air recirculating, heating and cooling device, comprising:
a) means for creating a circular airflow that distributes air evenly throughout a room;
b) means for creating a heated airflow for mixing with said circular airflow;
c) means for creating a cooled airflow for mixing with said circular airflow;

19. The air recirculating, heating and cooling device of claim 18, wherein further comprising means for selectively regulating said heated airflow and said cooled airflow to maintain a desired near even temperature throughout the room.

20. An air recirculating, heating and cooling device, comprising:
a ceiling mounted heating device adapted to selectively heat and distribute a first airflow; means for generating a cooled airflow above said heating device for subsequent mixing and uniform distribution with said first airflow; and,
means for extracting condensed water produced by said means for generating a cooled airflow during operation of same.

21. The air recirculating, heating and cooling device of claim 20, wherein said means for generating a cooled airflow is at least one air conditioning unit positioned above said heating device.

22. The air recirculating, heating and cooling device of claim 20, wherein said means for generating a cooled airflow is at least one air conditioning unit positioned above said heating device and between floors of a building structure equipped with said air recirculating, heating and cooling device.

23. The air recirculating, heating and cooling device of claim 20, wherein said means for generating a cooled airflow is at least one air conditioning unit positioned above said heating device and in the attic of a building structure equipped with said air recirculating, heating and cooling device.

24. The air recirculating, heating and cooling device of claim 20, wherein said means for generating a cooled airflow is at least one heat pump positioned above said heating device.

25. The air recirculating, heating and cooling device of claim 21, wherein said condensed water extraction means is at least one tube extending from at least one water collecting reservoir positioned beneath an evaporator of said at least one air conditioning unit, wherein said at least one tube extends to the outside of a building structure equipped with said air recirculating, heating and cooling device.

26. The air recirculating, heating and cooling device of claim 21, wherein said at least one air conditioning unit comprises at least one air intake tube and at least one air expelling tube for supplying air to and expelling air from said at least one air conditioning unit, respectively, wherein said at least one air intake tube and said at least one air expelling tube extend from a condenser of said at least one air conditioning unit to the outside of a building structure equipped with said air recirculating, heating and cooling device.

27. The air recirculating, heating and cooling device of claim 21, wherein said at least one air conditioning unit comprises at least one air intake port and at least one air expelling port positioned above said ceiling mounted heating device.

28. The air recirculating, heating and cooling device of claim 21, wherein said at least one air intake port is adapted to draw ambient air therein and over evaporator coils for generating said cooled airflow for subsequent expelling of said cooled airflow through said at least one air expelling port.

29. The air recirculating, heating and cooling device of claim 21, wherein said cooled airflow expelled through said at least one air expelling port is distributed over at least one fan blade of said heating device, said at least one fan blade adapted to uniformly mix and distribute said cooled airflow with said first airflow.

30. The air recirculating, heating and cooling device of claim 20, wherein said air recirculating, heating and cooling device is capable of establishing different temperatures in different rooms on the same floor of a building structure equipped with said air recirculating, heating and cooling device.

31. The air recirculating, heating and cooling device of claim 20, wherein said air recirculating, heating and cooling device is capable of establishing different temperatures in different rooms on different floors of a building structure equipped with said air recirculating, heating and cooling device.

32. The air recirculating, heating and cooling device of claim 21, wherein said at least one air conditioning unit is selectively activated or deactivated via receiver-transmitter technology.

33. The air recirculating, heating and cooling device of claim 20, wherein said means for generating a cooled airflow is substantially housed within a noise reducing enclosure, said enclosure comprising noise absorbing filler material to absorb and muffle noises and sounds emitted from said means for generating a cooled airflow during operation of same.

34. An air recirculating, heating and cooling device, comprising:
a ceiling mounted heating device adapted to selectively heat a first airflow, said first airflow distributed by at least one fan blade carried by said heating device;
at least one air conditioning unit for generating a cooled airflow above said at least one fan blade for subsequent mixing and uniform distribution with said first airflow; and,
means for extracting condensed water produced by said at least one air conditioning unit during operation of same.

35. The air recirculating, heating and cooling device of claim 34, wherein said at least one air conditioning unit is positioned above said heating device and between floors of a building structure equipped with said air recirculating, heating and cooling device.

36. The air recirculating, heating and cooling device of claim 34, wherein said at least one air conditioning unit is positioned above said heating device and in the attic of a building structure equipped with said air recirculating, heating and cooling device.

37. The air recirculating, heating and cooling device of claim 34, wherein said condensed water extraction means is at least one tube extending from at least one water collecting reservoir positioned beneath an evaporator of said at least one air conditioning unit, wherein said at least one tube extends to the outside of a building structure equipped with said air recirculating, heating and cooling device.

38. The air recirculating, heating and cooling device of claim 34, wherein said at least one air conditioning unit comprises at least one air intake tube and at least one air expelling tube for supplying air to and expelling air from said at least one air conditioning unit, respectively, wherein said at least one air intake tube and said at least one air expelling tube extend from a condenser of said at least one air conditioning unit to the outside of a building structure equipped with said air recirculating, heating and cooling device.

39. The air recirculating, heating and cooling device of claim 34, wherein said at least one air conditioning unit comprises at least one air intake port and at least one air expelling port positioned above said ceiling mounted heating device.

40. The air recirculating, heating and cooling device of claim 34, wherein said at least one air intake port is adapted to draw ambient air therein and over evaporator coils for generating said cooled airflow for subsequent expelling of said cooled airflow through said at least one air expelling port.

41. The air recirculating, heating and cooling device of claim 34, wherein said cooled airflow expelled through said at least one air expelling port is distributed over said at least one fan blade of said heating device, said at least one fan blade adapted to uniformly mix and distribute said cooled airflow with said first airflow.

42. The air recirculating, heating and cooling device of claim 34, wherein said air recirculating, heating and cooling device is capable of establishing different temperatures in different rooms on the same floor of a building structure equipped with said air recirculating, heating and cooling device.

43. The air recirculating, heating and cooling device of claim 34, wherein said air recirculating, heating and cooling device is capable of establishing different temperatures in different rooms on different floors of a building structure equipped with said air recirculating, heating and cooling device.

44. The air recirculating, heating and cooling device of claim 34, wherein said at least one air conditioning unit is selectively activated or deactivated via receiver-transmitter technology.

45. The air recirculating, heating and cooling device of claim 34, wherein said means for generating a cooled airflow is substantially housed within a noise reducing enclosure, said enclosure comprising noise absorbing filler material to absorb and muffle noises and sounds emitted from said at least one air conditioning unit during operation of same.

46. A method for cooling a room, said method comprising the steps of:
a) drawing a primary airflow from an upward location of the room through at least one inlet of a means for generating a cooled airflow;
b) cooling said primary airflow via said cooled airflow generating means to produce said cooled airflow;
c) exhausting said cooled airflow through at least one outlet of said cooled airflow generating means;
d) generating a secondary airflow with at least one rotating fan blade; and,
e) mixing said cooled airflow with said secondary airflow.

47. The method of claim 46, wherein said means for generating a cooled airflow is at least one air conditioning unit positioned above said auxiliary motor.

48. The method of claim 47, wherein said at least one air conditioning unit comprises at least one condensed water extraction means.

49. The method of claim 48, wherein said at least one condensed water extraction means is, at least one tube extending from at least one water collecting reservoir positioned beneath an evaporator of said at least one air conditioning unit, wherein said at least one tube extends to the outside of the room equipped with said air recirculating, heating and cooling device.

50. The method of claim 47, wherein said at least one air conditioning unit comprises at least one air intake tube and at least one air expelling tube for supplying air to and expelling air from said at least one air conditioning unit, respectively, wherein said at least one air intake tube and said at least one air expelling tube extend from a condenser of said at least one air conditioning unit to the outside the room equipped with said air recirculating, heating and cooling device.

51. A method for cooling a room, said method comprising the steps of:
a. producing a first airflow from an air recirculating, heating and cooling device comprising means for heating and means for cooling; and,
b. producing a second independent airflow, wherein said second independent airflow is heated or cooled by said air recirculating, heating and cooling device to heat or cool a room.

52. An air recirculating, heating and cooling device, comprising:
a) at least one heating module, comprising:
i) means for generating a primary airflow, said primary airflow having a downstream flow and an upstream flow relative to said means for generating said primary airflow;
ii) at least one heating element for heating said primary airflow;
iii) means for selectively regulating said at least one heating element, wherein said means for selectively regulating is responsive to at least one input for regulating the temperature of said primary airflow; and
b) means for generating a secondary airflow, said secondary airflow having a downstream flow and an upstream flow relative to said means for generating said secondary airflow, and wherein said secondary airflow mixes with said heated primary airflow;
c) means for isolating said at least one heating element from said means for generating a secondary airflow; and,
d) means for generating a cooled airflow.

53. The air recirculating, heating and cooling device as set forth in claim 52, wherein said means for generating a primary airflow comprises at least one primary motor operable to rotate at least one primary fan blade.

54. The air recirculating, heating and cooling device as set forth in claim 52, wherein said means for generating a secondary airflow comprises at least one secondary motor operable to rotate at least one secondary fan blade.

55. The air recirculating, heating and cooling device as set forth in claim 52, further comprising at least one support means.

56. The air recirculating, heating and cooling device as set forth in claim 55, wherein said means for generating a secondary airflow is positioned below said at least one heating module.

57. The air recirculating, heating and cooling device as set forth in claim 56, wherein said downstream airflow of said primary airflow mixes with said downstream airflow of said secondary airflow.

58. The air recirculating, heating and cooling device as set forth in claim 56, wherein said downstream airflow of said primary airflow mixes with said upstream airflow of said secondary airflow.

59. The air recirculating, heating and cooling device as set forth in claim 52, wherein said at least one heating module comprises a plurality of said heating elements.

60. The air recirculating, heating and cooling device as set forth in claim 59, wherein said heating elements are radially separated.

61. The air recirculating, heating and cooling device as set forth in claim 52, wherein said means for isolating said at least one heating element is at least one heat sink barrier for reducing the transfer of heat from said at least one heating element to said means for generating a secondary airflow.

62. The air recirculating, heating and cooling device as set forth in claim 52, wherein said at least one heating module comprises at least one inlet and at least one outlet for moving said primary airflow therethrough.

63. The air recirculating, heating and cooling device as set forth in claim 59, wherein said heating module comprises a plurality of inlets and outlets for moving said primary airflow therethrough, and wherein one each of said plurality of heating elements is individually positioned proximal to one each of said plurality of outlets.

64. The air recirculating, heating and cooling device as set forth in claim 59, further comprising means for selectively energizing at least one of said plurality of heating elements to control the desired temperature of the room.

65. The air recirculating, heating and cooling device as set forth in claim 64, wherein said means for selectively energizing comprises at least one portable remote control unit communicable with said plurality of heating elements.

66. The air recirculating, heating and cooling device as set forth in claim 65, wherein said at least one portable remote control unit further comprises a thermostat and controls carried thereby, and wherein a desired room temperature may be set via said controls, and wherein said plurality of heating elements are responsive thereto.

67. The air recirculating, heating and cooling device as set forth in claim 65, wherein said at least one portable remote control unit further comprises a display, thermostat and controls carried thereby, and wherein a desired room temperature may be set via said controls and displayed on said display, and wherein said plurality of heating elements are responsive thereto.

68. The air recirculating, heating and cooling device as set forth in claim 65, wherein said at least one portable remote control unit is wireless.

69. The air recirculating, heating and cooling device as set forth in claim 68, further comprising a wireless receiving unit carried by said at least one heating module and a wireless transmitting unit carried by said at least one portable remote control unit, wherein said wireless transmitting unit transmits a wireless signal detectable by said wireless receiving unit.

70. The air recirculating, heating, and cooling device as set forth in claim 69, wherein said wireless signal is an infrared frequency.

71. The air recirculating, heating and cooling device as set forth in claim 69, wherein said wireless signal is a radio frequency.

72. An air recirculating, heating and cooling device for selectively heating or cooling a room, said device comprising in combination:
a) at least one support;
b) a heating module comprising;
i) means for adapting said heating module in relation with said at least one support; and
ii) a means for discharging a heated primary airflow from said heating module, said heating module selectively regulated to adjust the temperature level of said primary airflow;
c) an auxiliary motor adapted in an isolated location downwards of said heating module for rotating at least one fan blade to produce either an upward secondary airflow for heating or a downward secondary airflow for cooling;
d) means for controlling said auxiliary motor to produce either the upward airflow or the downward airflow;
e) heat sink material for protecting at least one element of said device from the adverse effects of heat from said heating module; and,
f) means for generating a cooled airflow.

73. The air recirculating, heating and cooling device as set forth in claim 72, wherein said heating module includes at least one outlet for exhausting the heated primary airflow.

74. The air recirculating, heating and cooling device as set forth in claim 72, wherein said heating module includes at least one inlet for ingress of air to be heated.

75. The air recirculating, heating and cooling device as set forth in claim 73, wherein said heating module includes more than one outlet for exhausting the heated primary airflow.

76. The air recirculating, heating and cooling device as set forth in claim 72, including means for controlling the operation of said auxiliary motor to produce either the upward or the downward secondary airflow.

77. The air recirculating, heating and cooling device as set forth in claim 76, wherein said control means regulates the amount of heat produced by said heating module commensurate with upward secondary airflow to achieve a desired temperature of the air in the room.

80. An air recirculating, heating and cooling device, comprising:
a) at least one support means;
b) a heating module for generating a heated primary airflow;
c) at least one auxiliary motor mounted in an isolated location downwards of said heating module, said at least one auxiliary motor having at least one fan blade for generating an upward secondary airflow for mixing with said heated primary airflow;
d) means for selectively regulating the amount of heat generated by said heating module; and,
e) means for generating a cooled airflow.

81. The air recirculating, heating and cooling device as set forth in claim 80, wherein said heating module comprises at least one motorized impeller and at least one heating element.

82. The air recirculating, heating and cooling device as set forth in claim 80 wherein said heating module includes at least one inlet for introducing air to be heated.

83. The air recirculating, heating and cooling device as set forth in claim 80, wherein said heating module includes at least one outlet for exhausting the heated primary airflow.

84. The air recirculating, heating and cooling device as set forth in claim 80, wherein said means for selectively regulating automatically senses the temperature desired of the air in the room and regulates said heating module to maintain the air in the room at the desired temperature.

85. The air recirculating, heating and cooling device as set forth in claim 80, wherein said means for selectively regulating accommodates manual regulation of said heating module to maintain the air in the room at a desired temperature.

86. The air recirculating, heating and cooling device as set forth in claim 80, including a heat sink barrier for reducing the transfer of heat from said at least one heating element to selected elements of said device.

87. The air recirculating, heating and cooling device as set forth in claim 80, wherein said heating module includes at least one inlet for accommodating an inflow of air to be heated by said at least one heating element from an upward location of the room.
